(19) United States
(12) Patent Application Publication
(10) Pub. No.: US 2004/0081415 A1
(43) Pub. Date: Apr. 29, 2004

(54) Planar optical waveguide amplifier with mode size converter

(76) Inventors: Richard E. Demaray, Portola Valley, CA (US); David Dawes, Dublin, OH (US)

Correspondence Address: SKJERVEN MORRILL LLP, 25 METRO DRIVE, SUITE 700, SAN JOSE, CA, 95110, US

(21) Appl. No.: 10/350,392

(22) Filed: Jun. 23, 2003

Related U.S. Application Data
(60) Provisional application No. 60/350,723, filed on Jan. 22, 2002.

(51) Int. Cl. G02B 6/10

(52) U.S. Cl. 385/129; 385/42

(57) ABSTRACT

Planar wave guide devices deposited by reactive pulsed dc sputtering processes are presented. Devices according to the present invention include a waveguide with a core sputter deposited onto a substrate and a cladding sputter deposited onto the core. In some embodiments, second waveguide can be deposited in close proximity to the first waveguide to form a direction coupler. In some embodiments, light traveling through the waveguide can be amplified or attenuated in response to signals applied to the waveguide. In some embodiments, a DWDM device is formed in the waveguide. In other devices, a mode-locked laser is formed.

The present application claims priority to U.S. Provisional Application Serial No. 60/350,723, which is herein incorporated by reference in its entirety.

### BACKGROUND

1. Field of the Invention

The current invention is related to optical waveguide devices and, in particular, to optical devices with a low noise, planar optical waveguide amplifier with constant gain.

2. Discussion of Related Art

The current interest in optical devices for optical communications and other areas has spurred development of optical materials and devices. These optical devices include optical amplifiers, mode-size converters, and multiplexer/demultiplexer (mux) units.

Optical amplifiers have typically been formed of erbium doped fiber amplifiers (EDFAs). Conventional EDFAs include long lengths of optical fiber which have been doped with an erbium concentration. Significant expense is incurred in producing the lengths of optical fiber required to perform sufficient amplification and in coupling pump light into the optical fiber. Further, devices which utilize EDFAs are large and require high-power pump sources.

Therefore, there is a need for optical amplifiers and such devices which are smaller and more efficient.

### SUMMARY

In accordance with the present invention, an erbium doped planar waveguide amplifier (EDWA) coupled with a mode-sized converter is presented. In some embodiments, the amplifier has low noise and low ripple over the C-band. Both the active core and cladding layers of the waveguide amplifier can be sputter deposited.

In some embodiments, an EDWA according to the present invention can include a mode-size converter (MSC). The MSC can be produced at the time of deposition of the active core of the EDWA by a shadow mask process. The shadow mask results in a smooth taper of the active core which is otherwise unattainable with conventional etching-based taper technologies.

In some embodiments of the invention, the erbium doped waveguide amplifier (EDWA) can be used as switching devices. Further, EDWAs according to the present invention can be utilized in many optical devices. The list of optical devices includes optical amplifiers, optical switches, variable attenuators, both narrow band and wide band lasers, optical sources, parametric oscillators, tunable filters, bi-directional traveling wave amplifiers, optical gyroscopes, and WDM modules.

Many of these applications will be further discussed below with respect to the following figures.

### DESCRIPTION OF THE FIGURES

FIG. A1 shows an embodiment of an erbium doped waveguide amplifier (EDWA) according to the present invention.

FIG. X1 shows an embodiment of a laser according to the present invention.

FIG. X2 shows an embodiment of a L-band Amplifier according to the present invention.

FIG. X3 shows an embodiment of a C+L band Amplifier according to the present invention.

FIG. X4 shows an embodiment of a Multiple-Pass Amplifier according to the present invention.

FIG. X5 shows an embodiment of a Waveguide Laser Gyroscope according to the present invention.

FIG. X6 shows a Raman Waveguide Amplifier according to the present invention.

FIG. 1a shows CV curves for annealed materials which form devices according to the present invention.

FIG. 1b shows CV curves as deposited at 10 kHz.

FIG. 1c shows CV curves as deposited at 1 MHz.

FIG. 2a shows unannealled clad at different frequencies

FIG. 2b shows CV curves for 1/0.4 material unannealed.

FIG. 2c shows CV curves for 0.8/0.8 bb unannealed.

FIG. 2d shows CV curves for 1.6/0.5 material.

FIG. 3 shows CV curves for 1/0.4 material.

FIG. 4 shows CV curves for 0.8/0.8 material with different process conditions.

FIG. 5 shows the effects of bias stress.

FIG. 6a shows a breakdown curves for unannealed materials.

FIG. 6b shows breakdown curves for annealed materials.

FIGS. Y1 through Y5 illustrate that the angle dependent bandwidth of an erbium doped grating provides a free space source with as much as 100 nm of bandwidth in the C and L bands due to the 35-40 nm emission of erbium +3 ion in silica at a selected output angle.

FIGS. Z1A and Z1B show an optical circuit having an EDWA according to the present invention.

FIG. Z2 shows an AWG coupled a parallel set of EDWAs according to the present invention.

FIG. Z3 shows a side-pumped large area absorber according to the present invention.

FIG. Z4 shows an amplifier planar integrated circuits switch with EDWAs according to the present invention.

FIG. Z5 shows a reconfigurable EDWA according to the present invention for optically amplified division multiplexing.

FIGS. T1 through T45 show various applications and material growth results for amplifiers and other components according to the present invention.

FIGS. M1 through M8 show verification of a multiplexer according to the present invention.

FIG. D1 shows a Coherent Laser Radar utilizing components according to the present invention.

FIG. D2 shows an Optical Clock Recovery utilizing components according to the present invention.

FIG. D3 shows an Actively Mode Locked Waveguide Laser utilizing components according to the present invention.

FIGS. B1 through B11 show a device with an integrated pump.

FIGS. C1 through C7 show various optical devices utilizing components according to the present invention.

### DETAILED DESCRIPTION

Recently, engineers at Symmorphix fabricated an erbium doped, planar optical waveguide amplifier (EDWA) with the novel properties of very low noise and also low gain variation or ‘ripple’ over the so called ‘C’ band from about 1528 nm to about 1562 nm, which is important to photonic and data communications applications.

A single mode C-band EDWA was fabricated with other waveguides by sputtering both the doped and undoped layers of the waveguide. The resulting amplifier was very efficient with regards to coupling to fiber based pump and signal light. The entire 10 cm long amplifier of the embodiment actually produced less than 2 dB total insertion loss at 1310 nm, fiber to fiber with standard, low index contrast HI-1060 fiber.

The coupling efficiency is due to a novel mode size converter or MSC that was integrated through the fabrication process in the deposition of the waveguide core layers. The MSC was fabricated during the deposition of the erbium-doped core layer in a region of extremely uniform and smoothly decreasing film thickness. This region was used to form the terminal several millimeters of the active waveguide core prior to the formation of the coupling facet. The decreasing core film thickness serves as a length of ‘reverse taper’ which supports the gradual increase of the mode size as the guided light approaches the coupling facet. The smoothness of the film is on the order of several Angstroms average roughness, so unlike a taper achieved by etching in the plane, the roughness and the radius of the terminal tip of the taper do not scatter light.

Consequently, a so called ‘spot size’ at the facet can be controlled over a wide range for a waveguide formed from one contrasting pair of index material. In particular, a high contrast waveguide with a small core mode size or ‘small pipe’ can be efficiently coupled, die-to-die with a low contrast or ‘large pipe’, which is representative of standard fiber with high coupling efficiency and low insertion loss.

The region of uniformly decreasing film thickness is achieved by means of a very uniform incoming distribution of physical vapor as associated with a uniform wide area sputter target erosion as well as application of a so called ‘shadow mask’. Some embodiments of the sputtering process are described in U.S. application Ser. No. 09/903,050, which is herein incorporated by reference in its entirety.

A ‘shadow mask’ is a physical means of blocking the incoming physical vapor in one dimension, which results in a smoothly varying taper at the waveguide. “In-plane” tapers have generally been produced with etching techniques, resulting in significant roughness and the concurrent production of optical scattering sites in the waveguide. Therefore, the coupling efficiency to the active core of the EDWA is significantly increased with a mode-size converter according to the present invention.

Further during deposition of the EDWA structure, other optical structures can also be deposited. For example, a passive mux structure has also recently been fabricated by means of sputtering with a process that has demonstrated high quality fill of the so called ‘Mux’ gap by the sputtered cladding.

### EDWA Variable Attenuator and Switch

The utilization of a planar waveguide amplifier as a switch also allows the amplifier to function in a number of other ways in an optical circuit. In particular, a multi-channel planar waveguide amplifier can function to pass or block a channel with high isolation. The dynamic gain serves to further increase the discrimination of the pass signals in that they have the benefit of the gain imparted by the amplifier.

In addition, such a switch circuit can be employed as a variable optical attenuator. The waveguide amplifier can be pumped so that the incident signal is attenuated up to the intrinsic absorption of the circuit. In the case of the subject amplifier, the absorption is 3 dB/cm at 1530 nm, so a 10 centimeter long waveguide amplifier would have −30 dB of attenuation if it were not pumped by 980 nm pump light. If it were pumped with 150 mW of 980 nm pump light, it would have +7 dB of gain. Consequently, such a switch would have 37 dB of dynamic attenuation, 30 dB below the input signal and 7 dB above the input signal. In another mode it can act as a loss-less circuit element. That is, a pass signal can be achieved with incremental gain so as to overcome the attenuation of the circuit so as to output the same signal strength as the input signal. In another embodiment, the gain can be raised above the loss-less level up to the gain limit of the amplifier.

### Add-Drop Module

An add-drop module can utilize the switch described above. An add-drop circuit according to the present invention can include splitter, for example a 3 dB splitter, and two arrays of Waveguide Amplifier Switches according to the present invention.

In order to emulate a fully transparent n-channel add/drop switch, it is necessary to split the n-channel signal into two separate fibers with the two signals in some portion. All n-channels of each of the two duplicate channels are demuxed and each set are coupled to separate n-channel planar waveguide amplifiers. One set of amplifiers are pumped so as to amplify the through signals and block the drop signals. The other set of amplifiers are pumped so as to amplify the drop signals and block the pass signals. The first set of through signals are combined with the complementary set of add wavelengths.

### Wavelength Stabilized Laser

FIG. X1 shows an embodiment of a wavelength stabilized laser. There are several ways to form a laser from an erbium doped waveguide amplifier. One way is to form lumped reflections at both ends of the waveguide. This can be accomplished by providing an external grating of the active (doped) region of the amplifier or by thin film filter coating at the facets of the waveguide. Another way of forming a laser is to form a distributed grating in the doped (active) region of the amplifier. The distributed grating can be either in the top cladding or the bottom cladding region of the waveguide.

Further, if the laser is associated with a tunable feedback device, such as a tunable or writeable grating or other mechanism, then a tunable laser can be formed. Since the loss is small coupling into the optical amplifier, a tunable dispersion device and reflective mirror which forms part of the laser cavity can be external to the waveguide.

Lasers as described above can form narrow-band sources of signal in both the C and L optical bands. Narrow band fixed wavelength lasers can be formed with gratings as described above. Wide band optical sources can also be formed as described above.

### Phased Coupled Array of Lasers

In some embodiments, an array of n wavelength stabilized lasers can operate as a single laser with up to n times the output of a single laser by forming a common resonator and phase coupling each of the lasers in the far field.

### Broadband ASE Signal Source

Since ASE from erbium doped waveguide shows relative broadband emission, it is possible to design a competitive ASE power source from EDW. One configuration for this ASE source is to use a relatively inexpensive multimode pump for an erbium doped waveguide amplifier with some sensitizers to help absorption. Sensitizers consist of any single or combinations of rare-earth or transition metal elements with appropriately positioned energy levels that favor efficient transfer to the active erbium ions. Specific examples of such sensitizers include ytterbium, neodymium, chromium, etc. Other elements such as silver and copper when incorporated as nanocrystalline particles in the erbium-doped active waveguide could be function as a sensitizer. A single mode pump can also be utilized in this ASE source; the source can be more expensive.

### C-Band and L-Band Amplifier with Gain Flattening

FIG. X2 shows an embodiment of L-band Amplifier. An L-band amplifier can be made from a regular “C-band” Erbium doped waveguide amplifier. If the inversion of erbium energy levels is less than 20% and the waveguide is long enough, then an L-band waveguide amplifier is feasible.

Further, a C-band waveguide amplifier can be cascaded with a L-band waveguide amplifier. The gain spectrum for C+L band amplifier could be much flatter compared to C-band amplifier only, if the design of the cascaded amplifier is carefully done.

Additionally, if C-band and L-band signals are demuxed into two parallel C-band and L-band amplifiers and then muxed together, it will form a C+L band waveguide amplifier as shown in FIG. X3. The mux and demux can be also integrated into a waveguide amplifier die.

### EDWA with Dispersion Compensator for Sub-Bands

As the data rate increases, the dispersion compensation is an important issue for every system producer. Compensating dispersion within the whole C/L band is becoming more and more difficult. Breaking C/L-band into different sub-bands for dispersion compensation has attracted significant attention. Since a waveguide amplifier is perfect as a single wavelength amplifier or a couple of closely packed wavelength amplifiers, it is possible to compensate these known dispersions by picking the right wavelength dispersive waveguide material and tailoring the geometry of the waveguide and waveguide length to compensate for the dispersion.

### EDWA for Bandwidth Management

There is a current trend in optical systems to divide C/L band into different sub-bands for narrow band accessibility. This will be easier for power management, supervision, dispersion compensation, dynamic gain control. Waveguide amplifiers according to the present invention could be fit into these applications and provide additional gain.

### Bi-Directional Traveling Wave Amplifier

By virtue of the symmetrical construction of the EDWA according to the present invention, light propagating in a forward or in a backward direction through the amplifier experiences the same low noise amplification.

### Multiple-Pass Amplifier

FIG. X4 shows an embodiment of a multiple-pass amplifier according to the present invention. An input signal is input to a first port of an optical circulator and directed out of the second port of the optical circulator into an EDWA according to the present invention. A reflector in the optical waveguide reflects the signal back through the EDWA for a second pass and back into the second port of the optical circulator. The signal, having passed through the EDWA two times, is then directed to a third port of the optical circulator and out of the multiple-pass amplifier.

### Parametric Amplifier

An embodiment of the invention as a parametric amplifier comprising a pair of sources produced with the EDWA of this invention and followed by a section of a nonlinear optical medium which mixes the two wavelengths and thereby producing a third wavelength such that energy of the respective photons is conserved.

### Parametric Oscillator

An embodiment of the invention as a parametric oscillator comprising the parametric amplifier described in the previous paragraph with an optical feedback element to promote oscillation of one or more of the respective wavelengths.

### Waveguide Optical Gyroscope

FIG. X5 shows an embodiment of a waveguide optical gyroscope according to the present invention. The waveguide optical gyroscope is a sensor for detecting the angular velocity based on the phase difference (Sagnac phase difference) between two light beams transmitted in both directions in an optical ring circuit comprising a fiber coil and the EDWA. In another embodiment of the invention, the fiber loop is replaced by a coiled waveguide implemented on the same or on a separate substrate as the EDWA.

### Raman Waveguide Amplifier

FIG. X6 shows an embodiment of a Raman waveguide amplifier according to the present invention. The Raman waveguide amplifier is an amplifier comprising a waveguide section constructed from a material with high inelastic scattering coefficient and pumped with a waveguide laser according to the present invention.

### Chirped Amplifier

An embodiment of the invention as a chirped pulse amplifier comprising the EDWA of the present invention as a mode-locked laser source and as a section of a broadband amplifying medium with high dispersion to transform and compress the pulses temporally.

### Narrow Band-Width Amplifier

An embodiment of the invention as a narrow bandwidth amplifier comprising an EDWA of the present invention constructed together with an optical feedback element that selectively feeds back a narrow range of wavelength for further amplification.

### Further Functions for Switch/Amplifier

Optical amplifying WDM modules

Lossless optical add/drop multiplexer and demultiplexer

Optical matrix switch with optical amplification

Optical channel monitors with high dynamic range

Dynamic gain equalizer with combined C-band and L-band in 1500-nm optical communication window

Lossless tunable filter used in optical DWDM networking

Wavelength converter

### Electrical Characterization of Symmorphix Rare Earth Doped and Undoped Optical Alumino-Silicate Films by Capacitance-Voltage and Current-Voltage Measurements

The films in this report are nominal 200 nm thick oxide films deposited by RF and RPDC magnetron sputtering in high vacuum at room temperature under conditions of about 100 Watts of 2 Megahertz substrate bias power. The net deposition rate was between about 0.3 and 0.8 microns per hour. The films demonstrate hysterics free CV behavior as shown in these graphs, indicative of alkali free dielectrics. The CV and IV data demonstrate that the films are very high quality insulating and capacitive films suitable for use as barrier and gate dielectric applications at low temperature.

The very high IV voltage to breakdown and the low associated conductivity together with the large induced internal negative charge induced in these films by annealing at 800 deg. C., indicates that these films have a very high probability of providing high levels of induced poled fixed charge when the film is simultaneously subjected to high temperature and high electrical potential. Consequently, high Pockel coefficients may reasonably be expected to achieve so that these films might be utilized for nonlinear electro-optic applications such as modulation and switching. Values greater than 5 pico-meters/Volt might be expected. It is also probable that the rare earth ions present in the material may also be poled leading to direct external electrical switching of the emission transition moment for the optical excited states of the rare earth dopants.

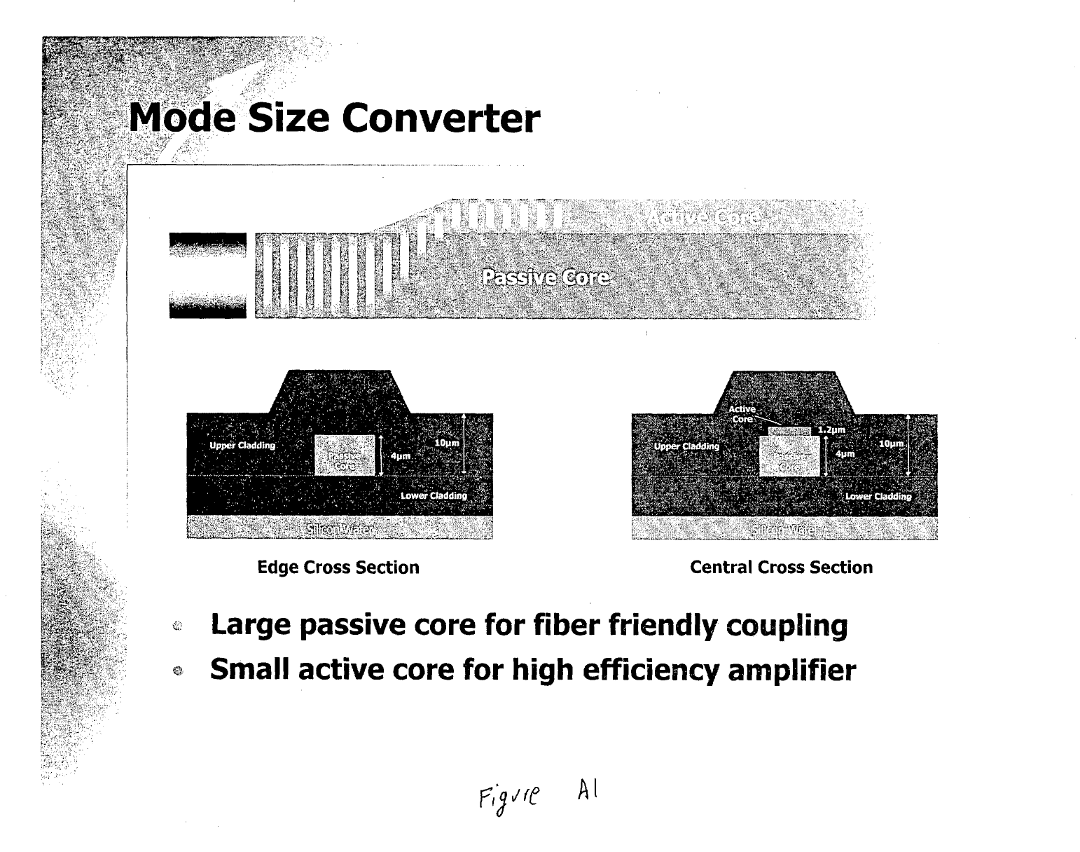

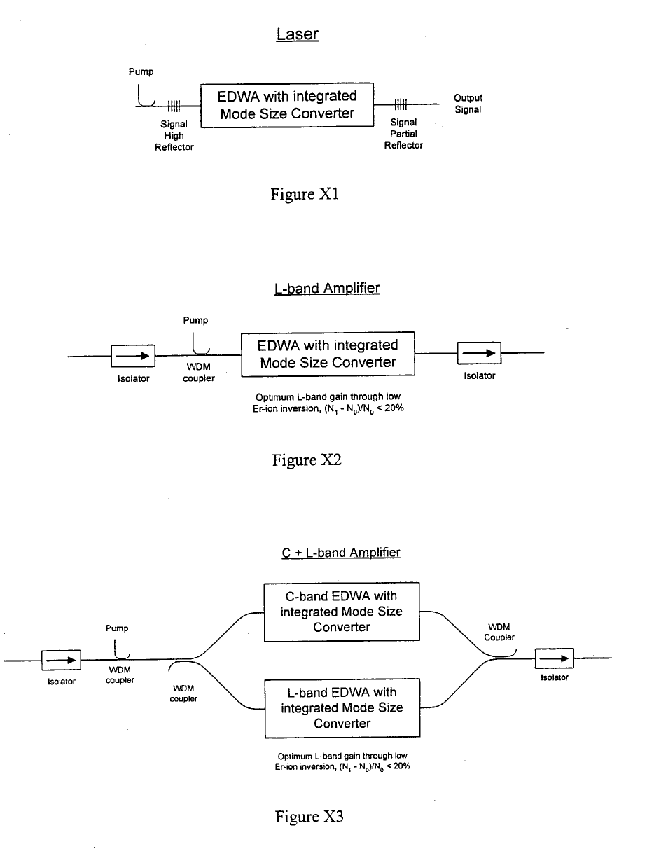

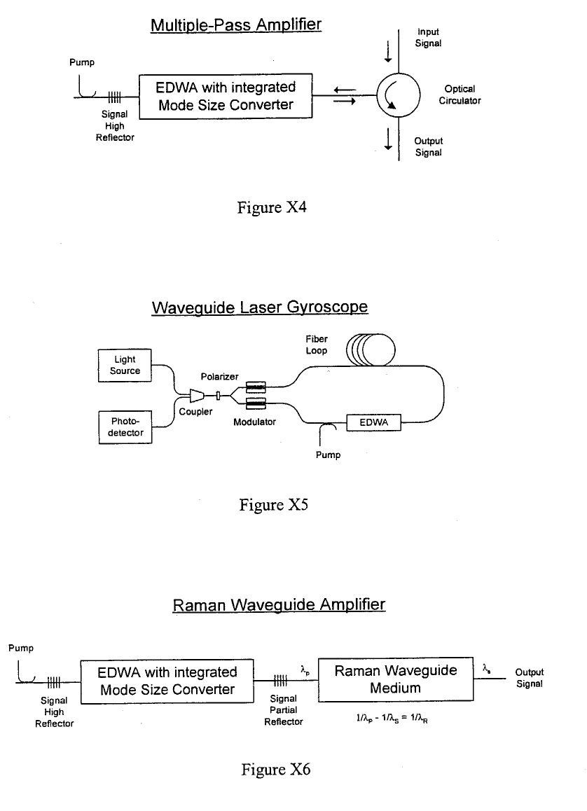

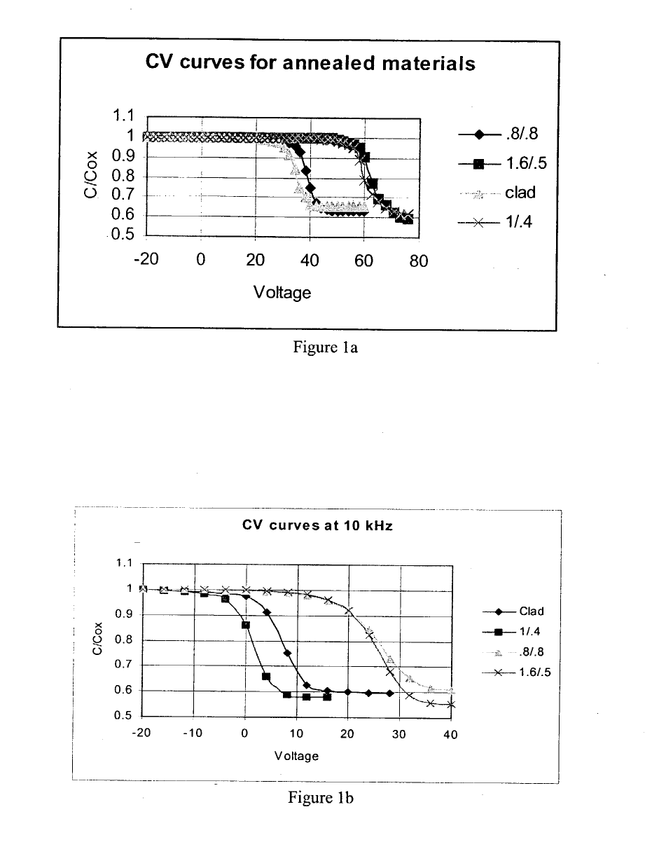

FIG. 1a shows that after annealing at 800 deg. C. for 30 minutes, these doped and undoped films develop significant positive flat band shift. This is most likely due to the formation of an internal net negative charge. The undoped clad film is 92 mole % silica and 8 mole % alumina. Note that the films with the higher flatbands have a net excess of Erbium over Ytterbium.

FIG. 1b shows that the 1/0.4 doped film with 60/40 Mole % silica/alumina sputtered from the oxide target has a flat band voltage of a few volts negative as deposited at 10 kHz. This would make a good gate oxide for application to low temperature processed polysilicon transistors, for instance, on a plastic substrate.

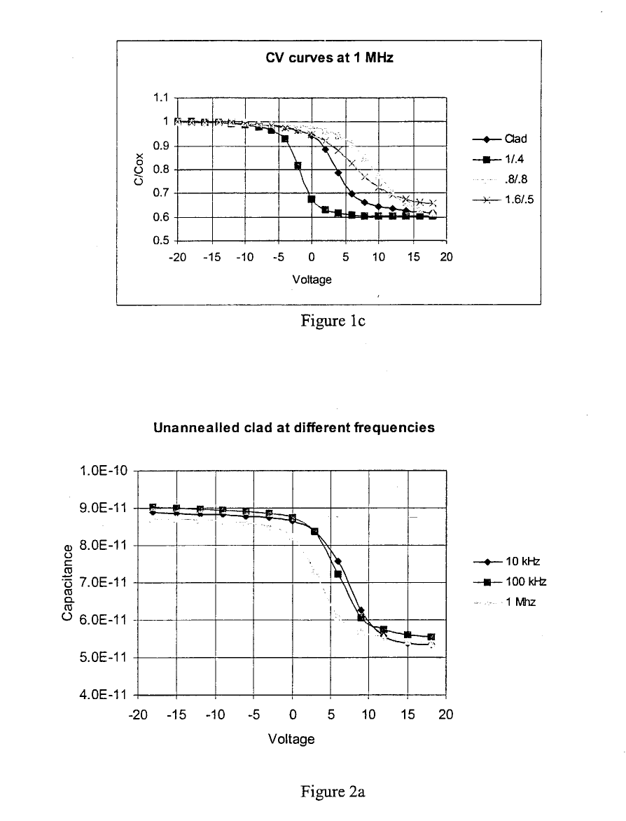

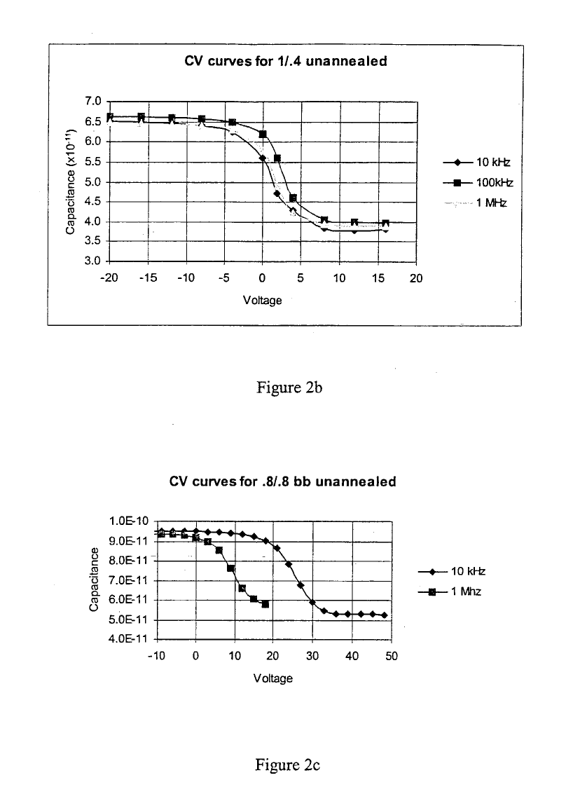

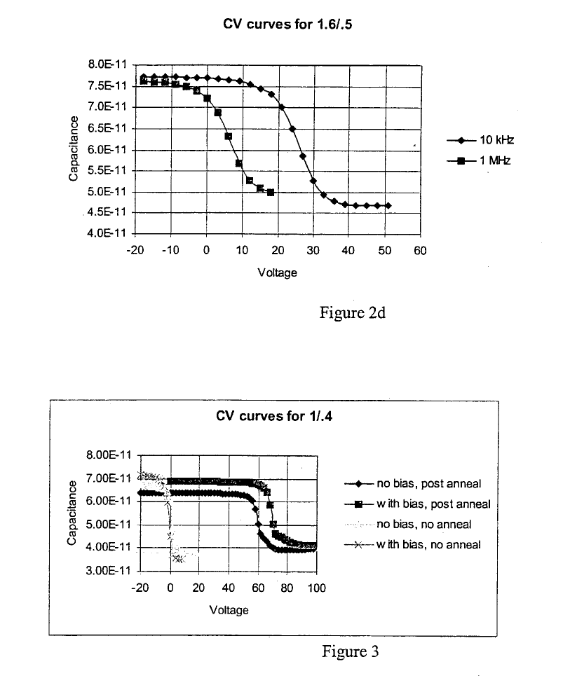

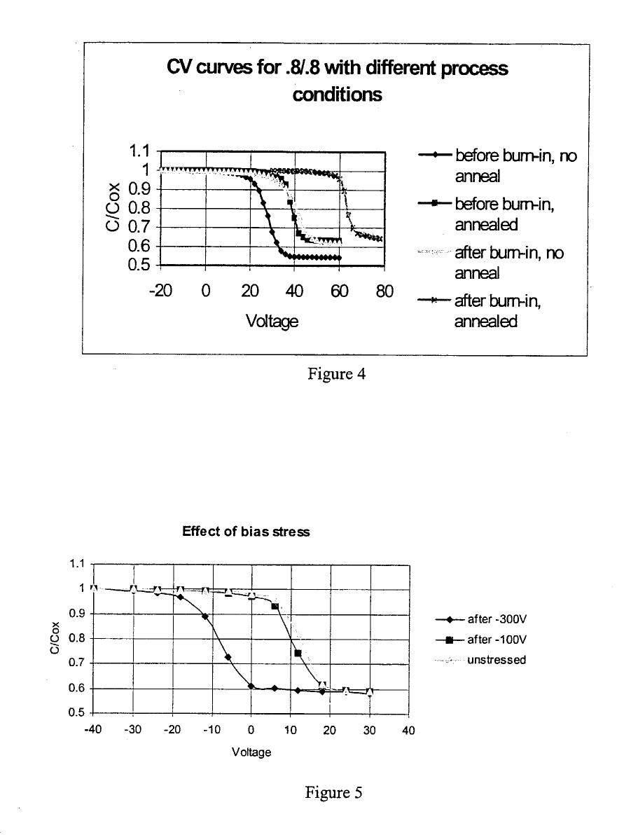

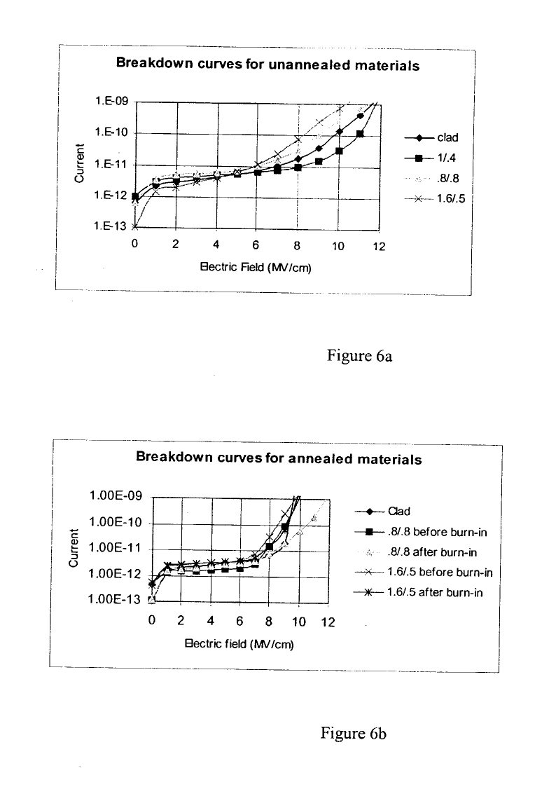

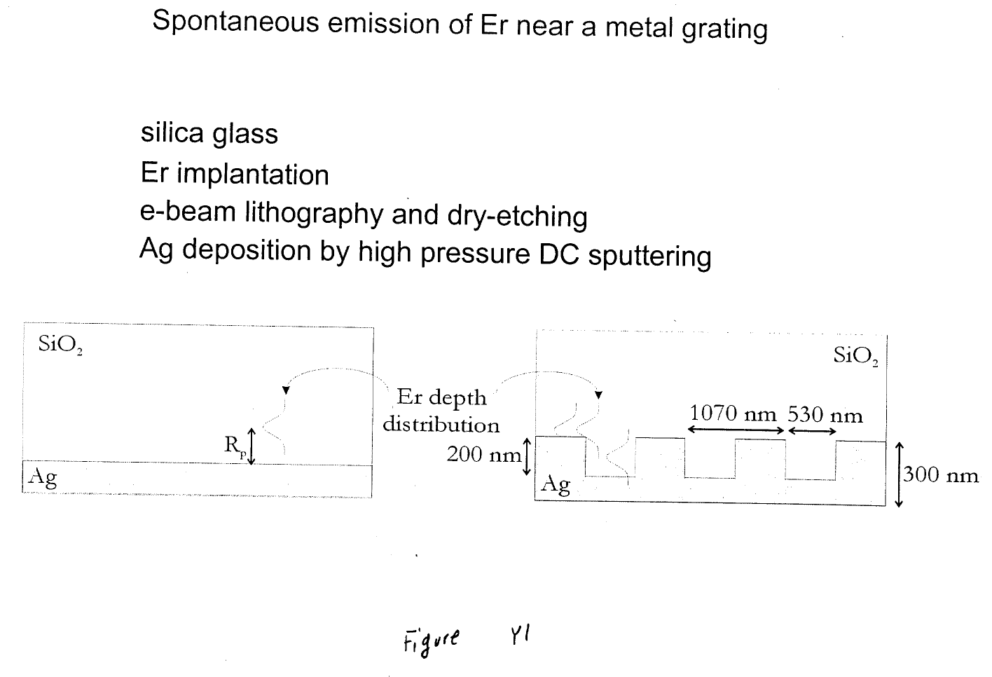

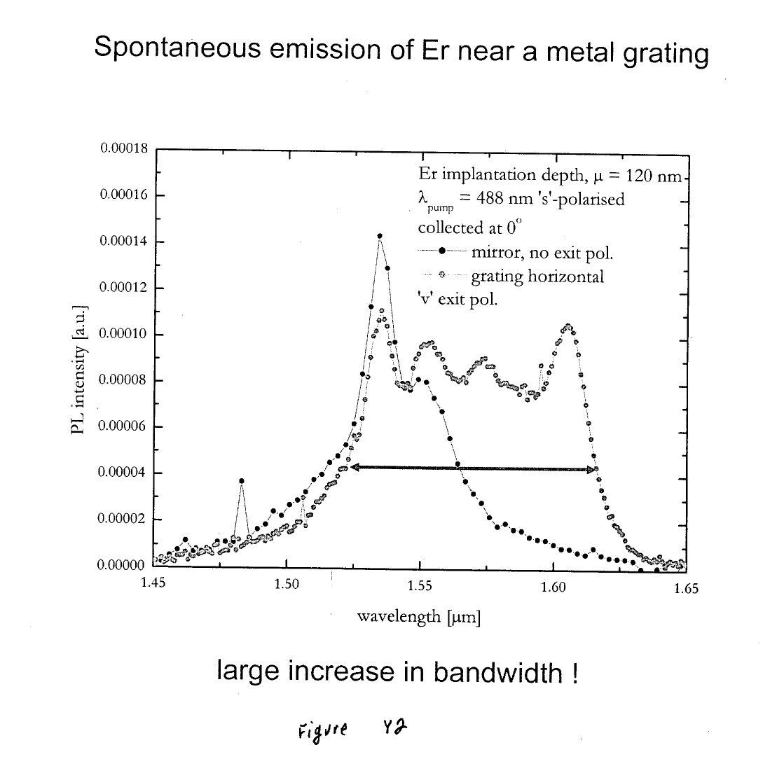

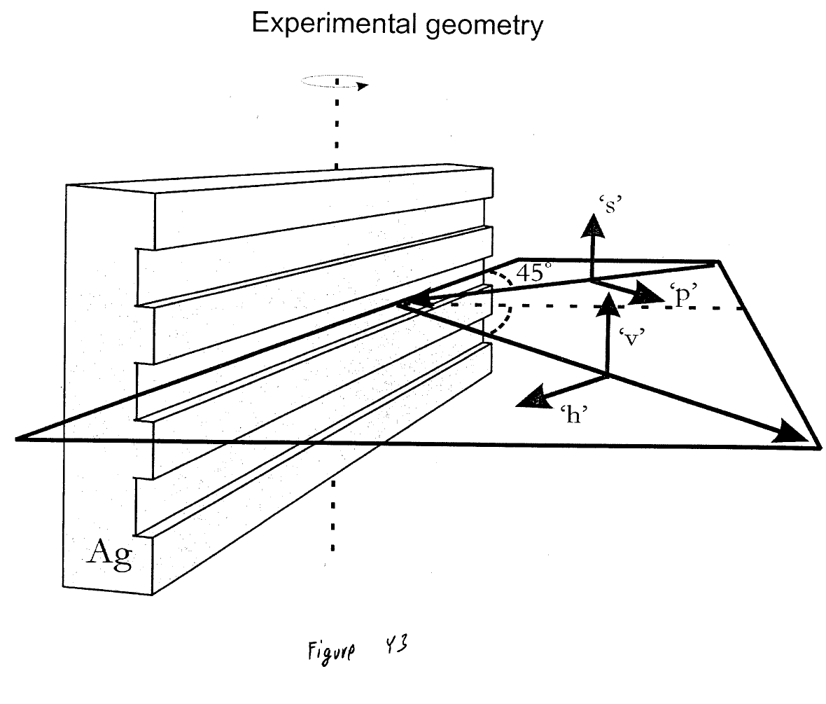

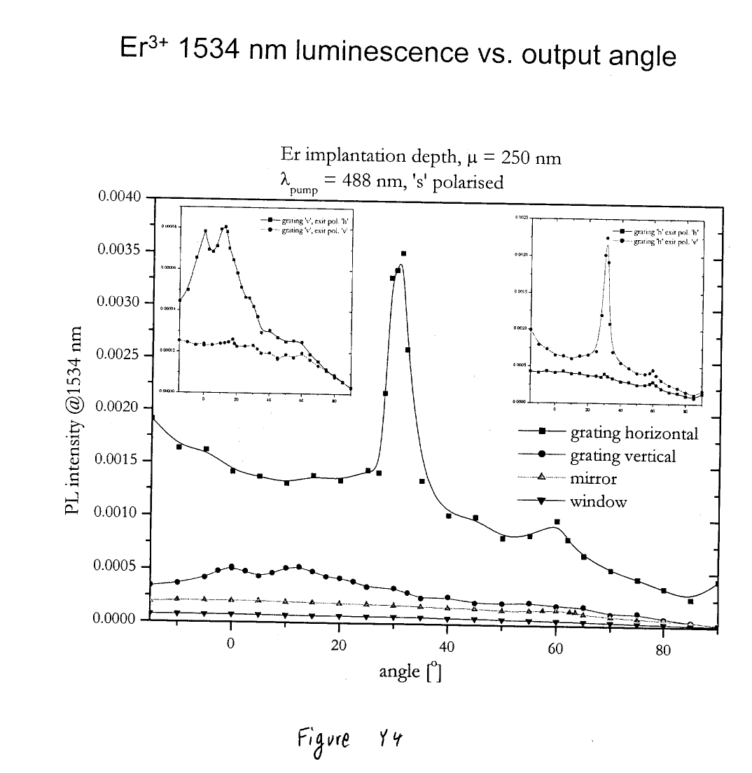

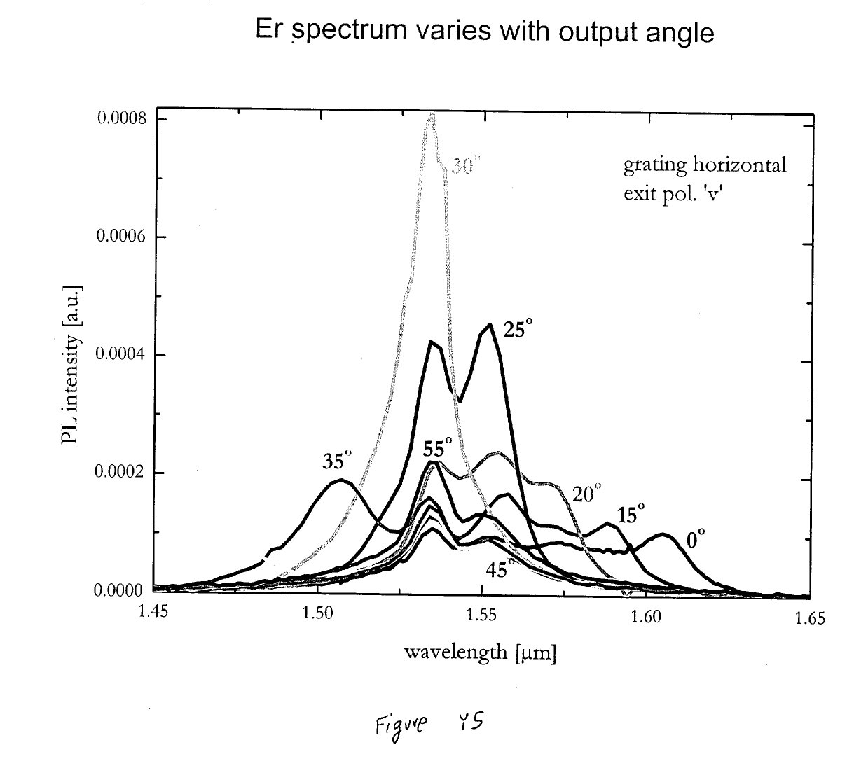

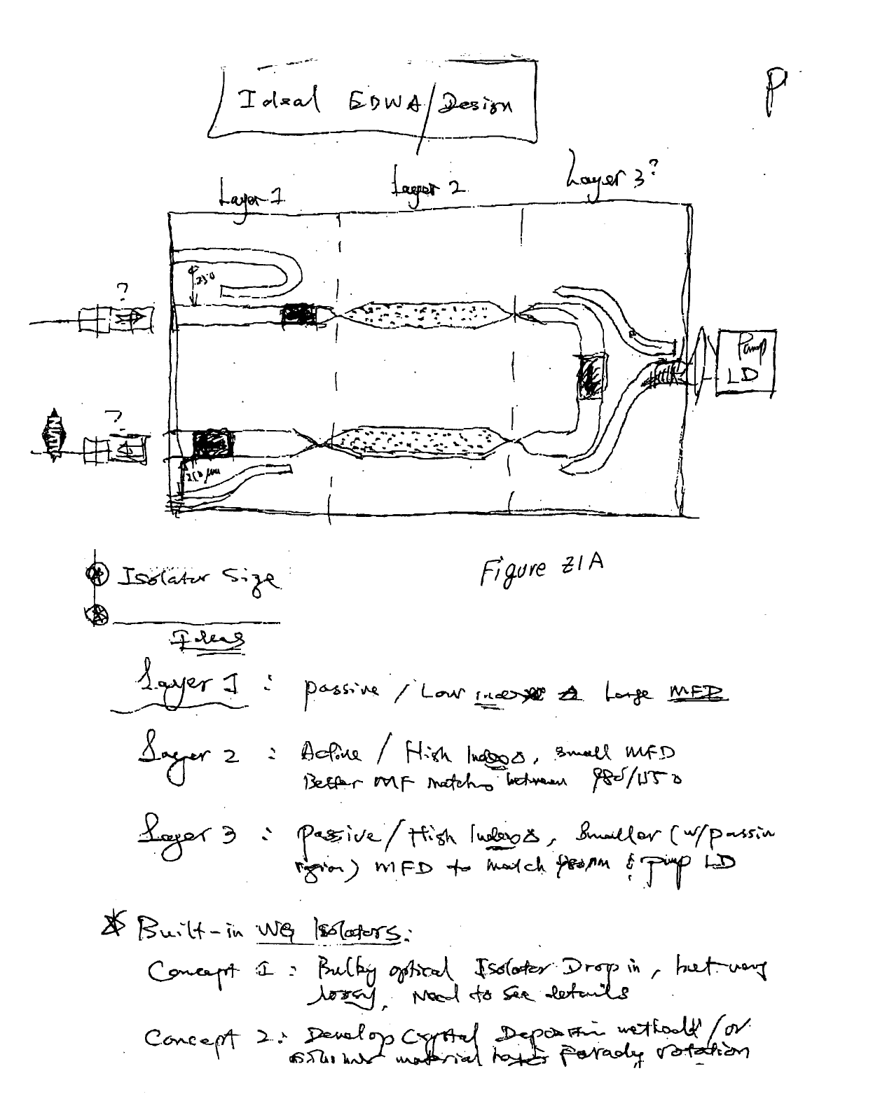

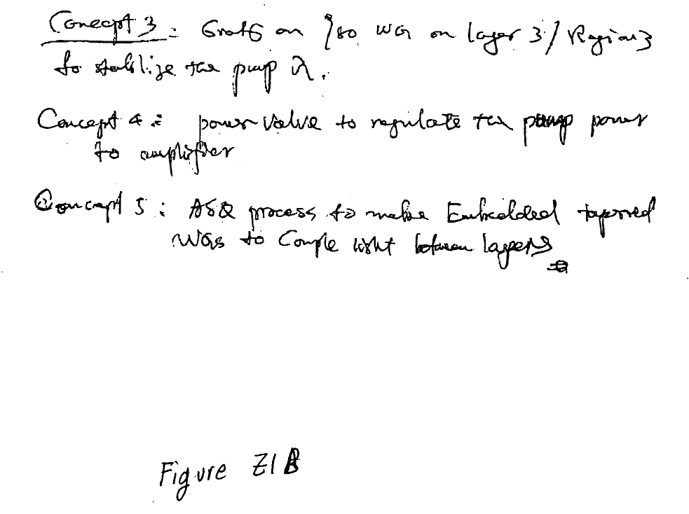

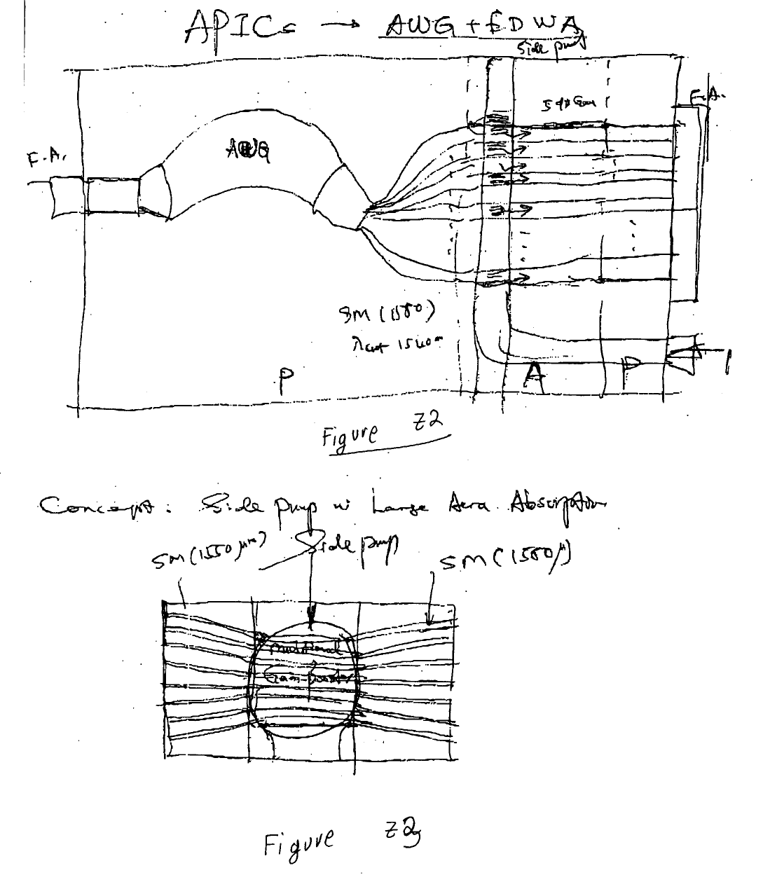

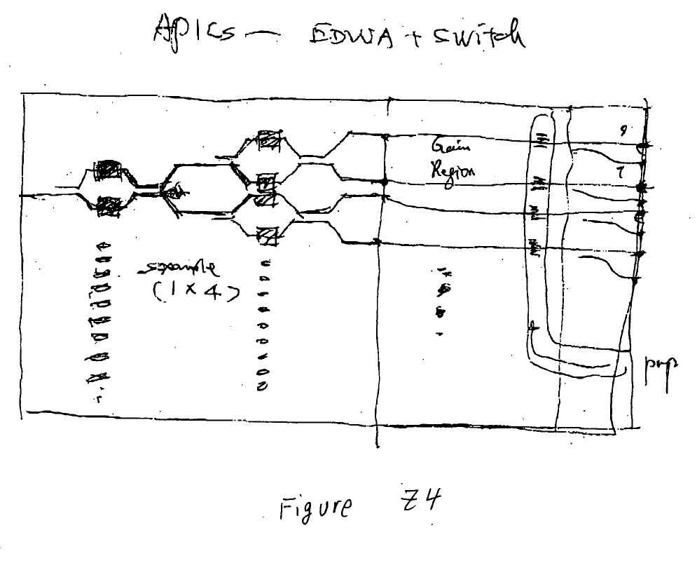

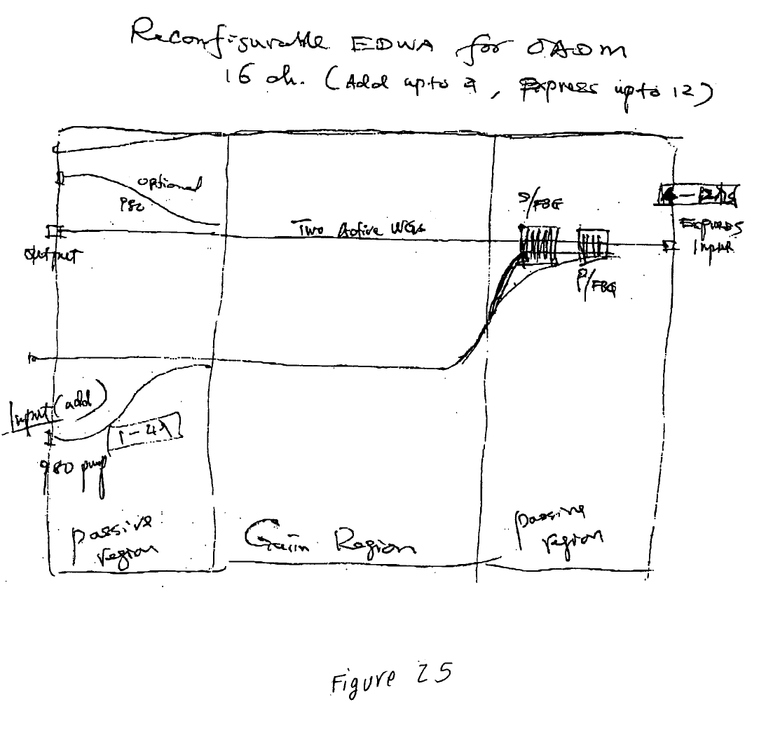

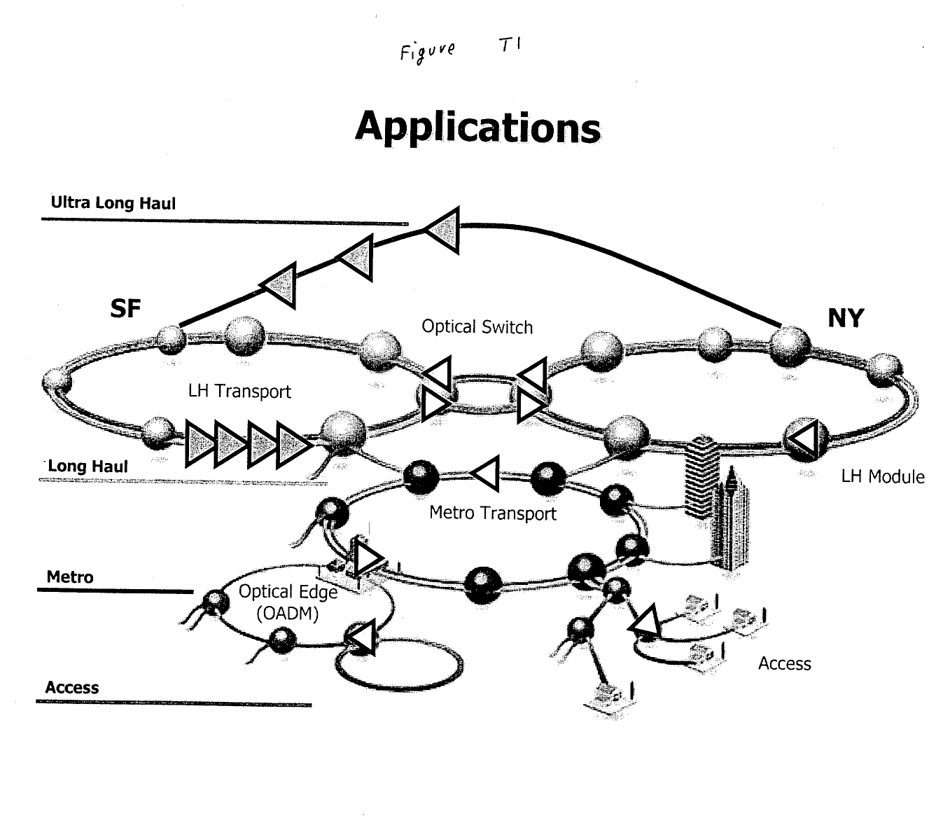

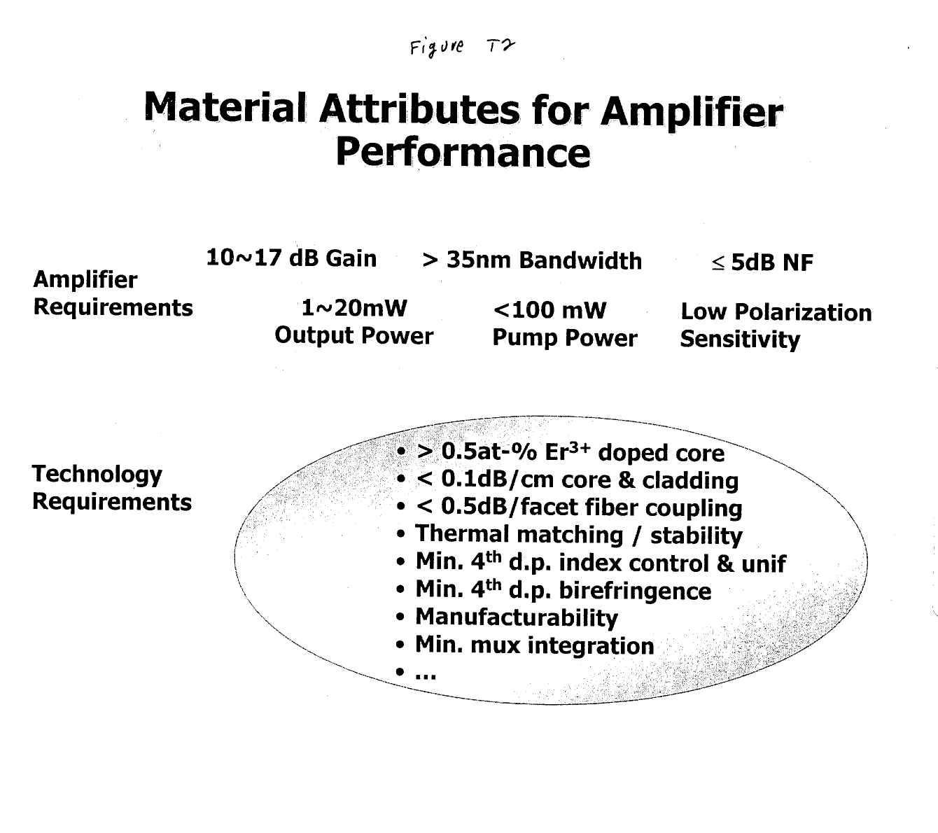

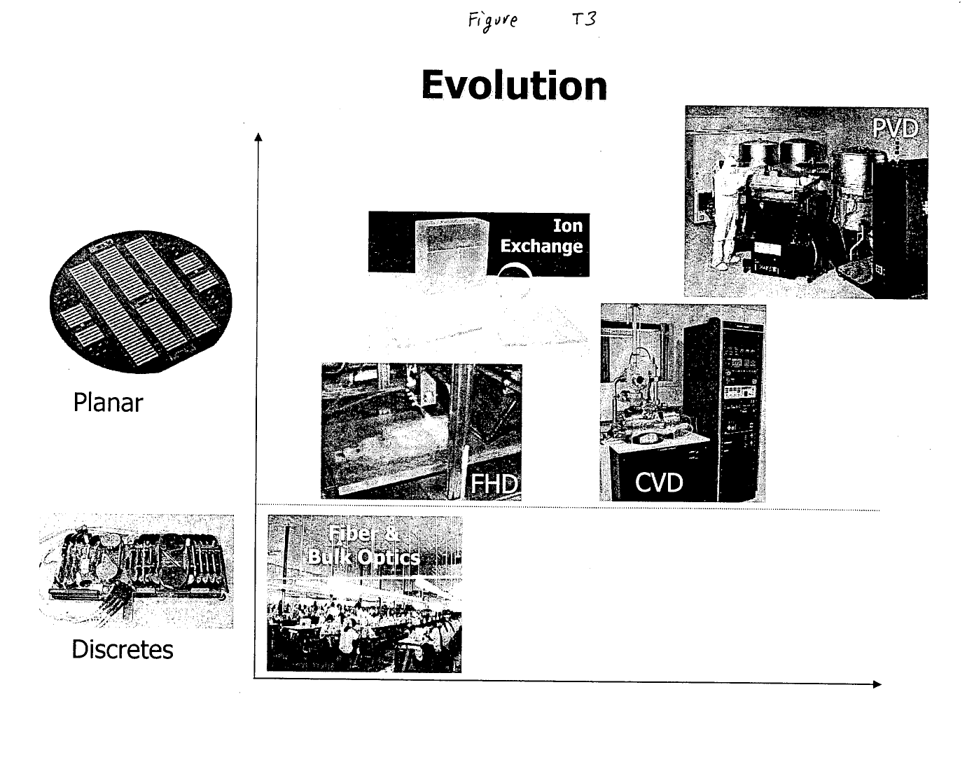

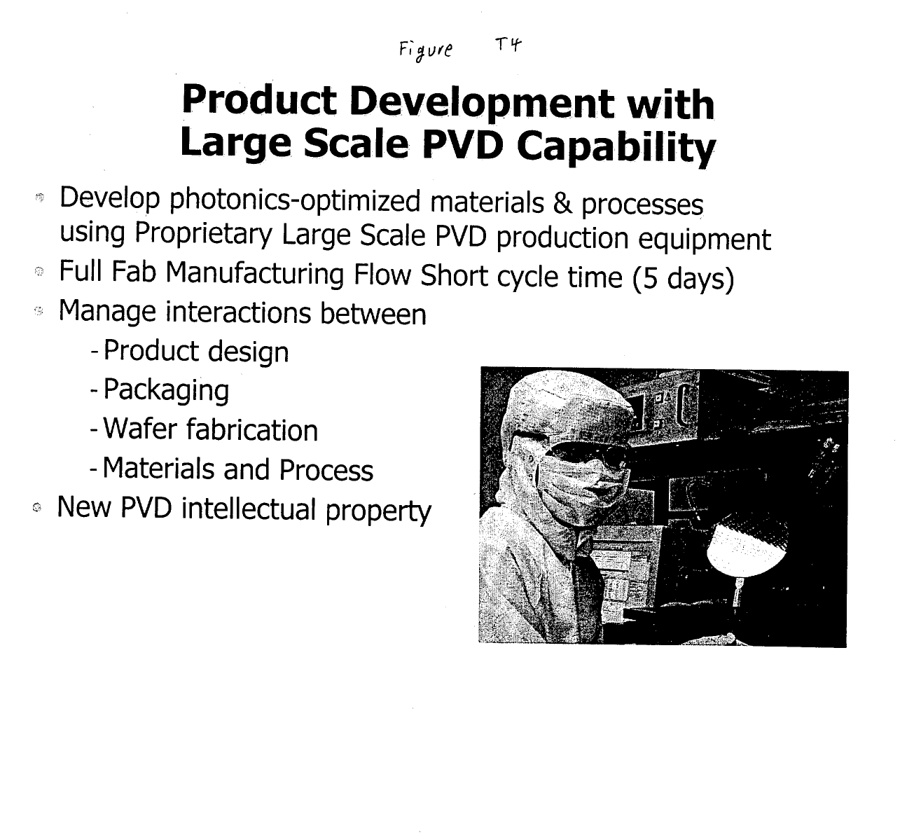

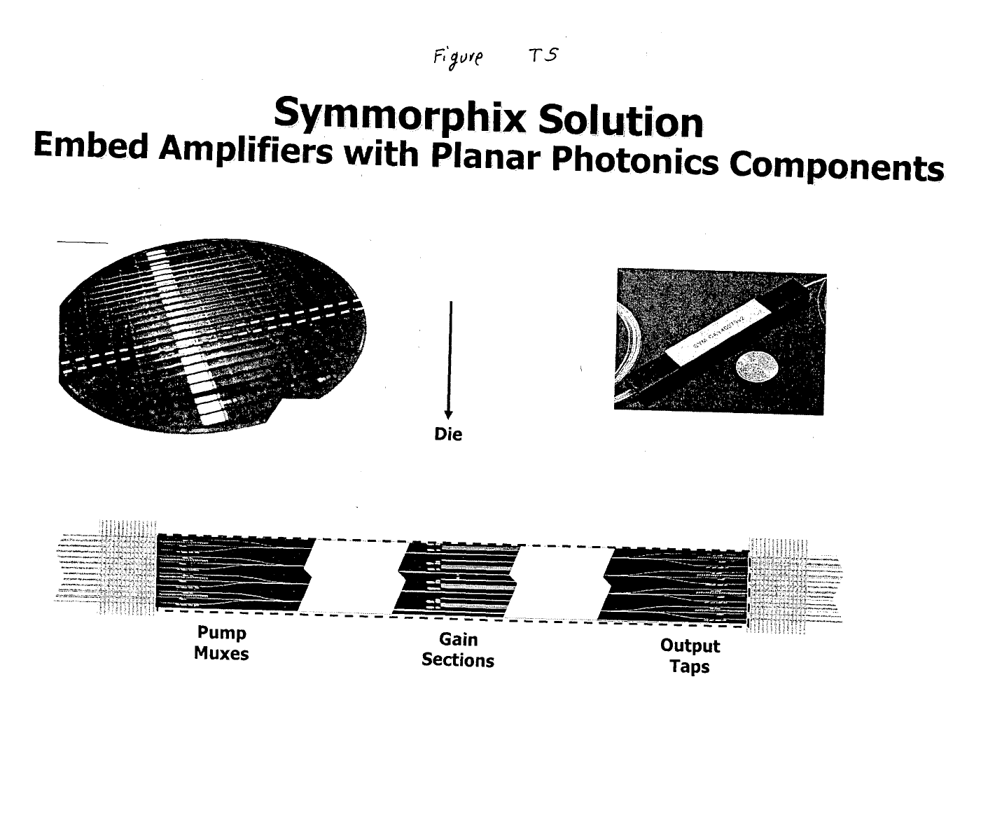

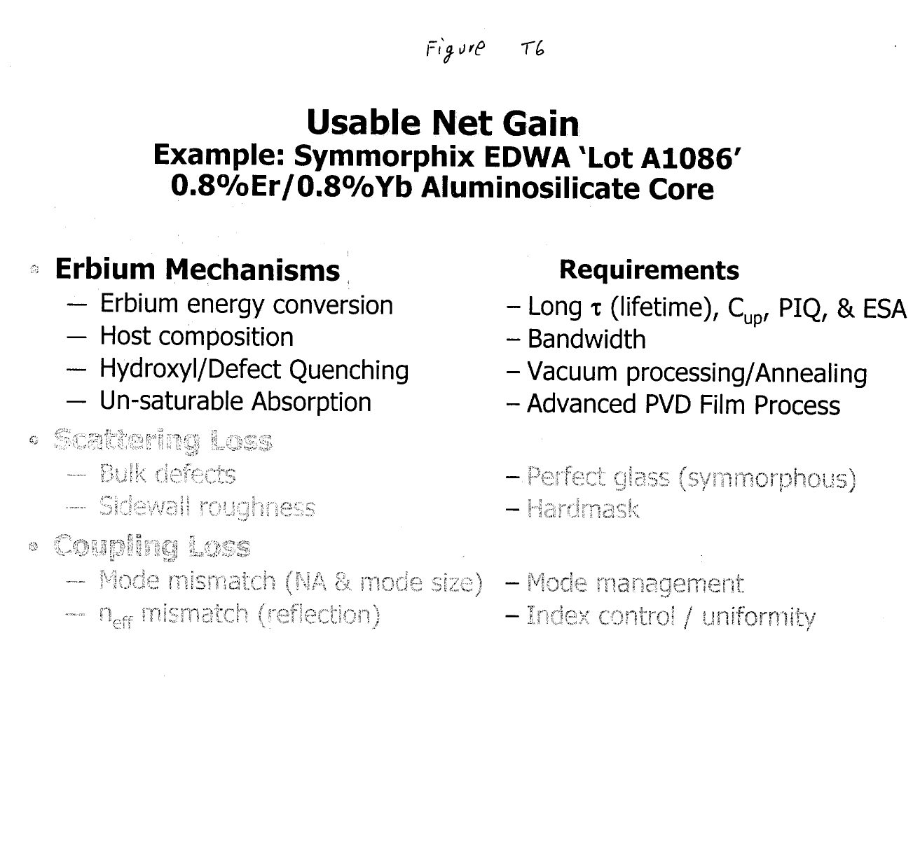

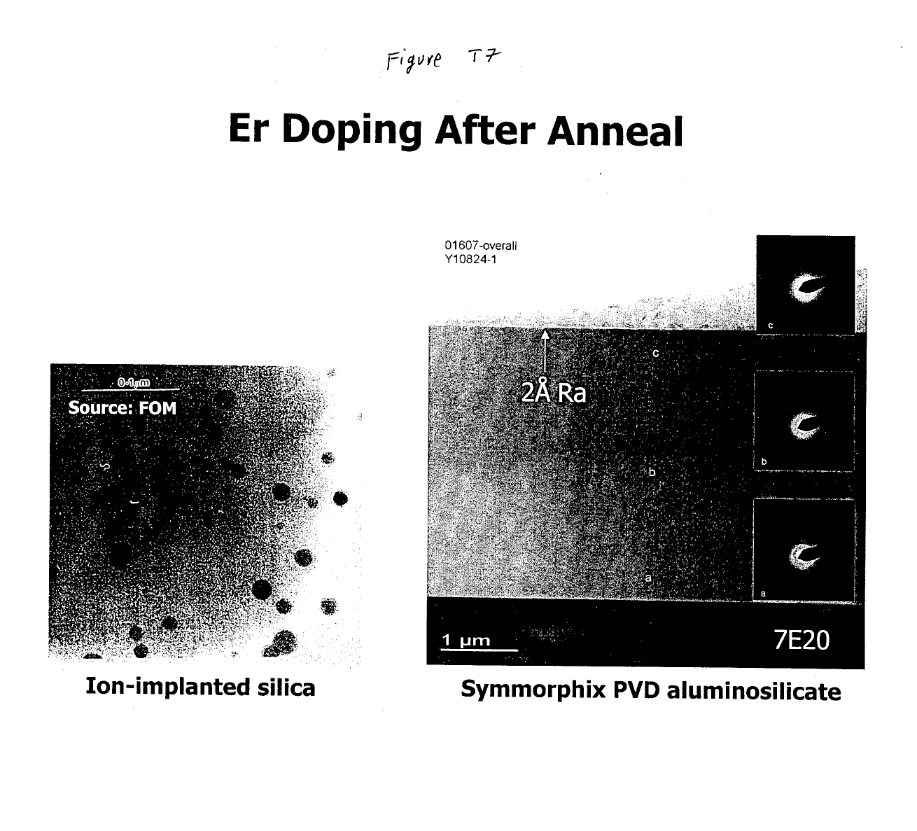

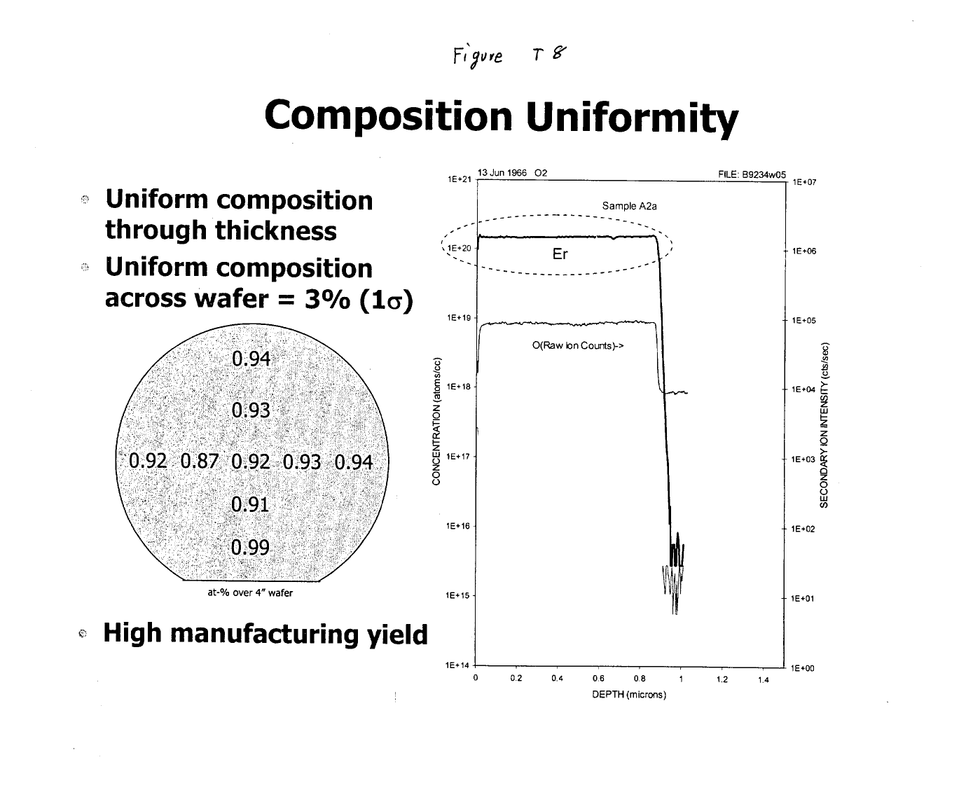

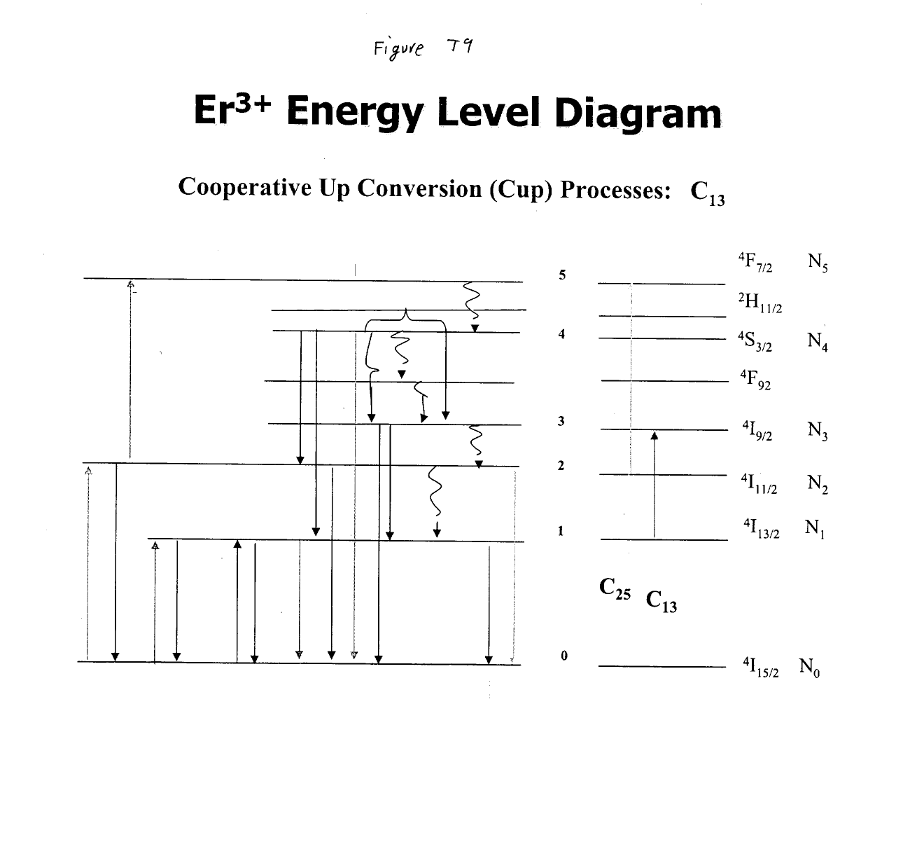

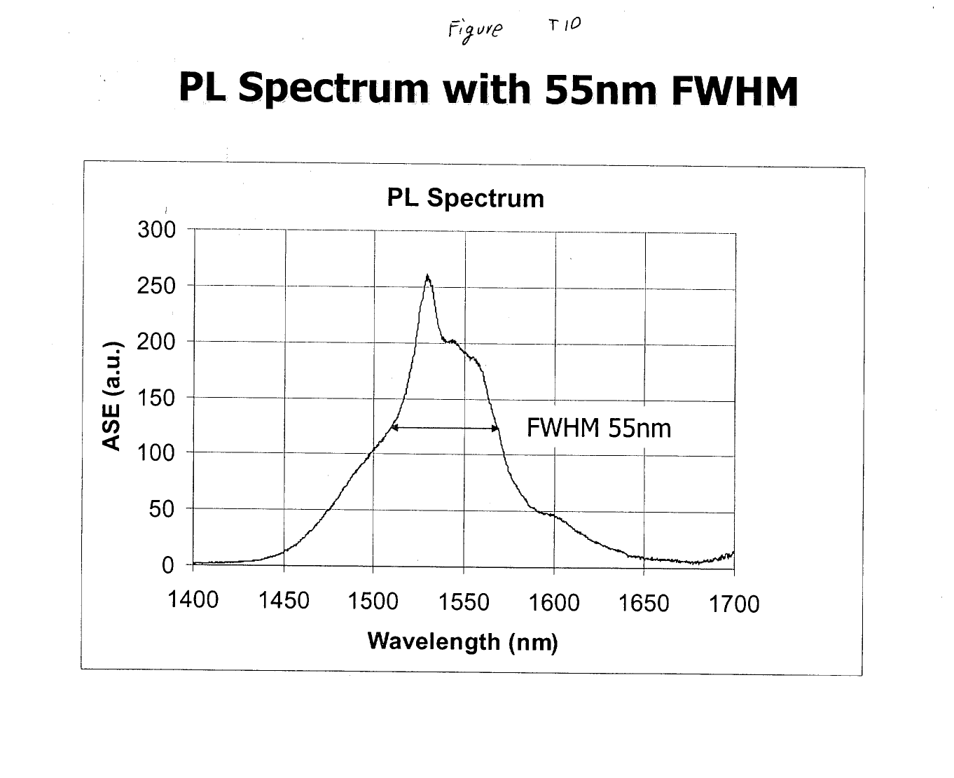

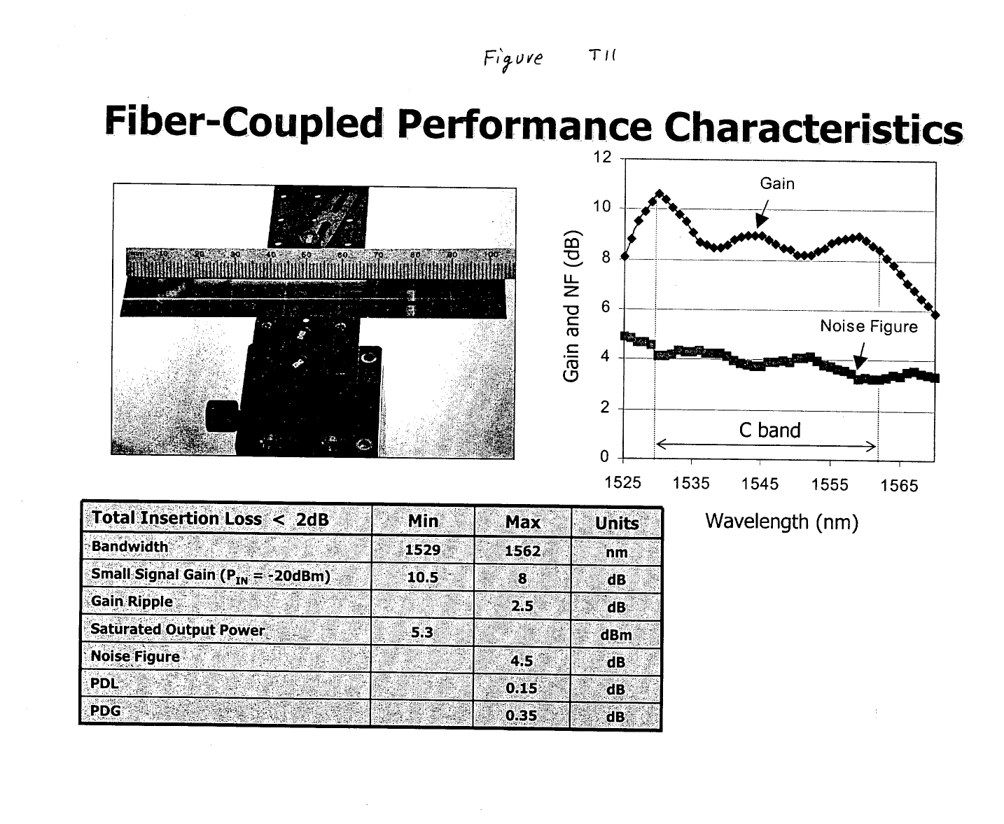

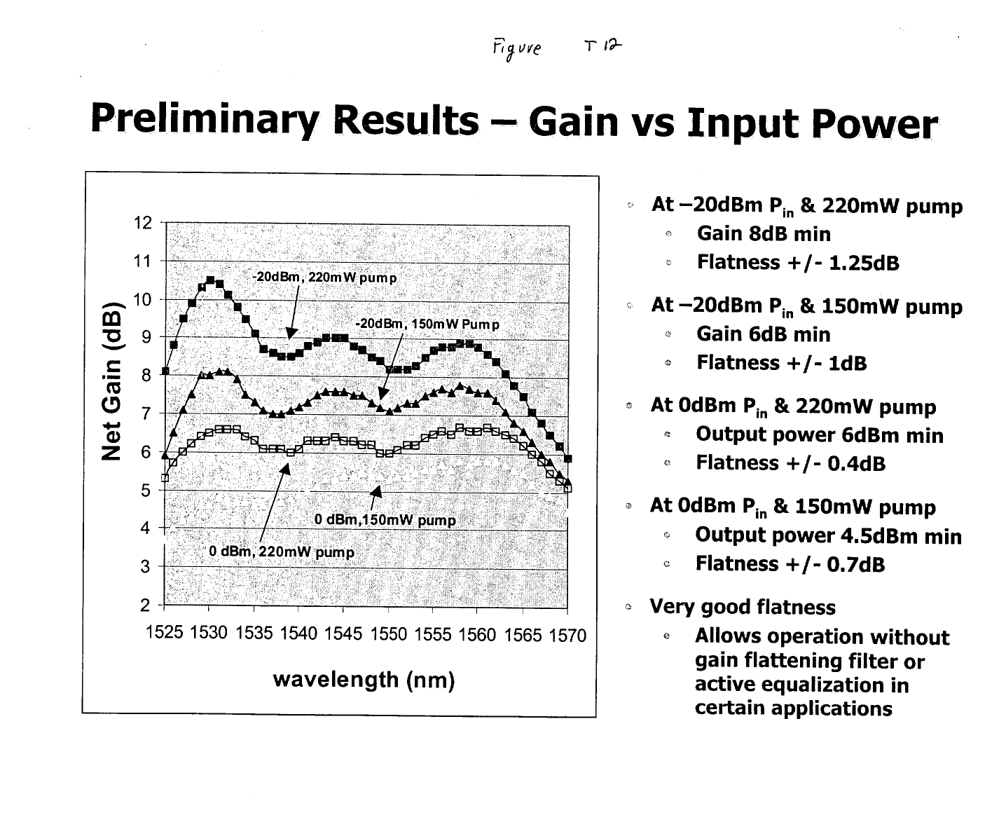

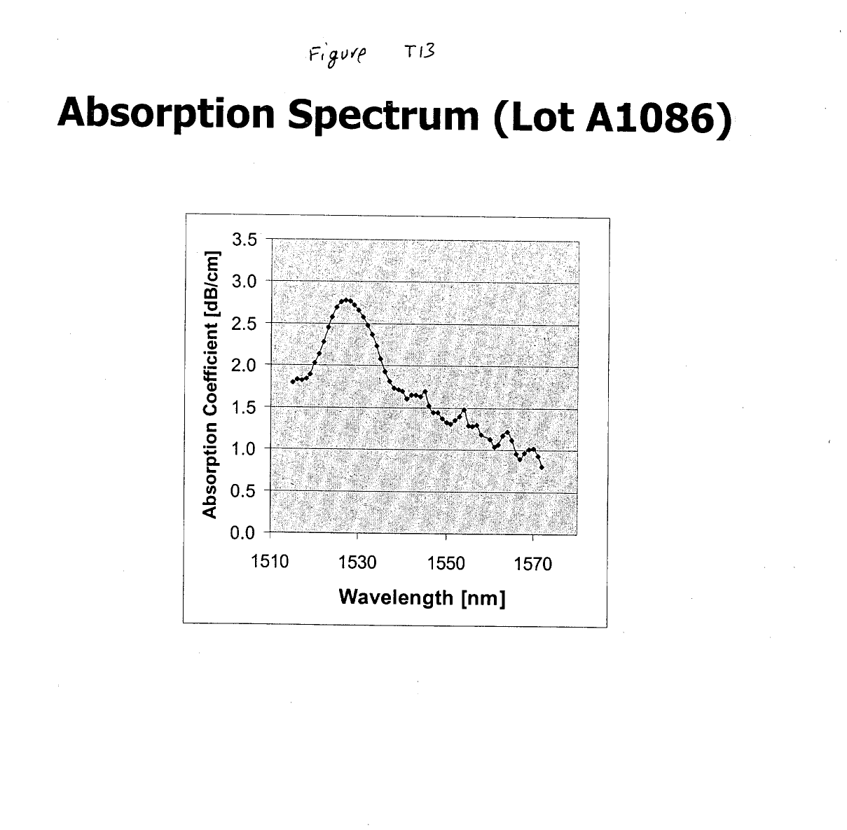

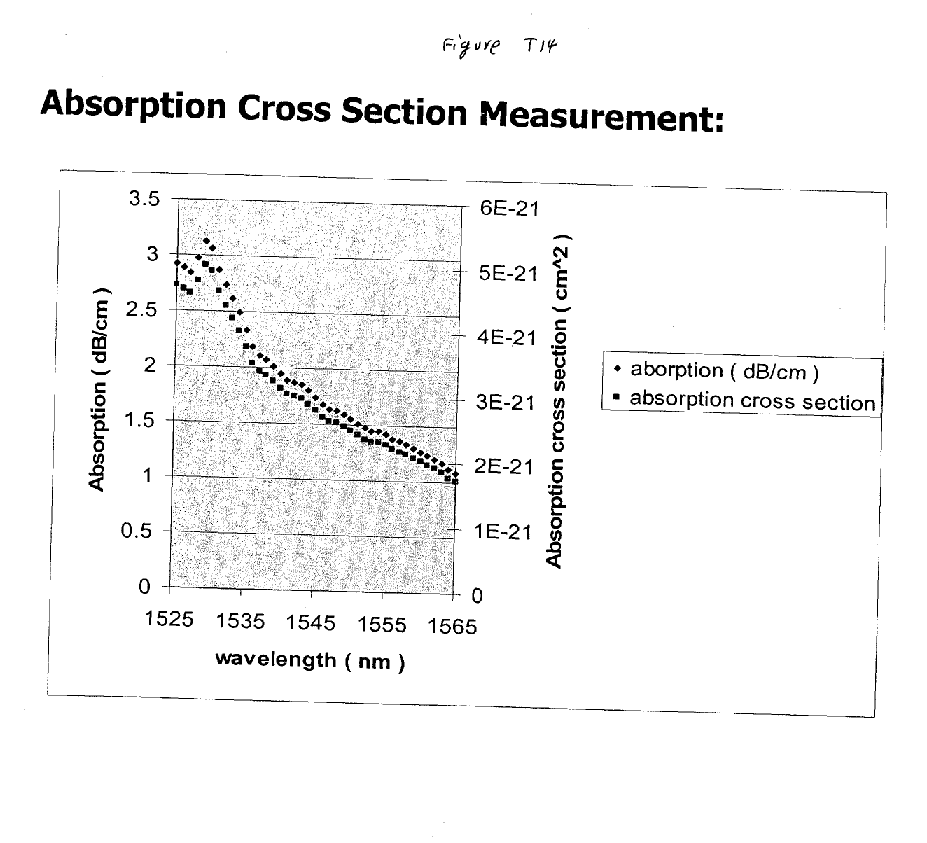

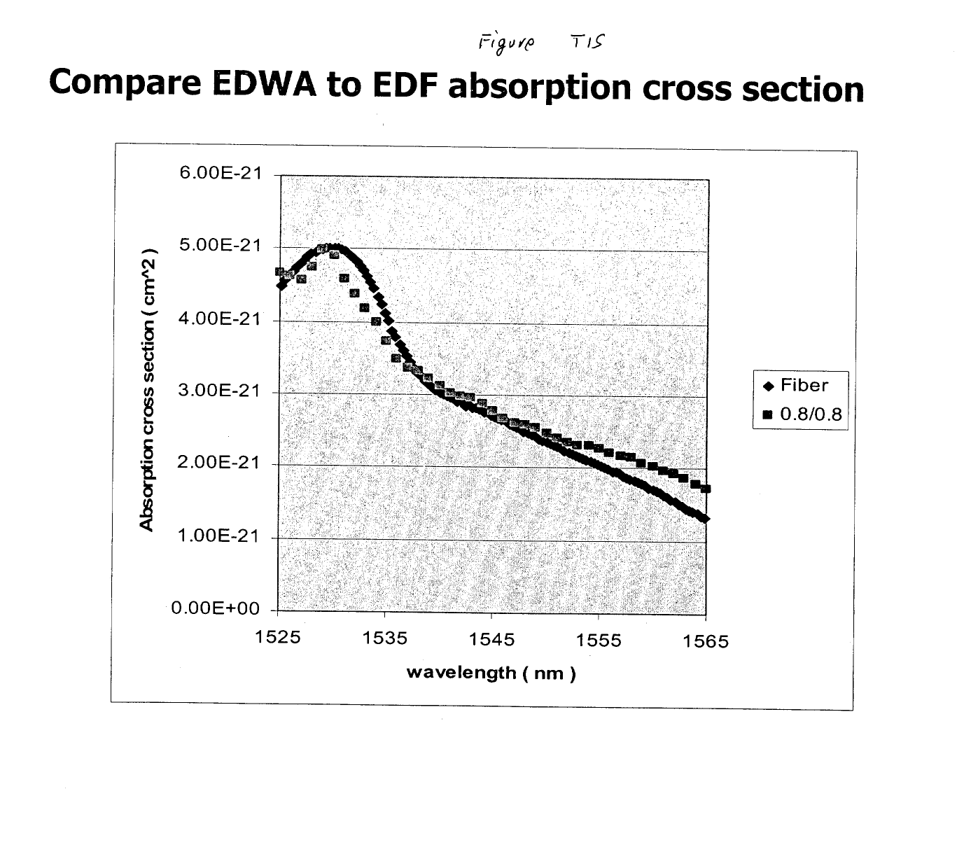

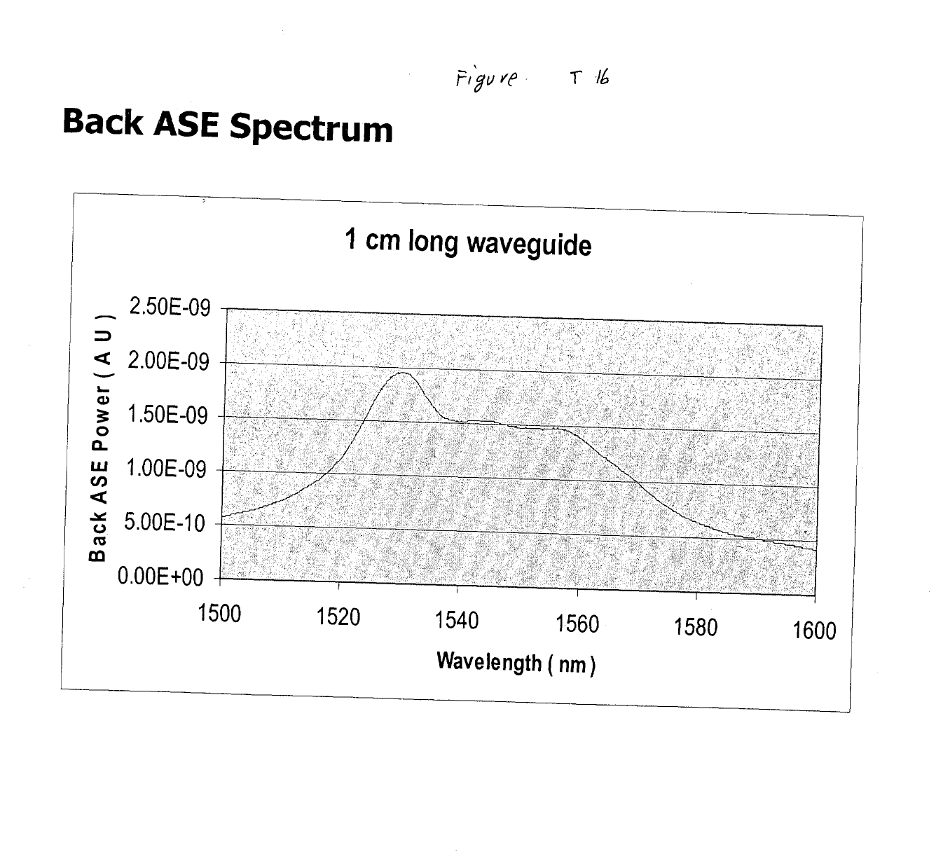

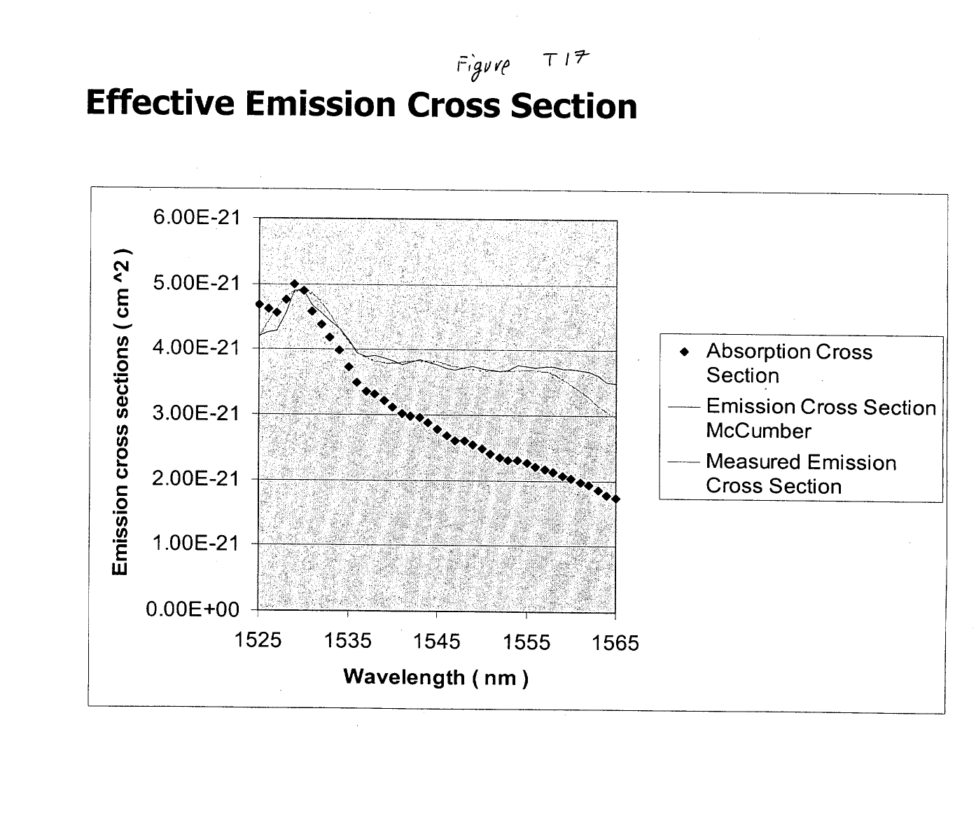

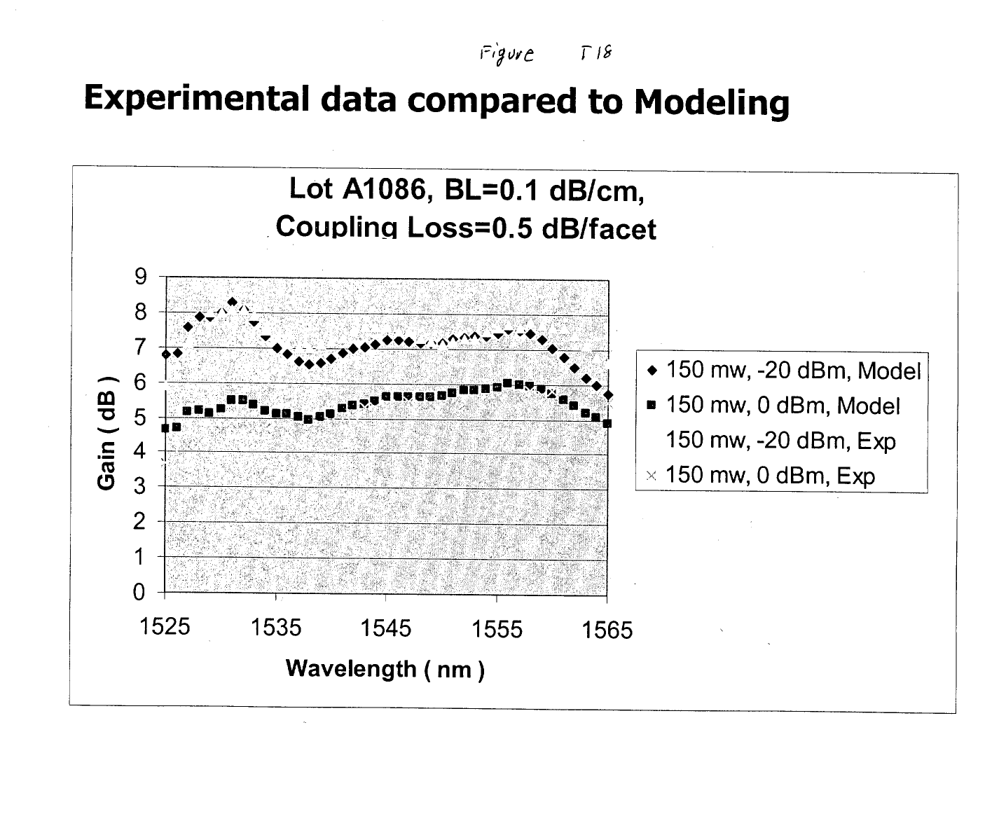

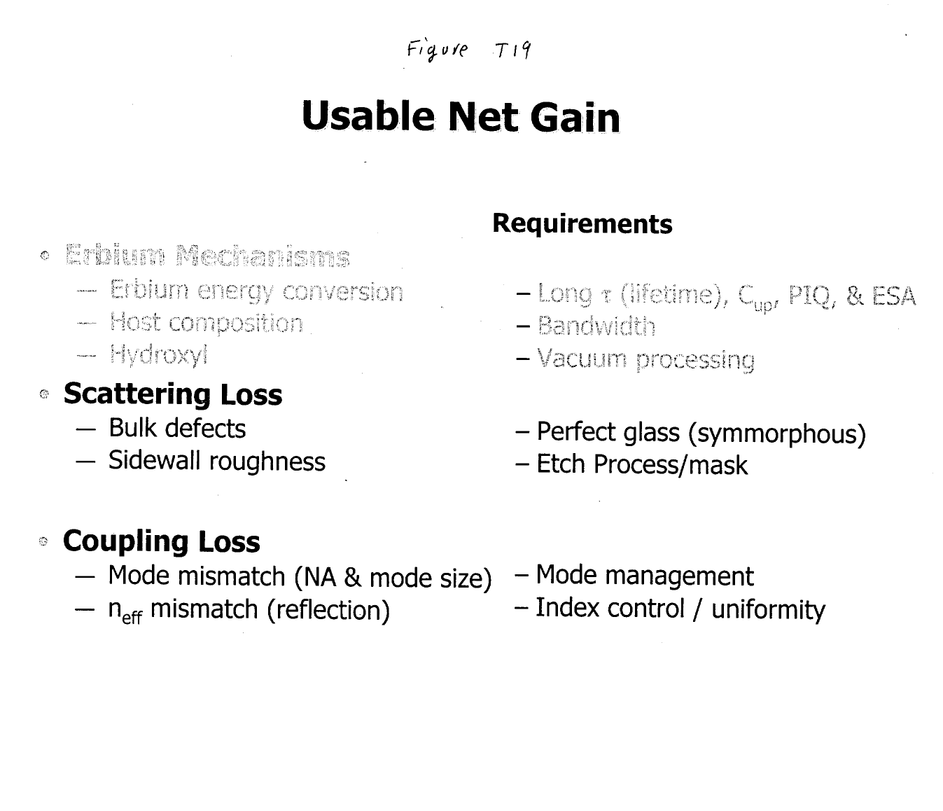

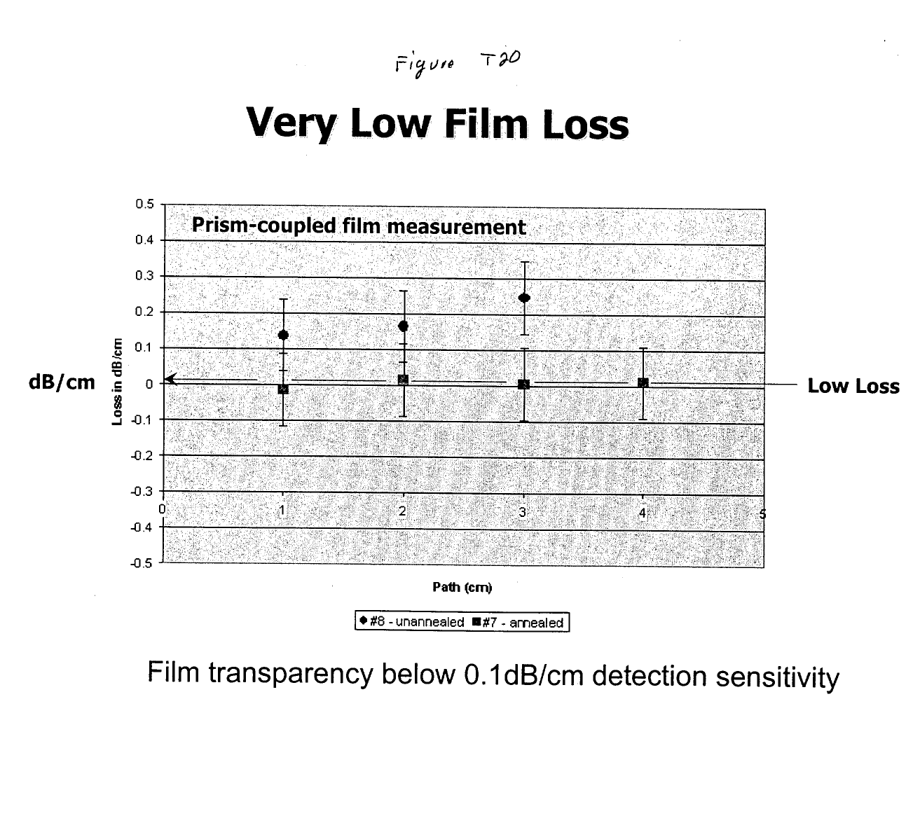

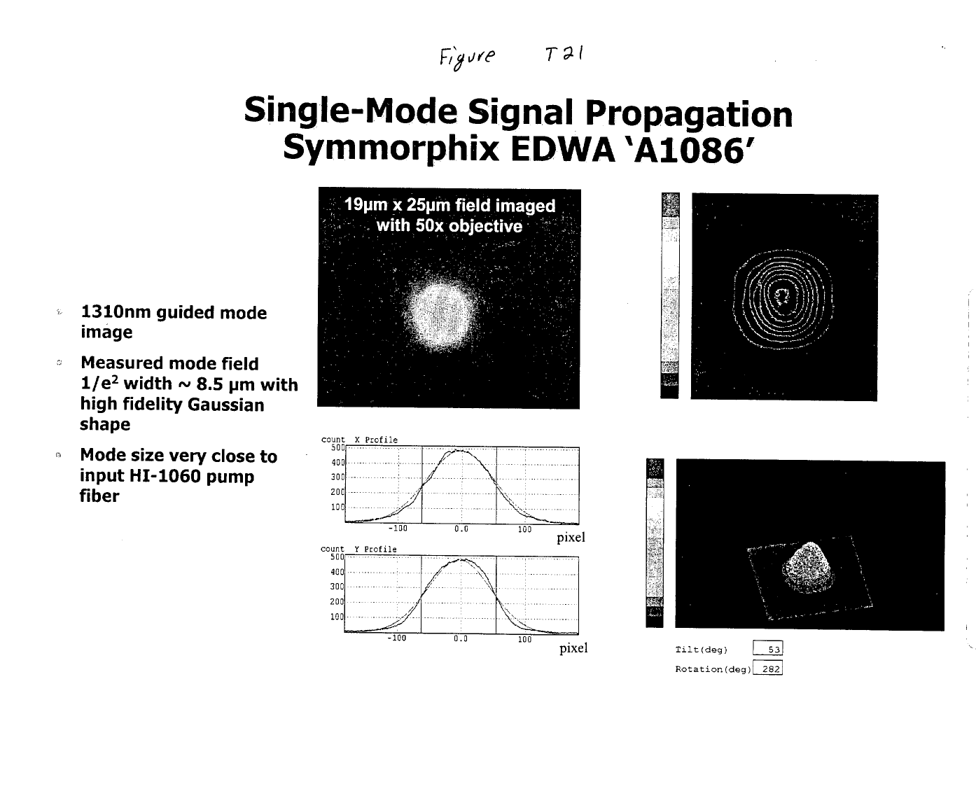

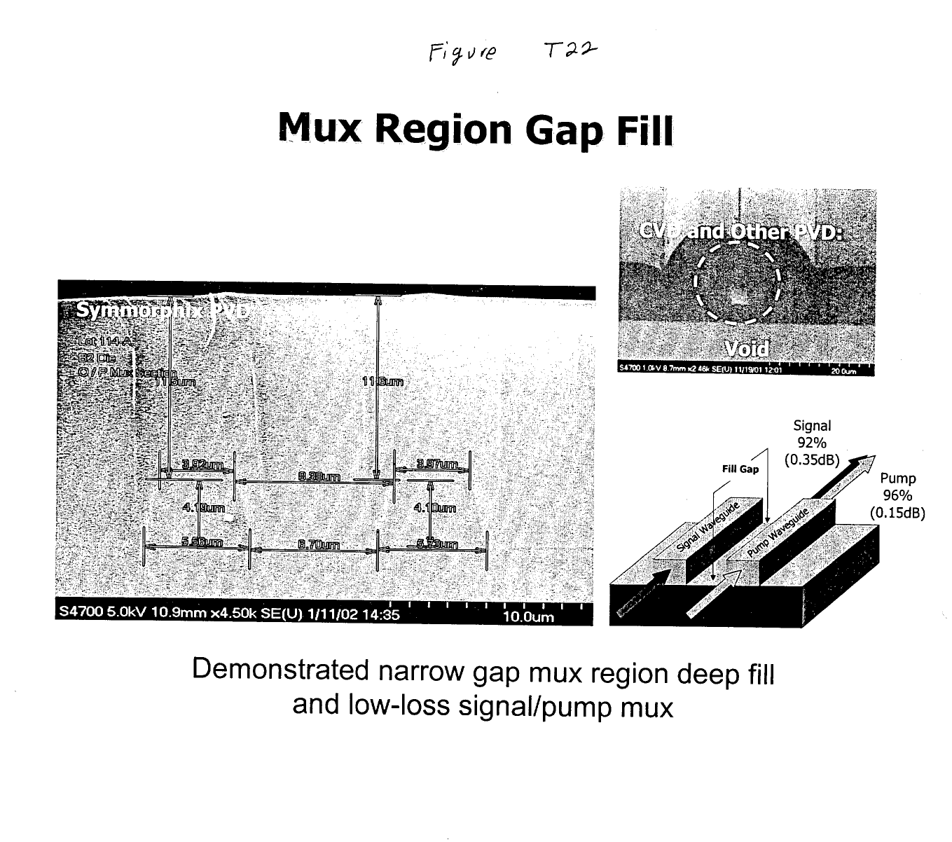

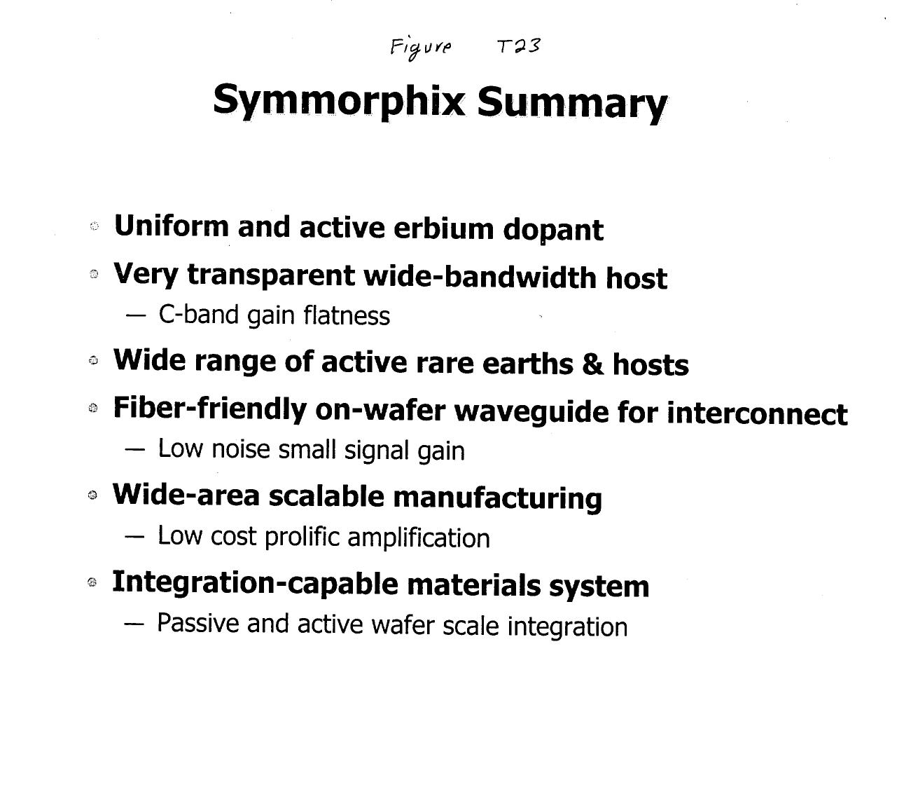

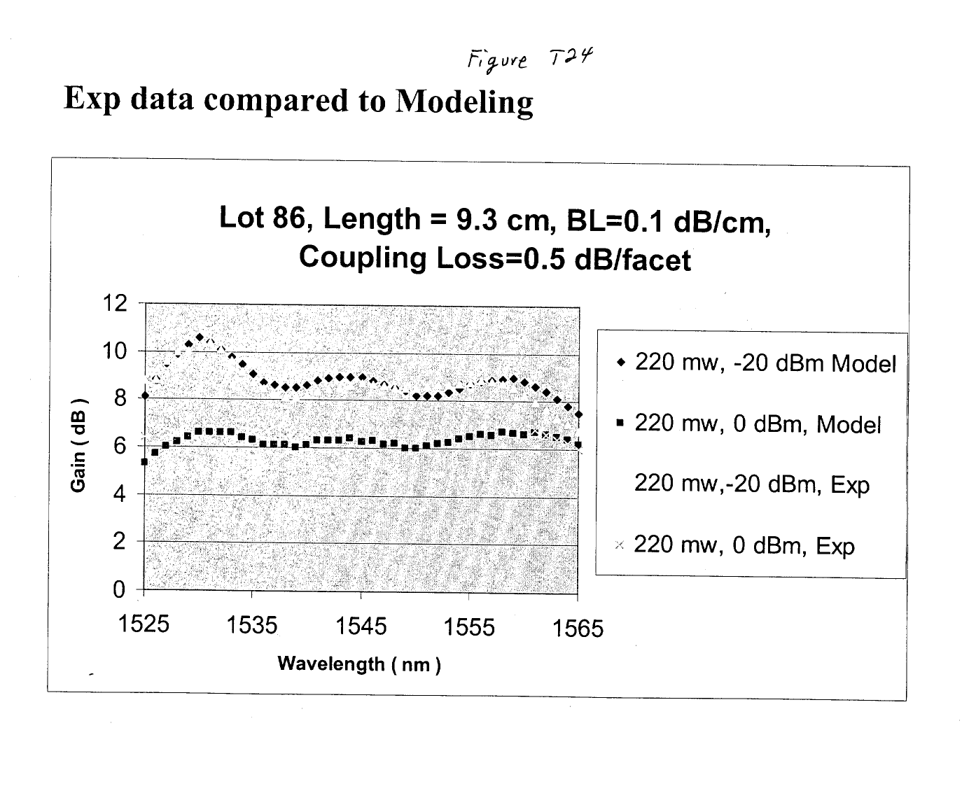

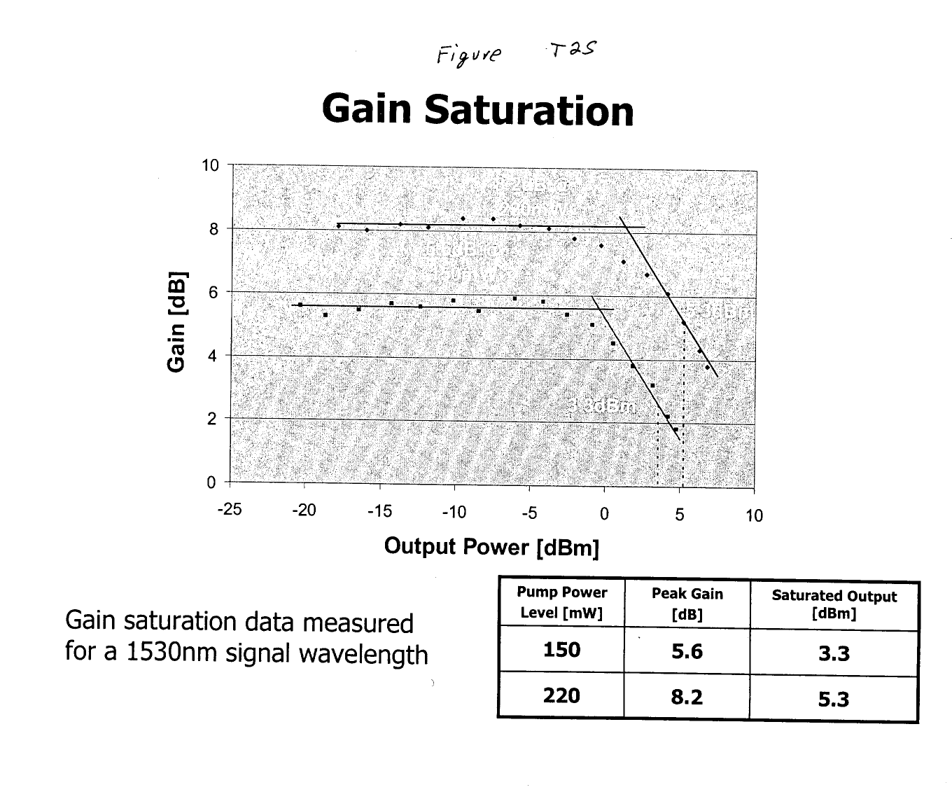

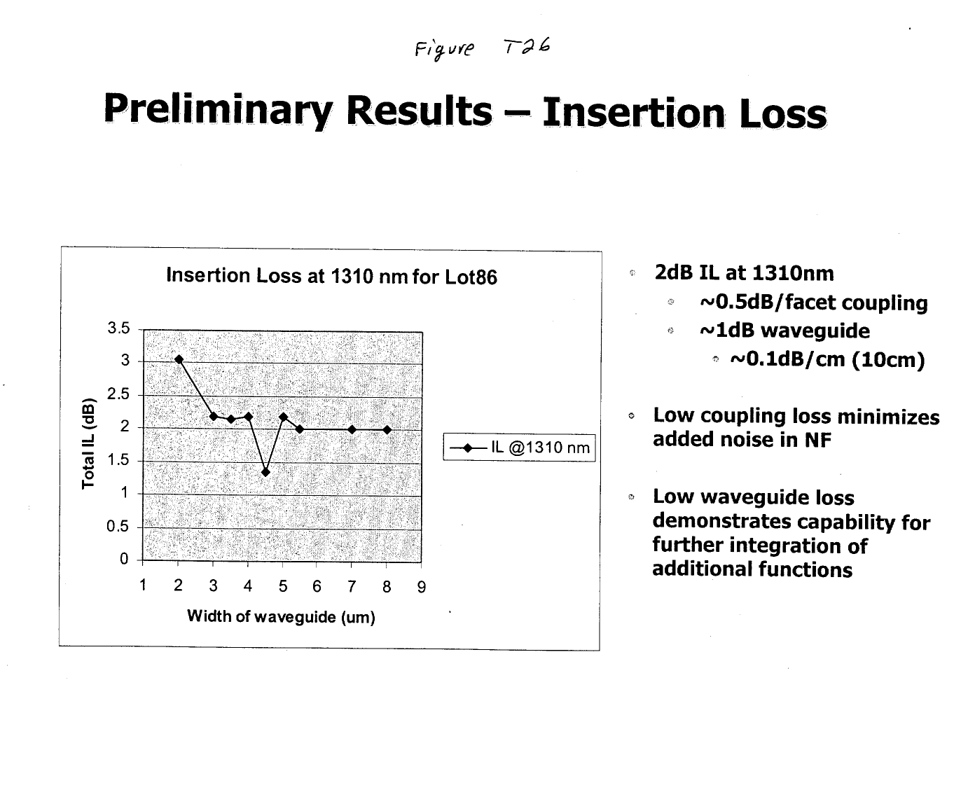

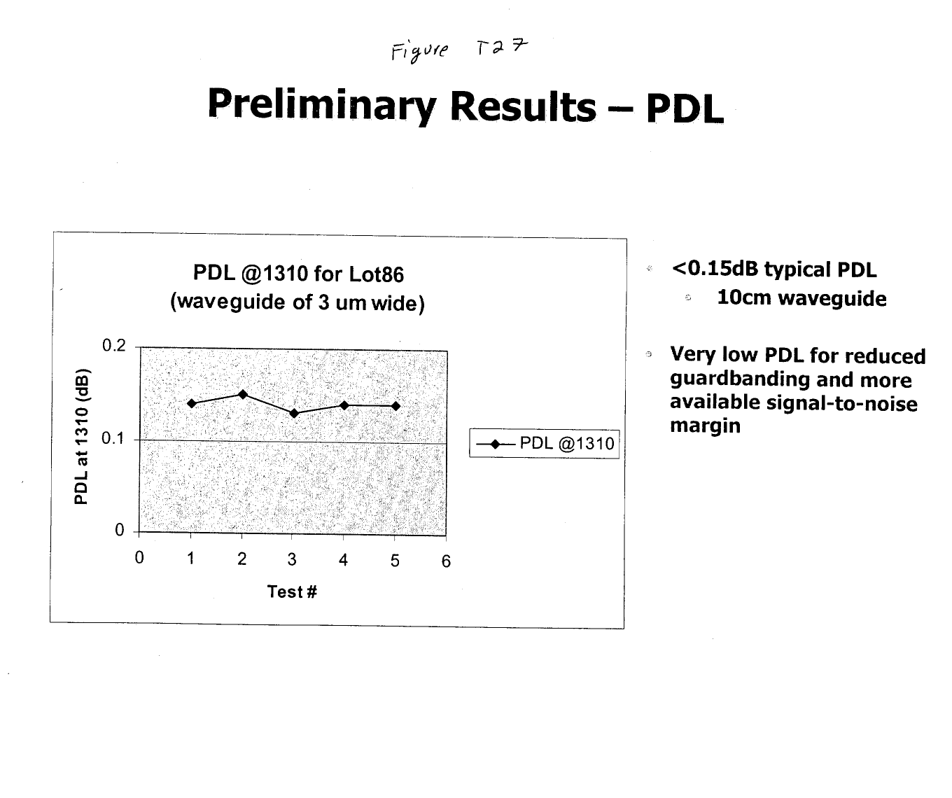

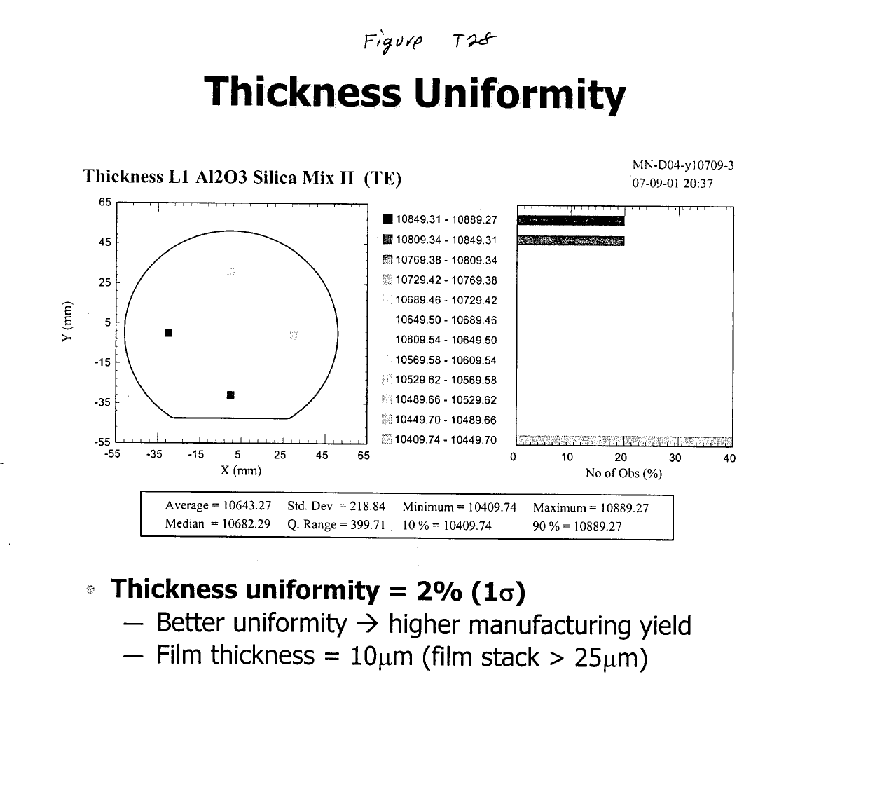

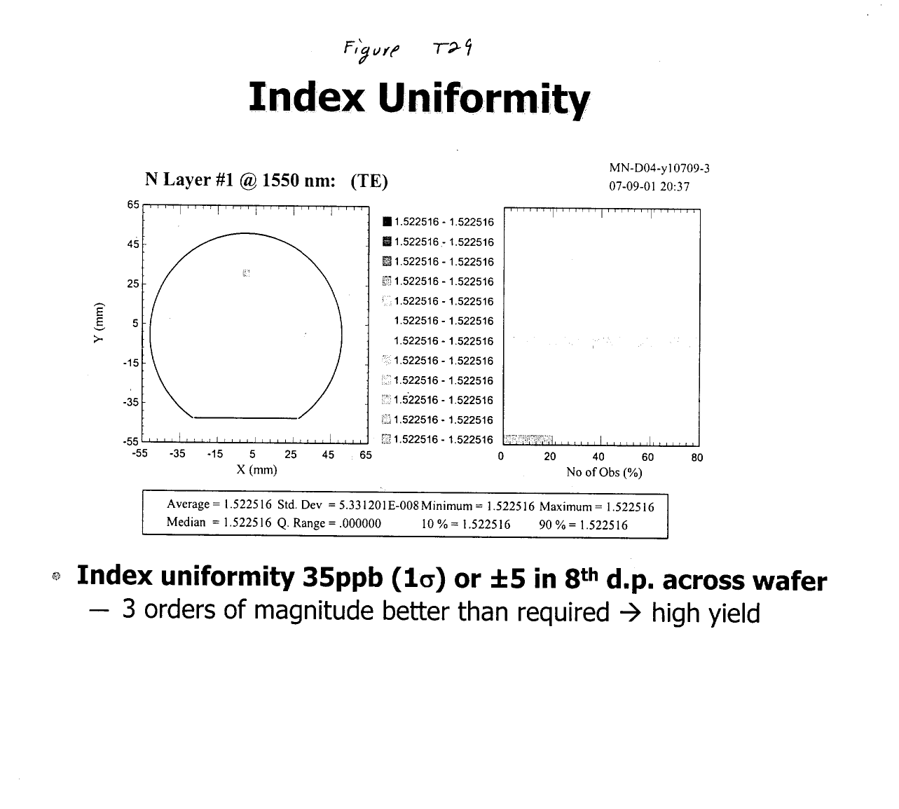

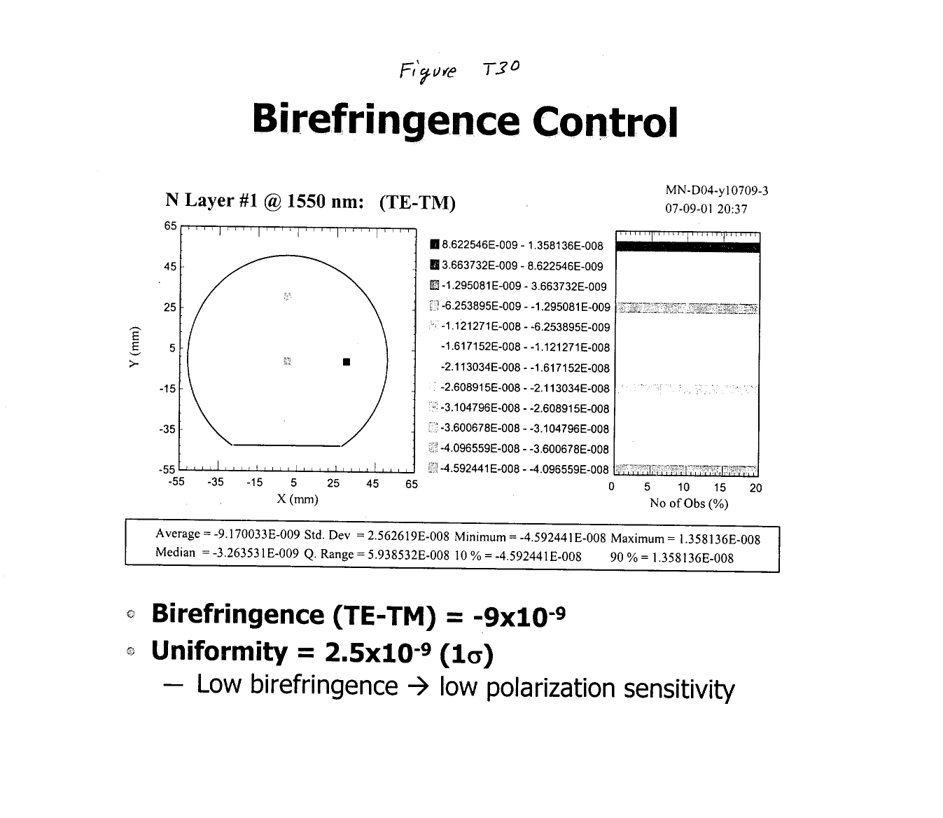

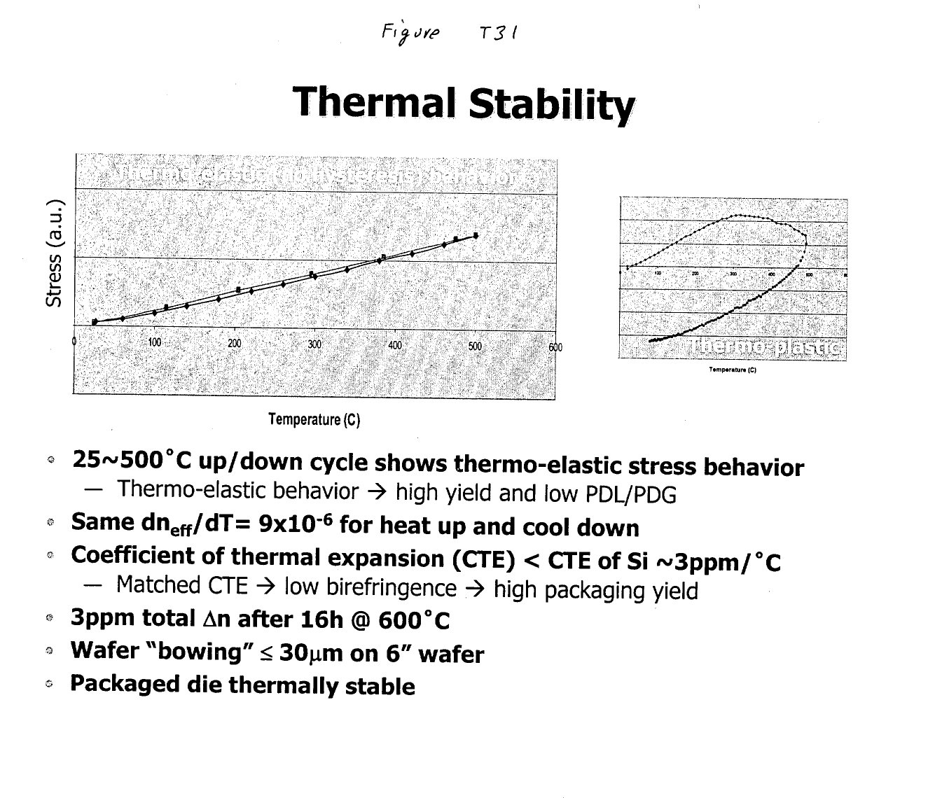

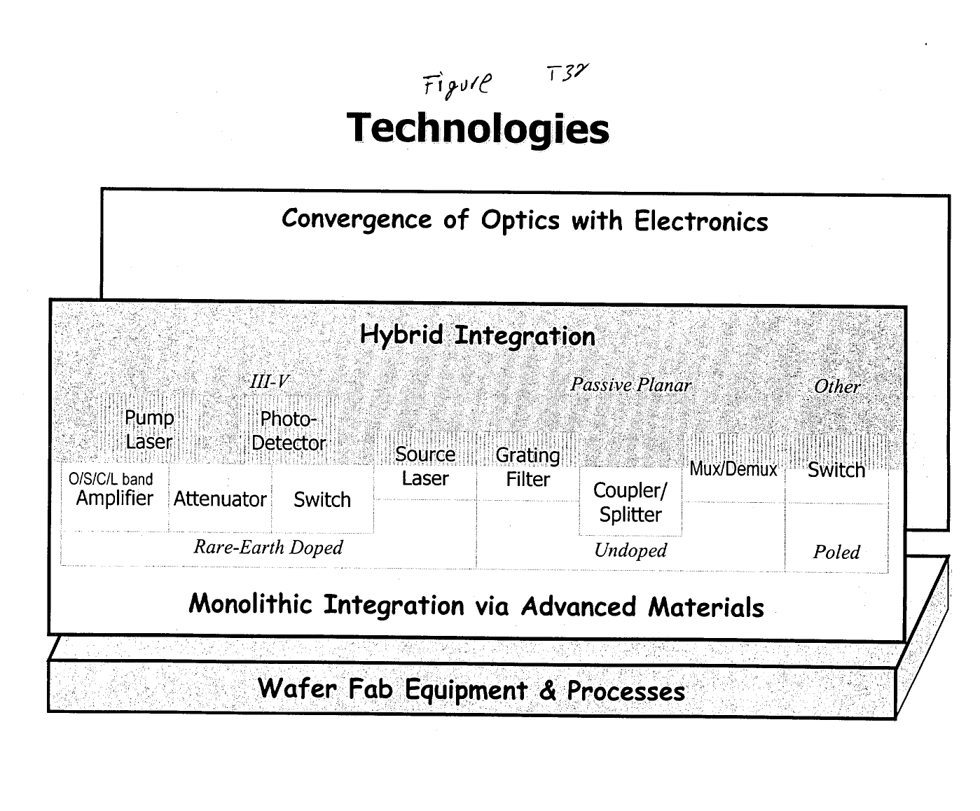

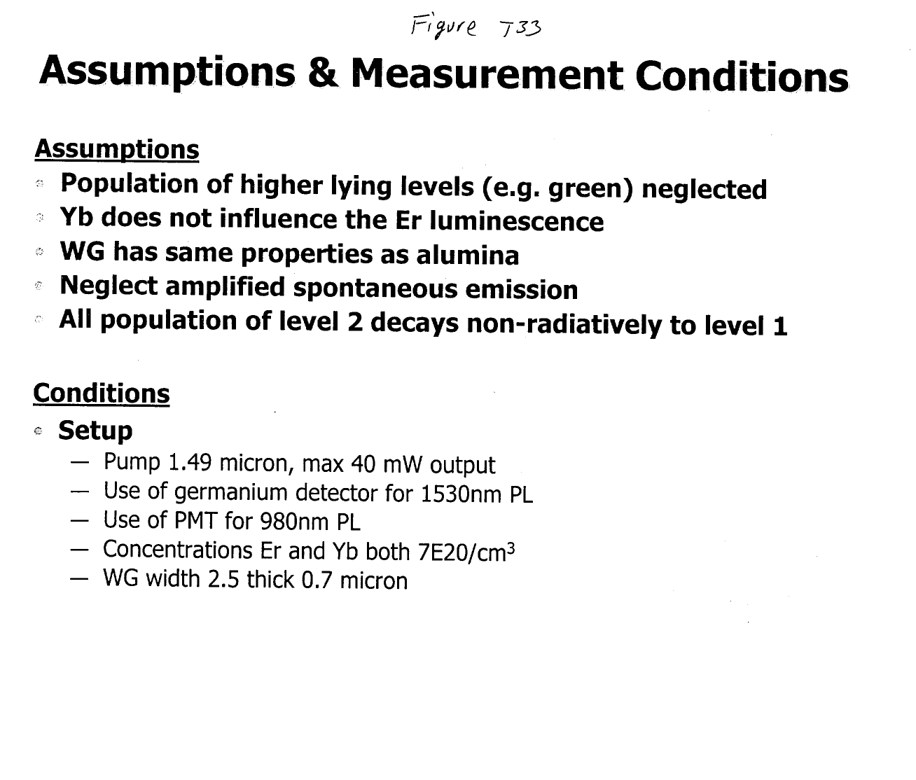

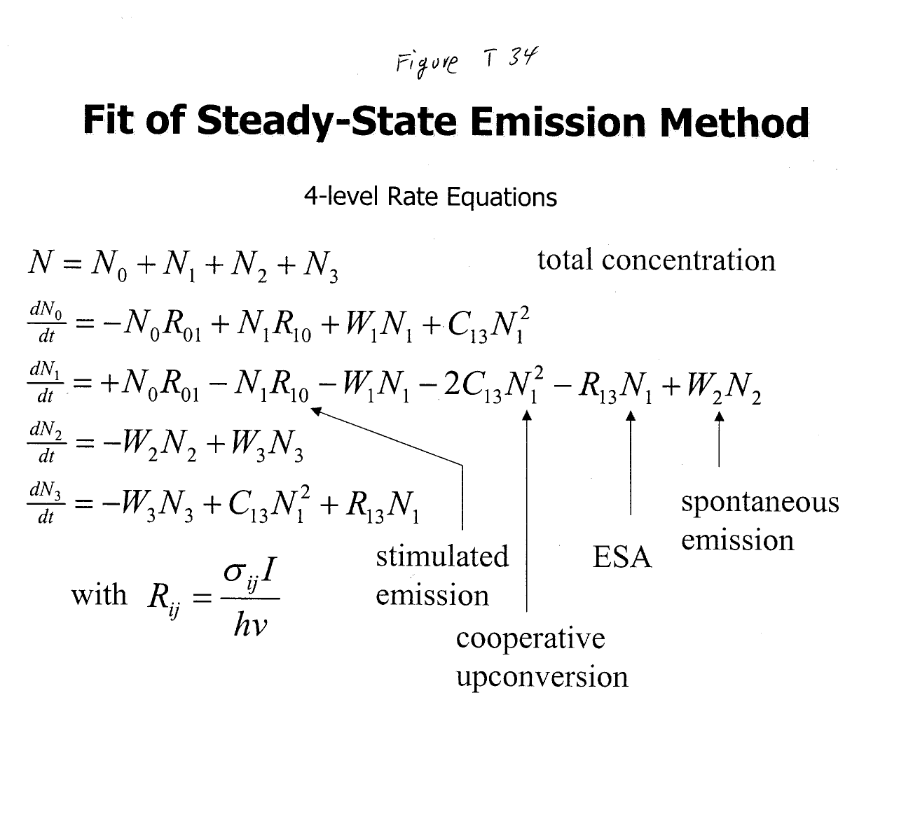

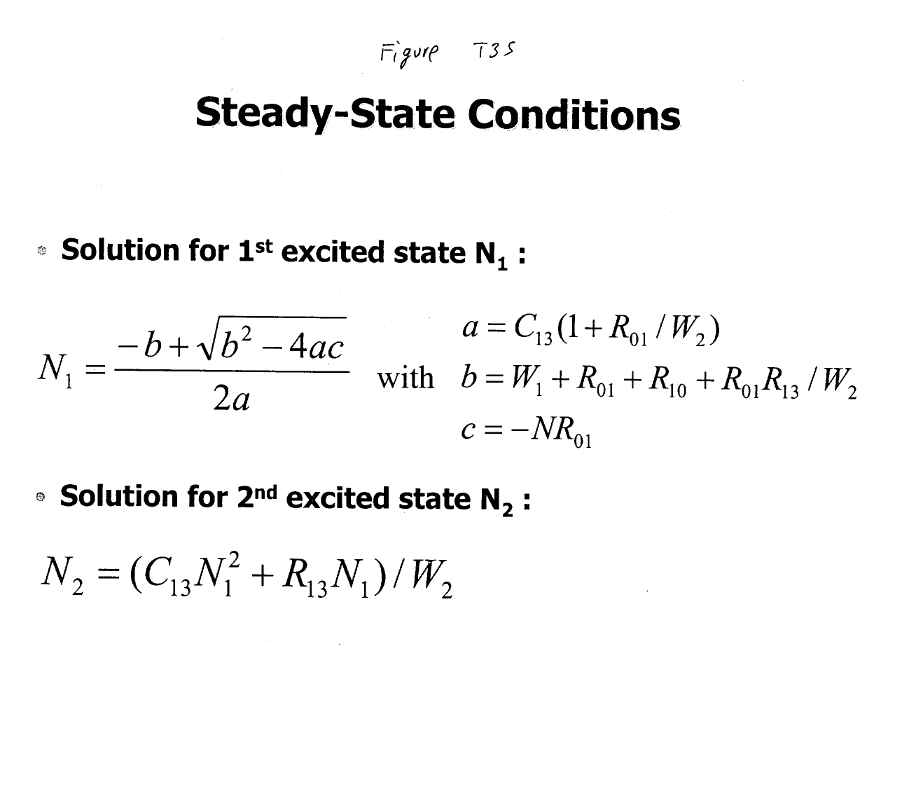

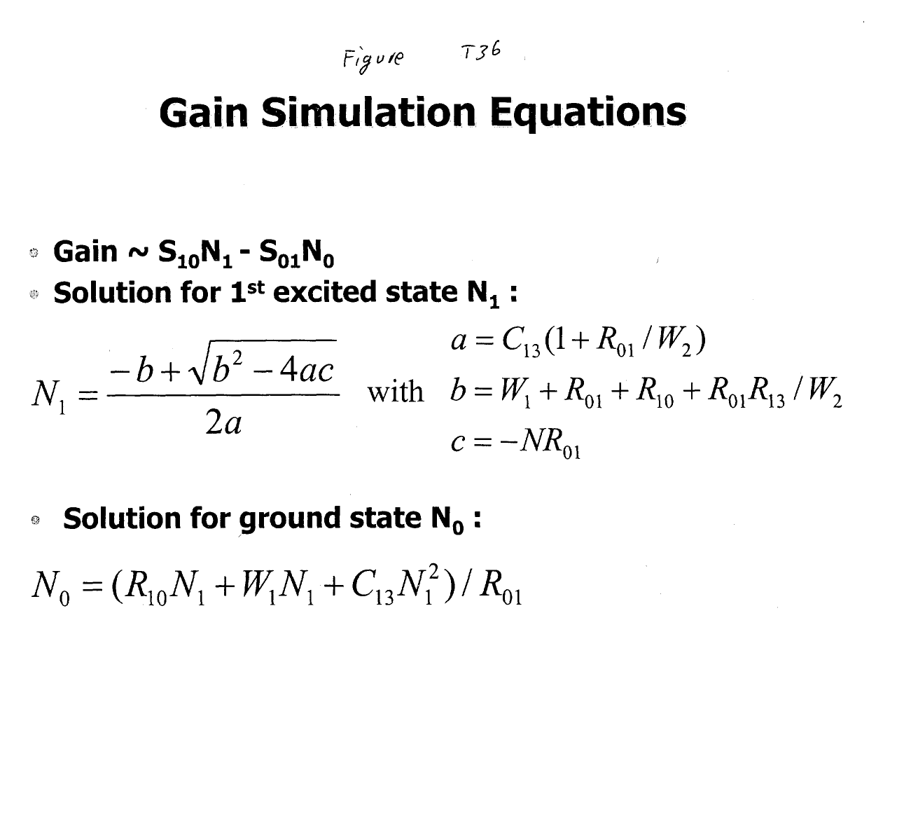

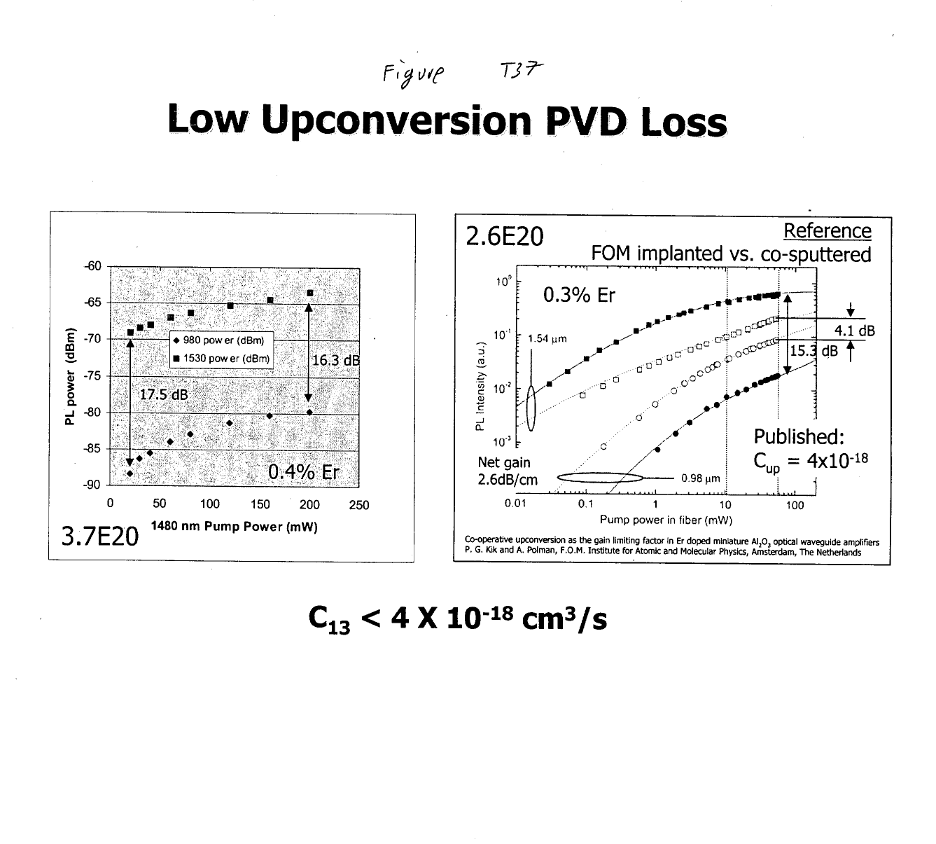

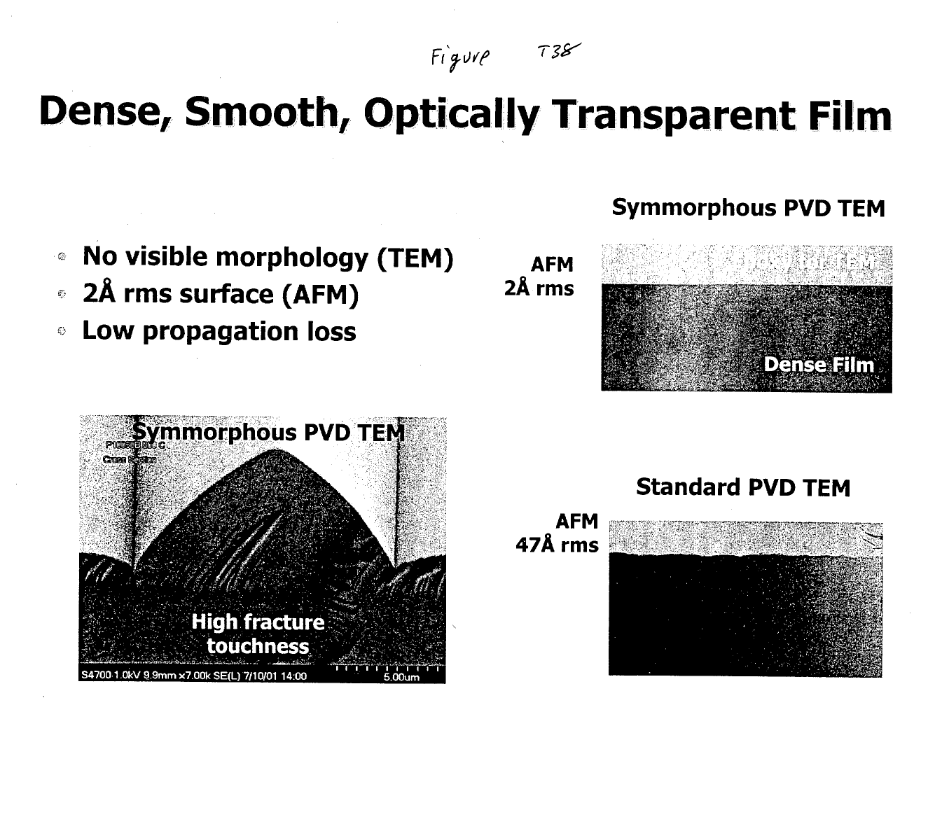

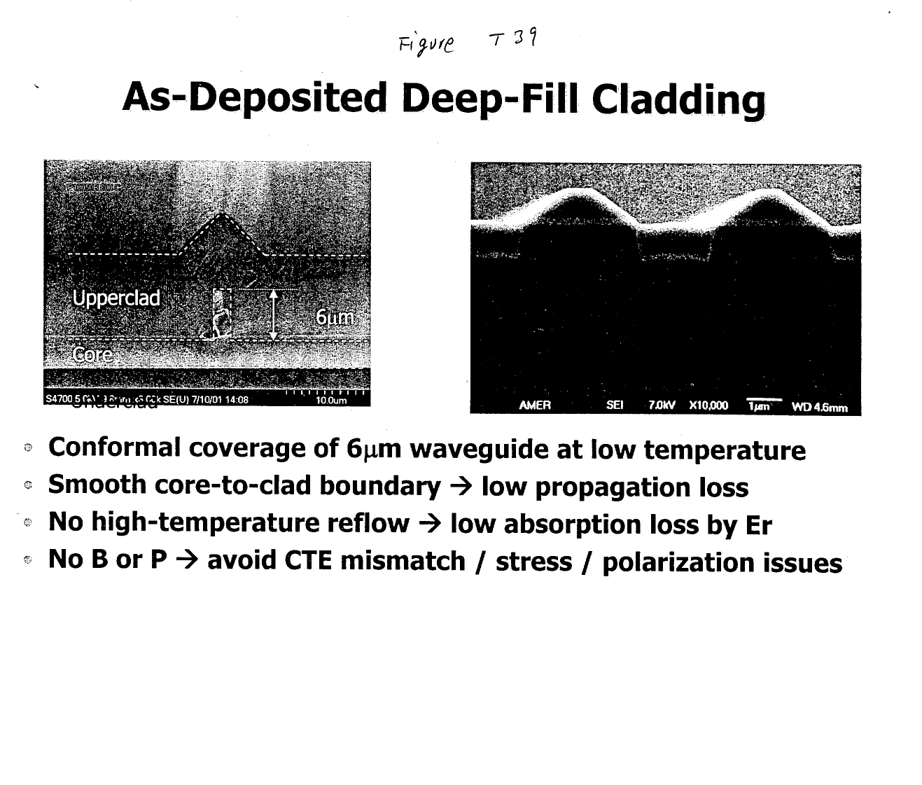

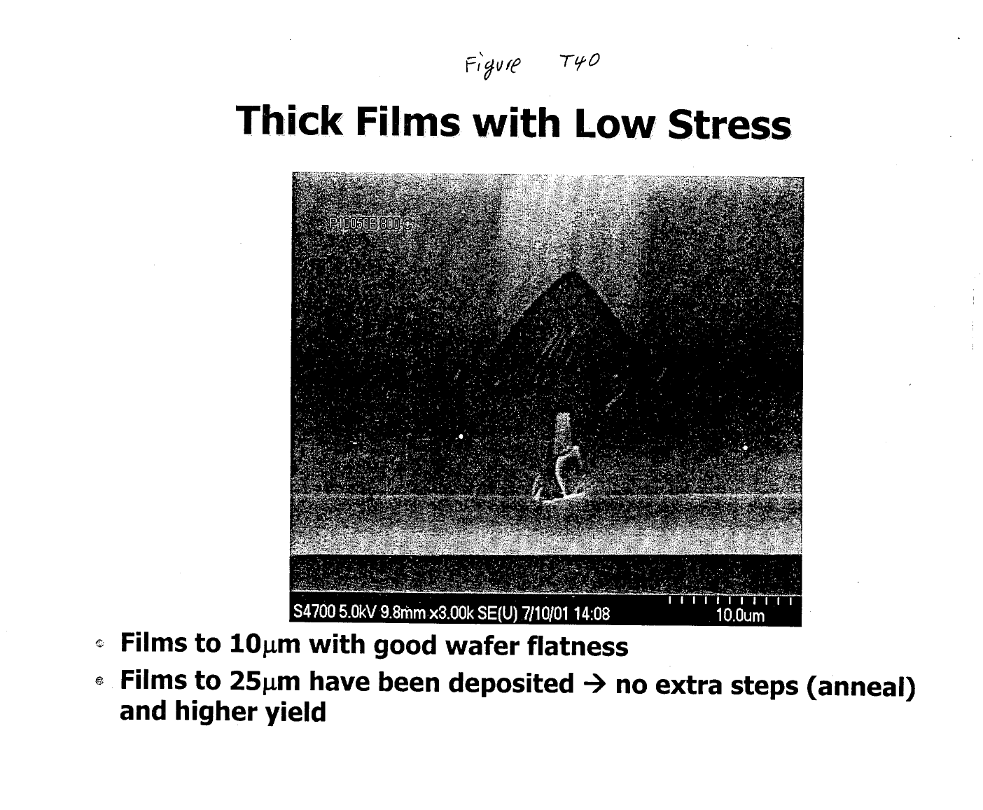

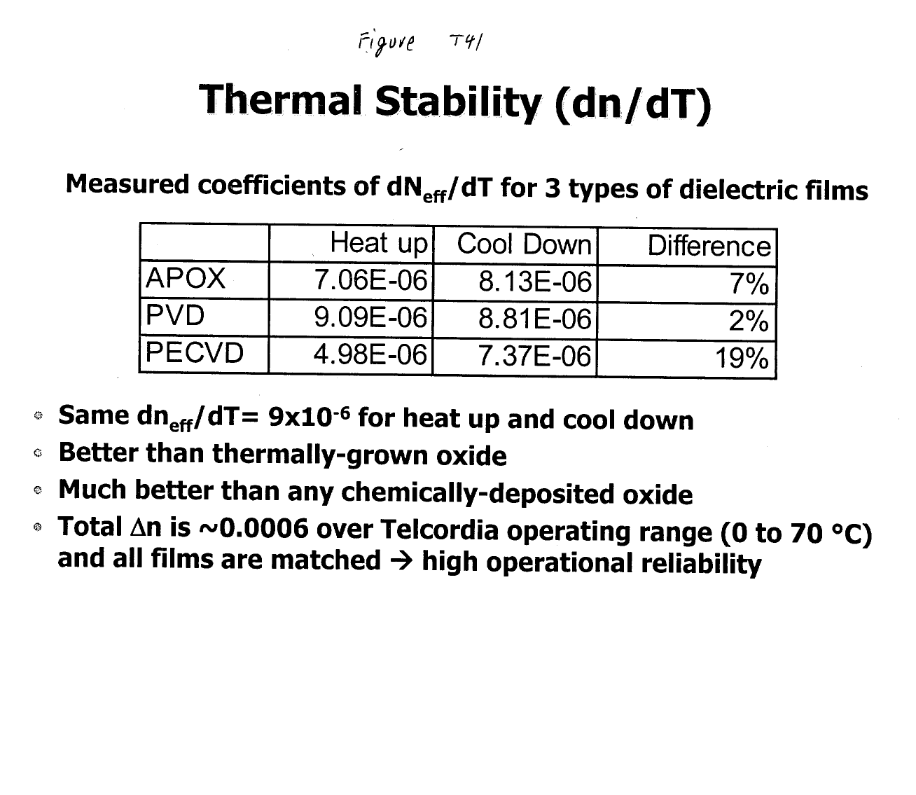

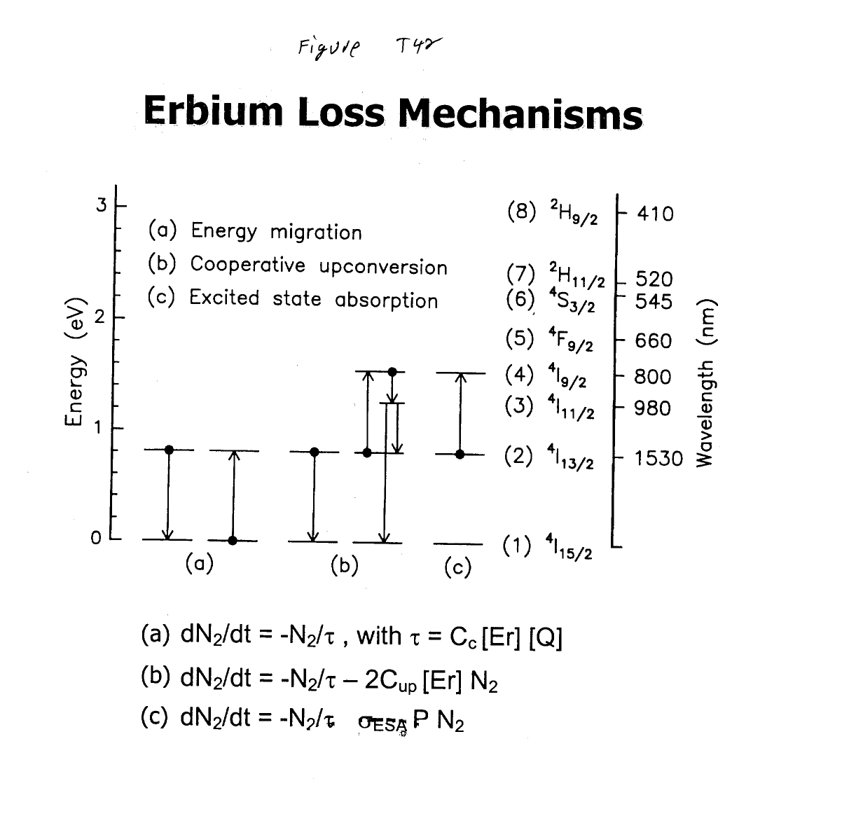

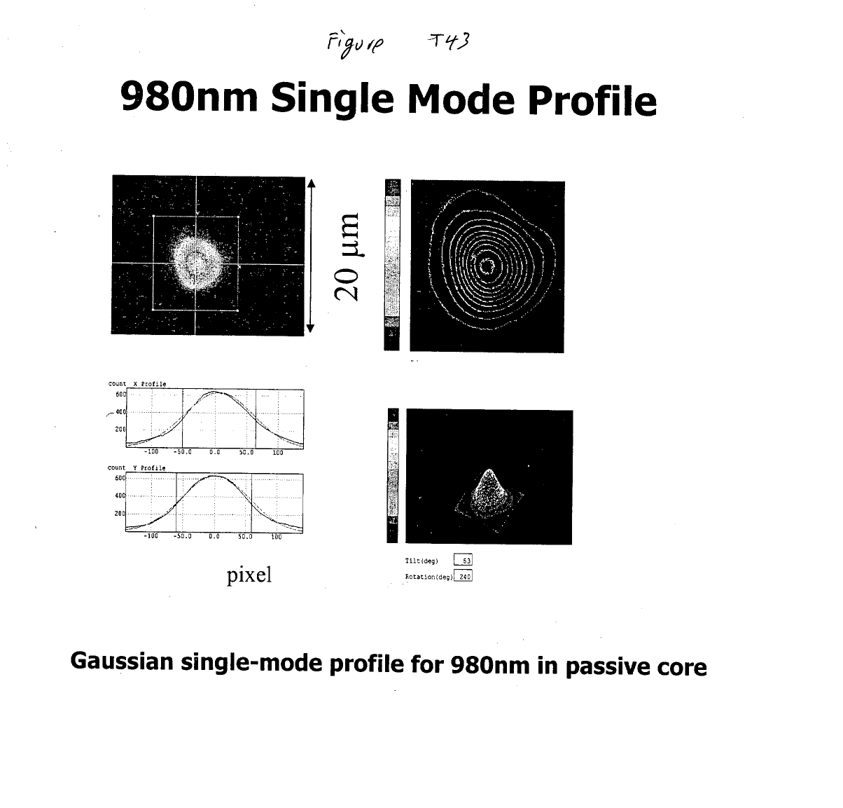

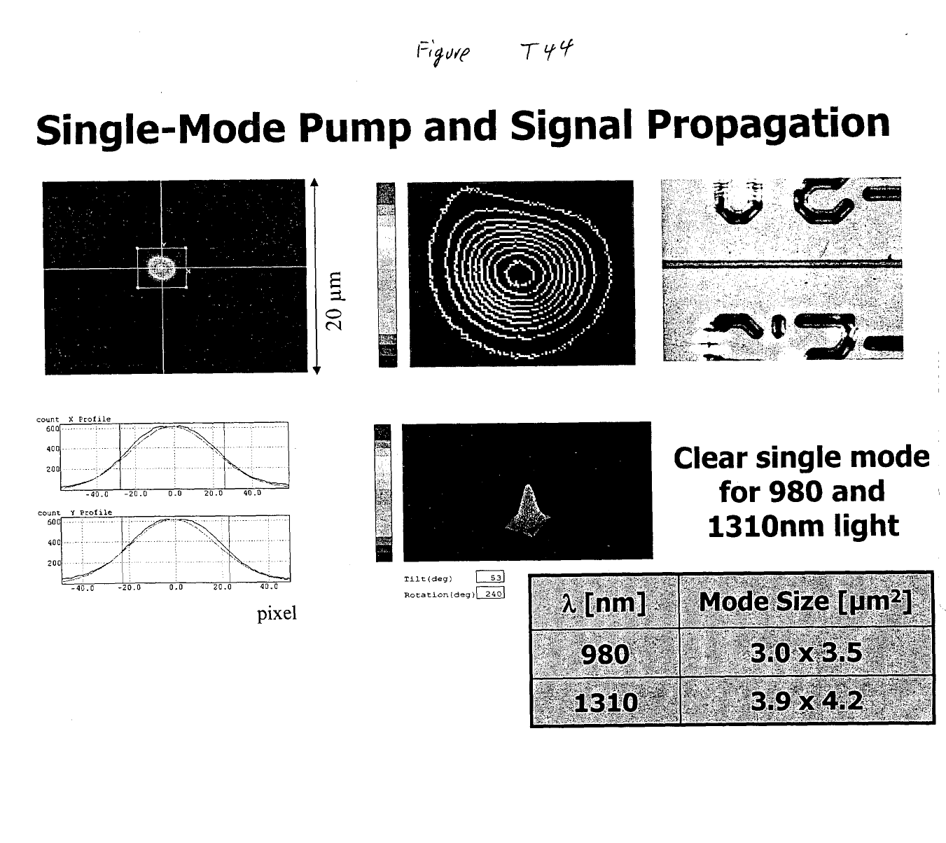

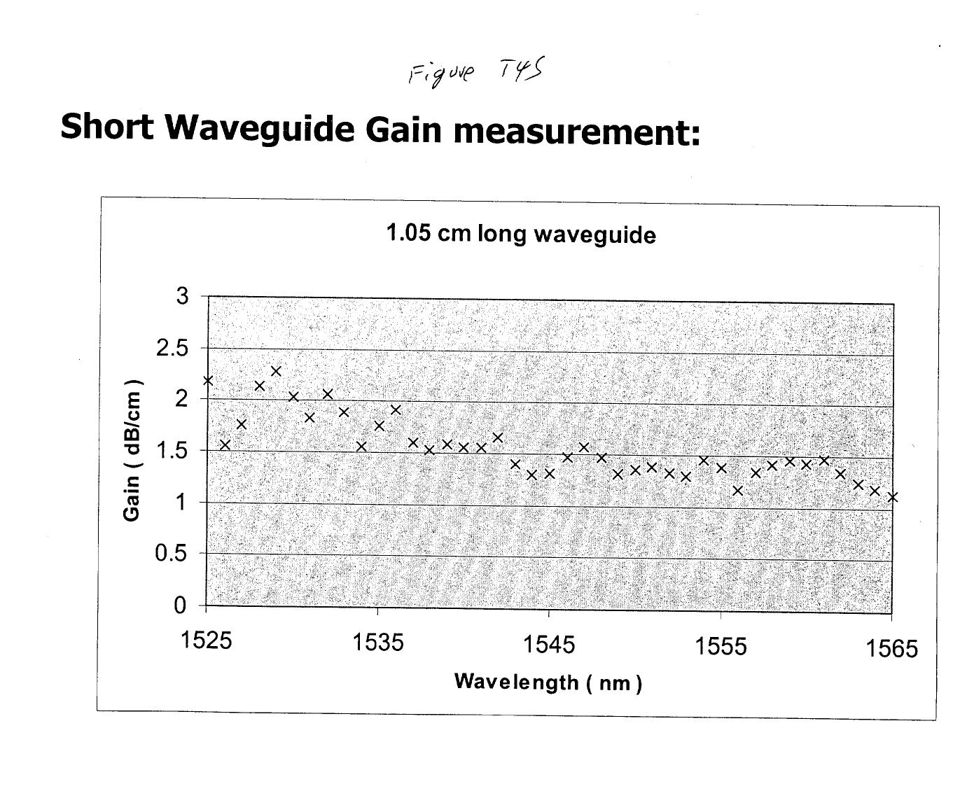

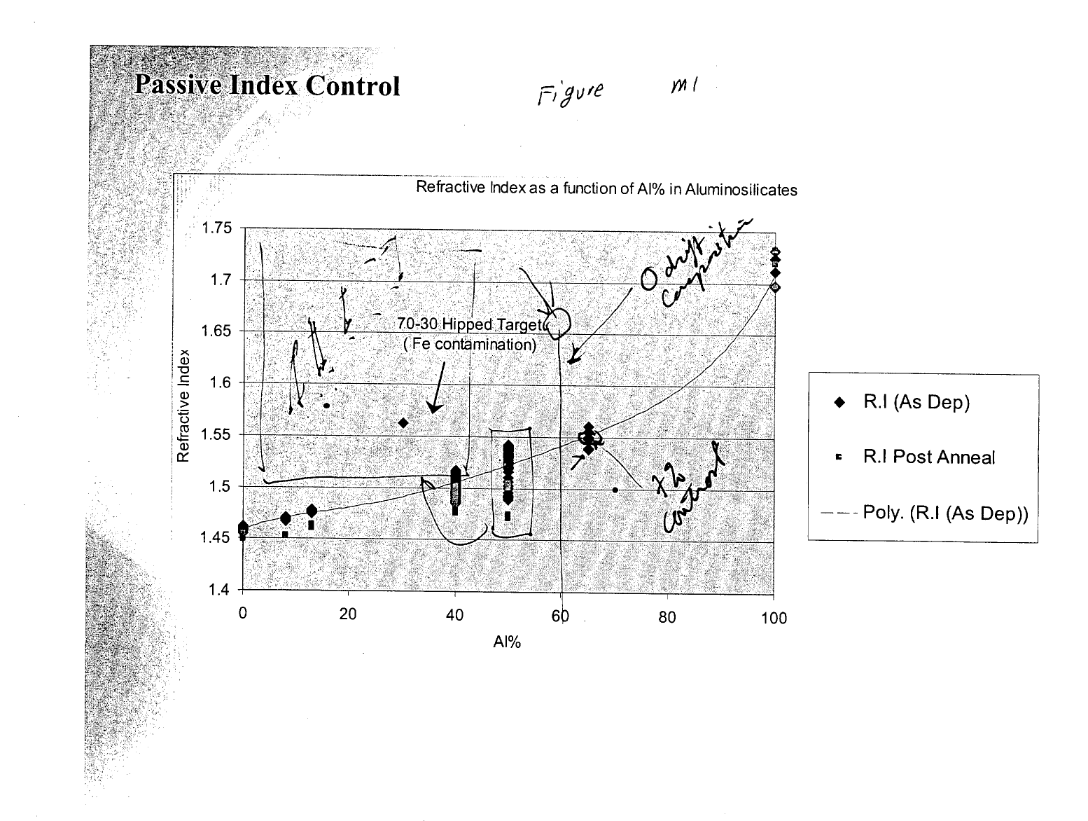

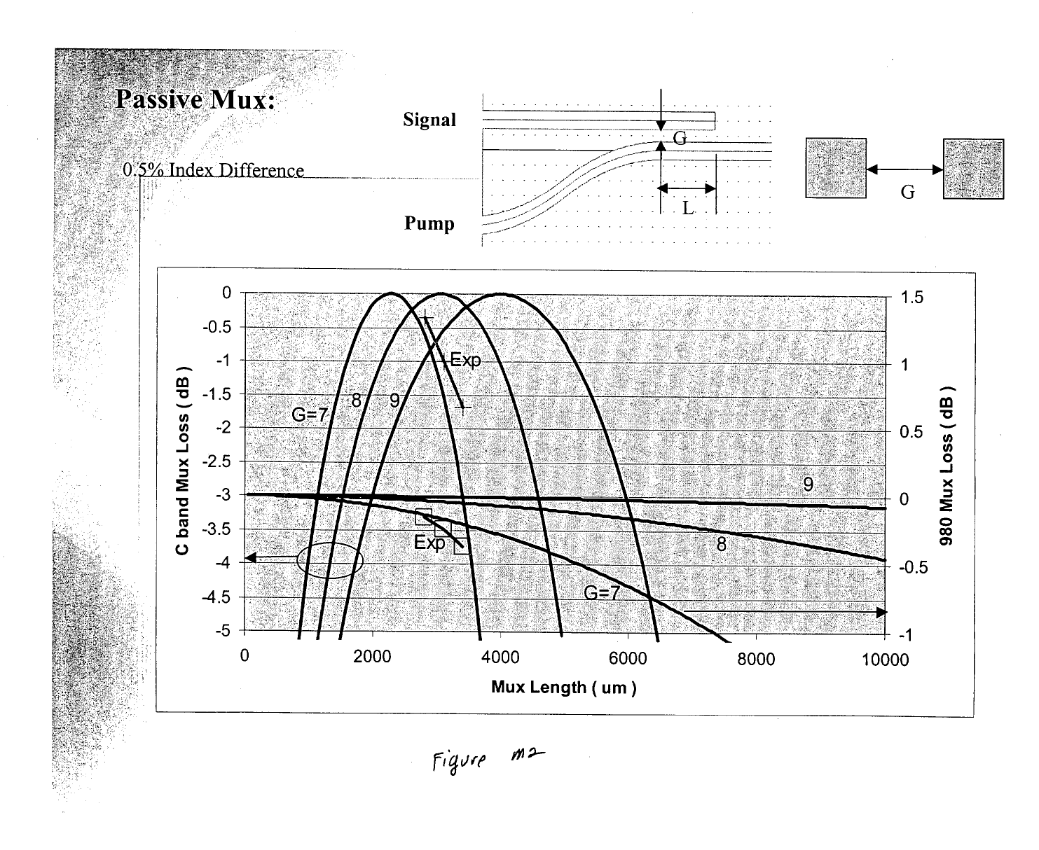

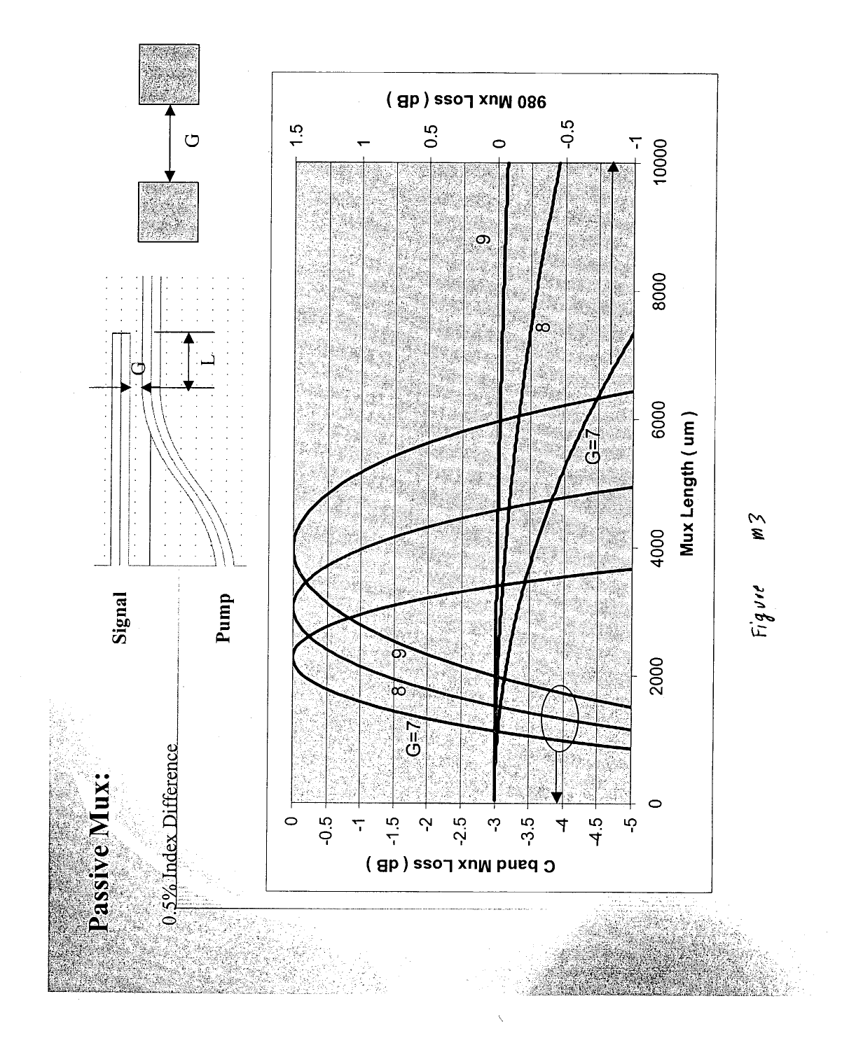

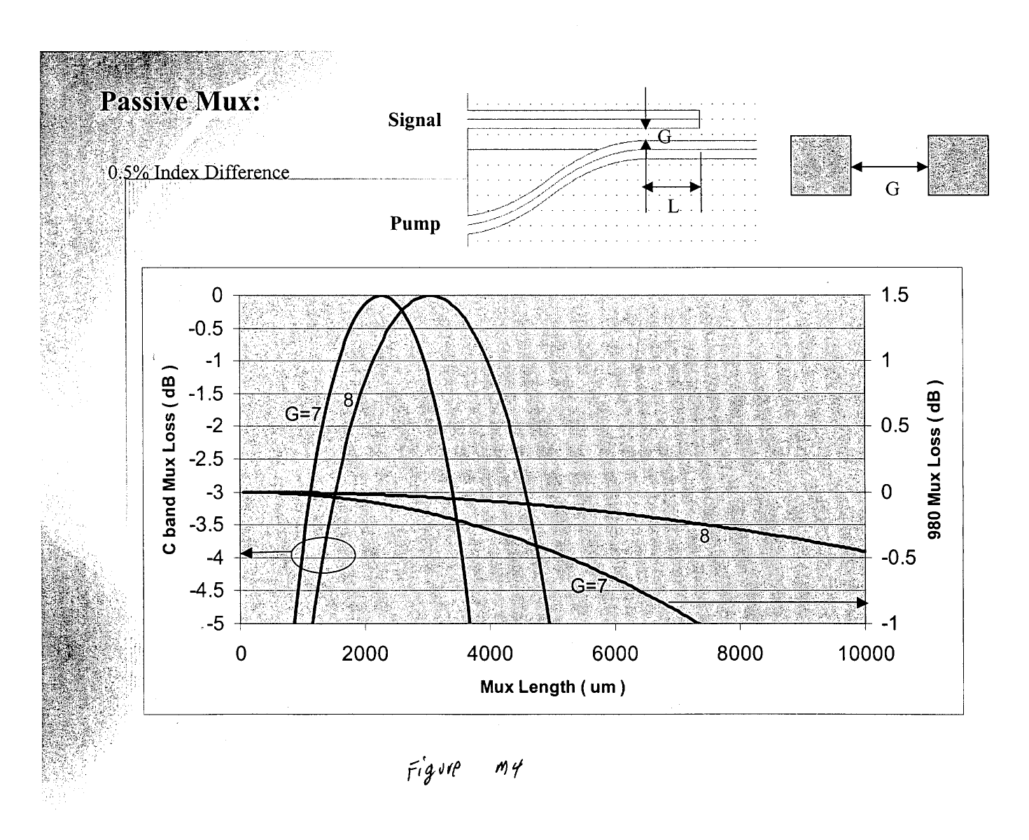

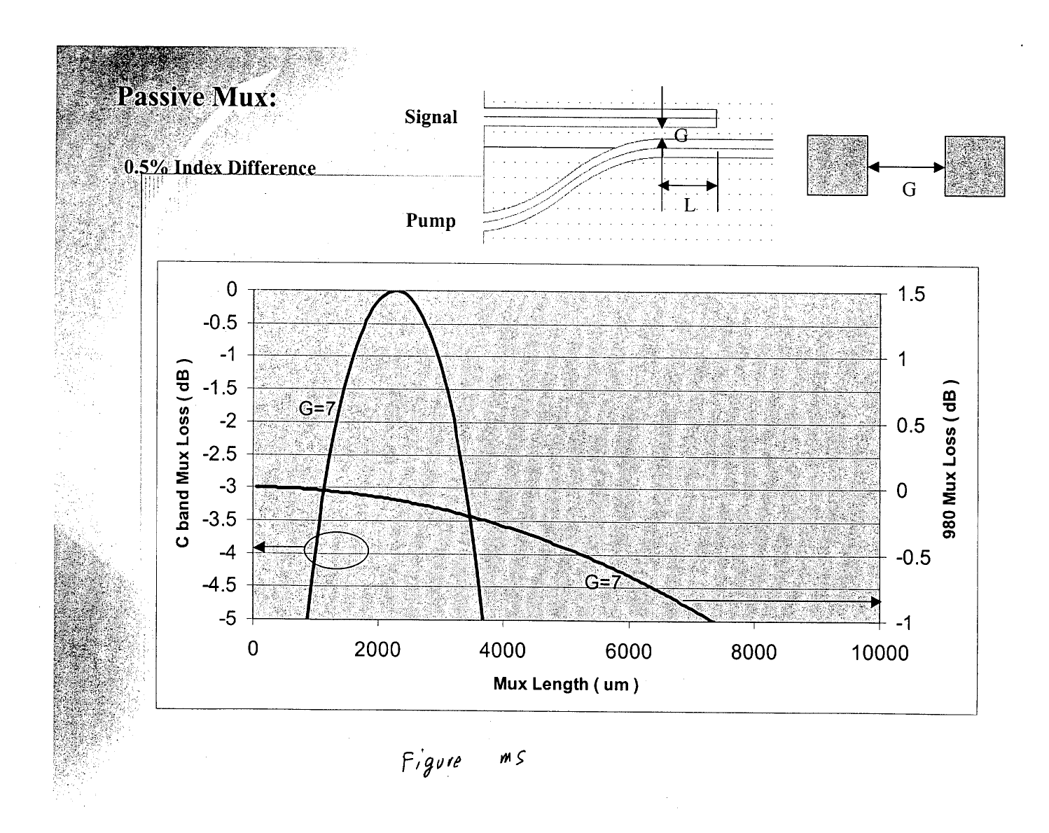

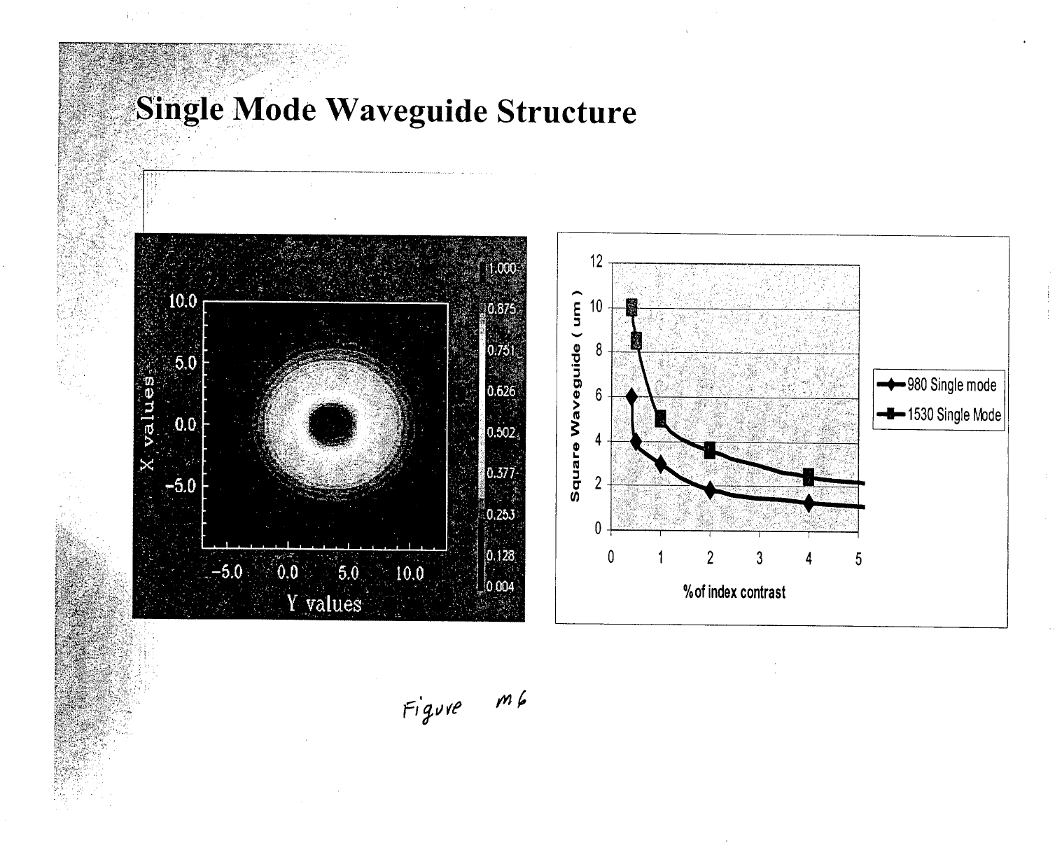

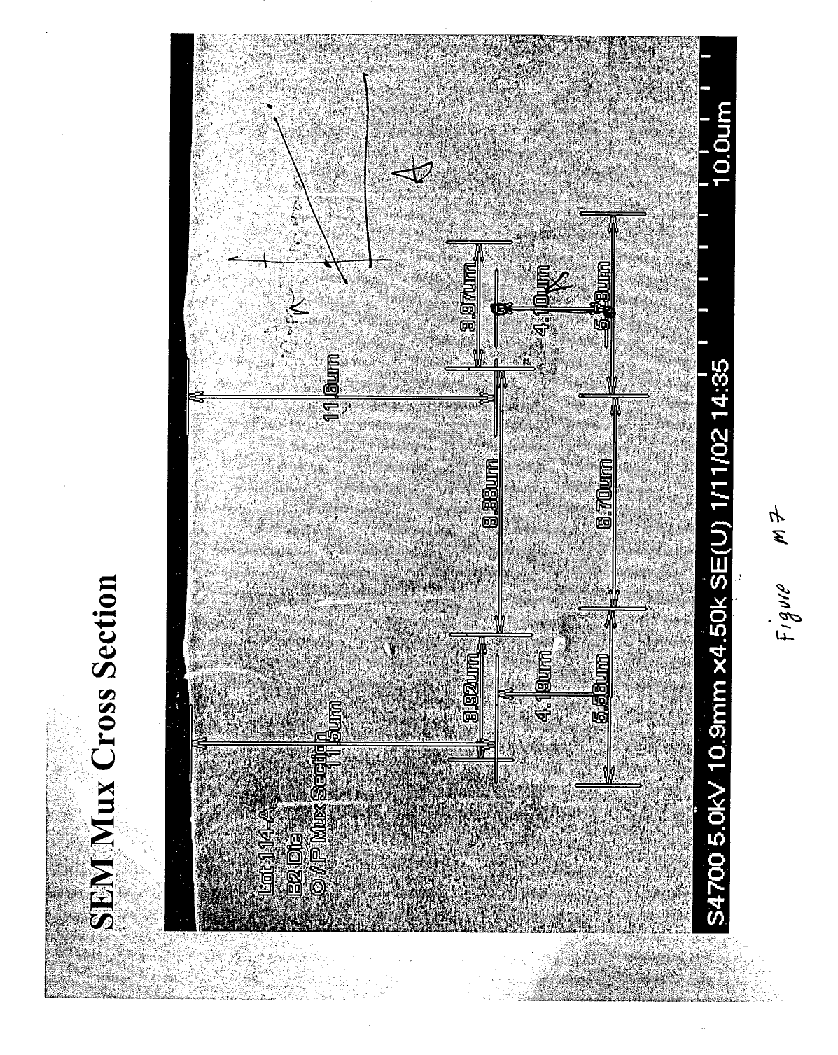

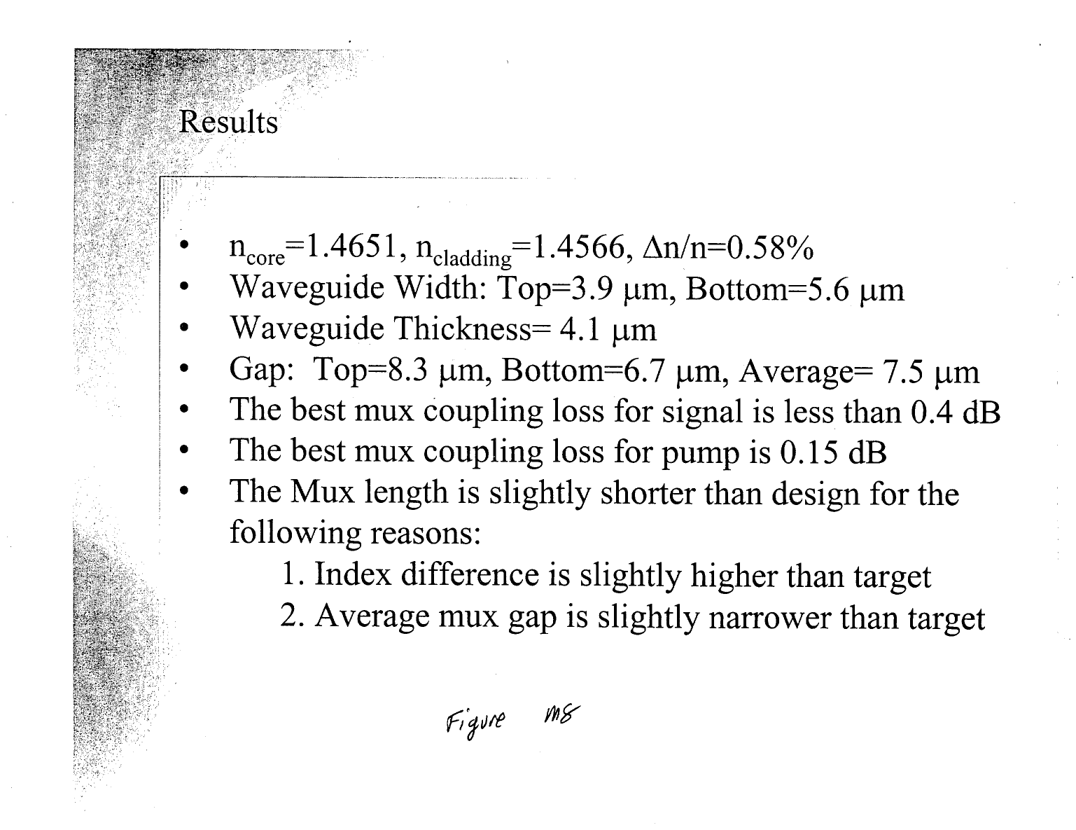

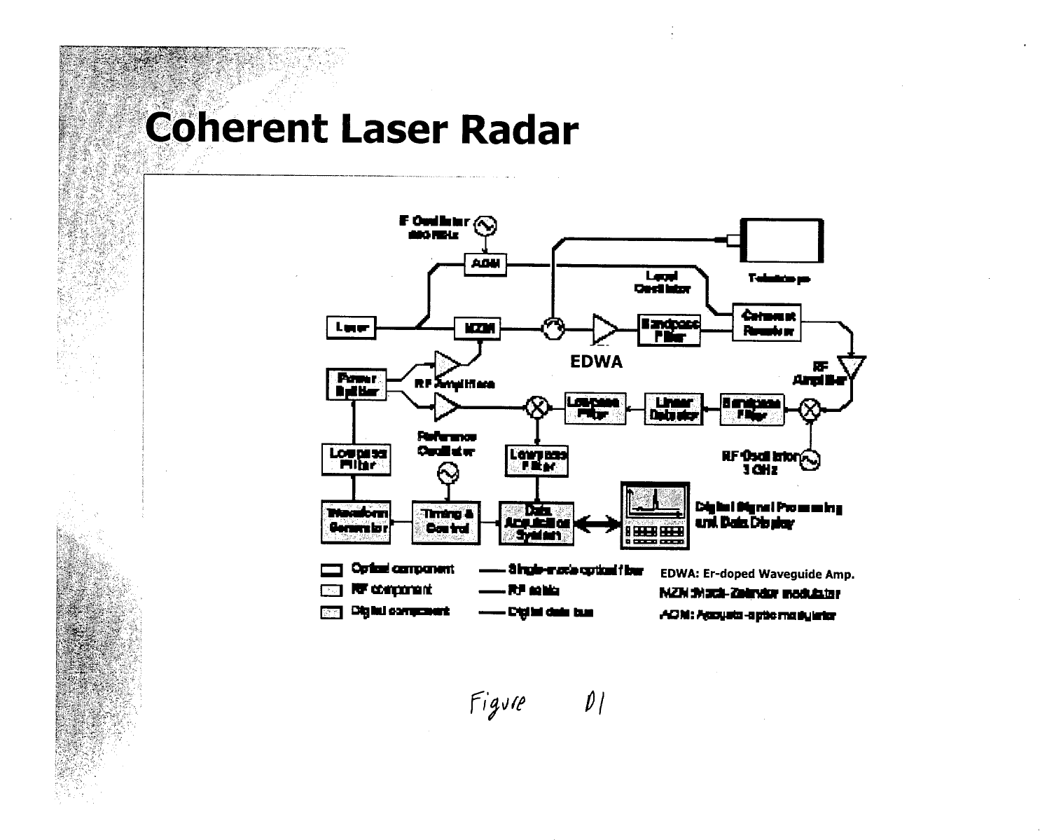

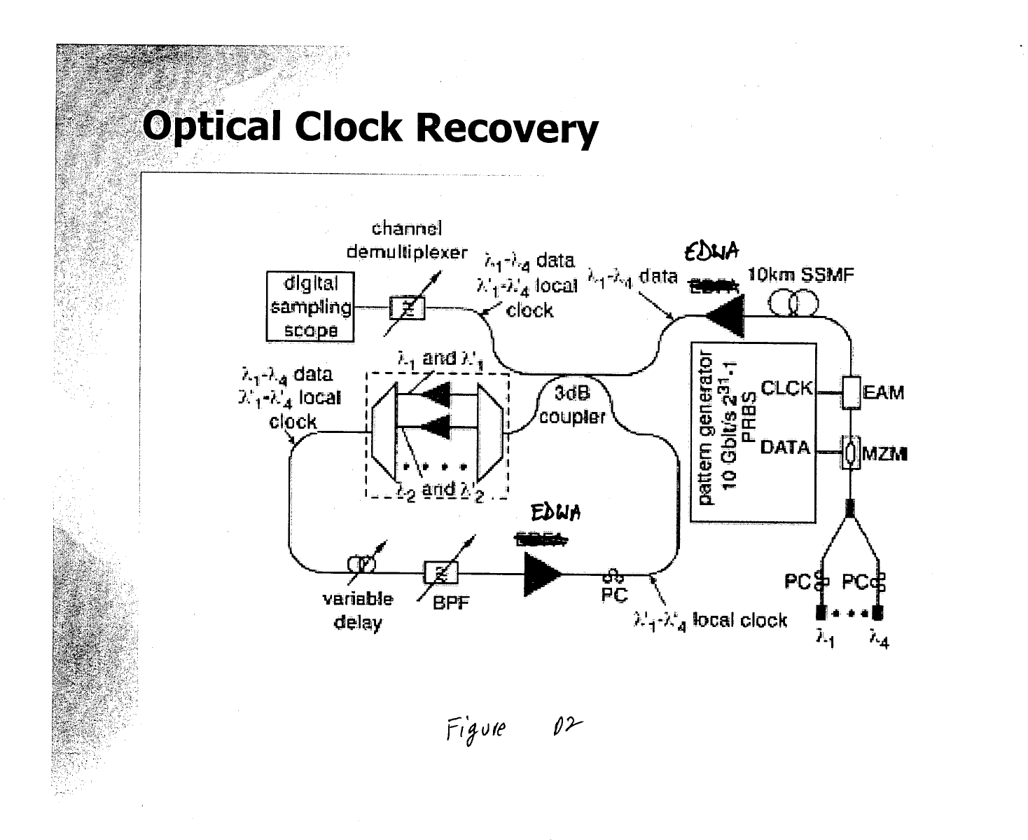

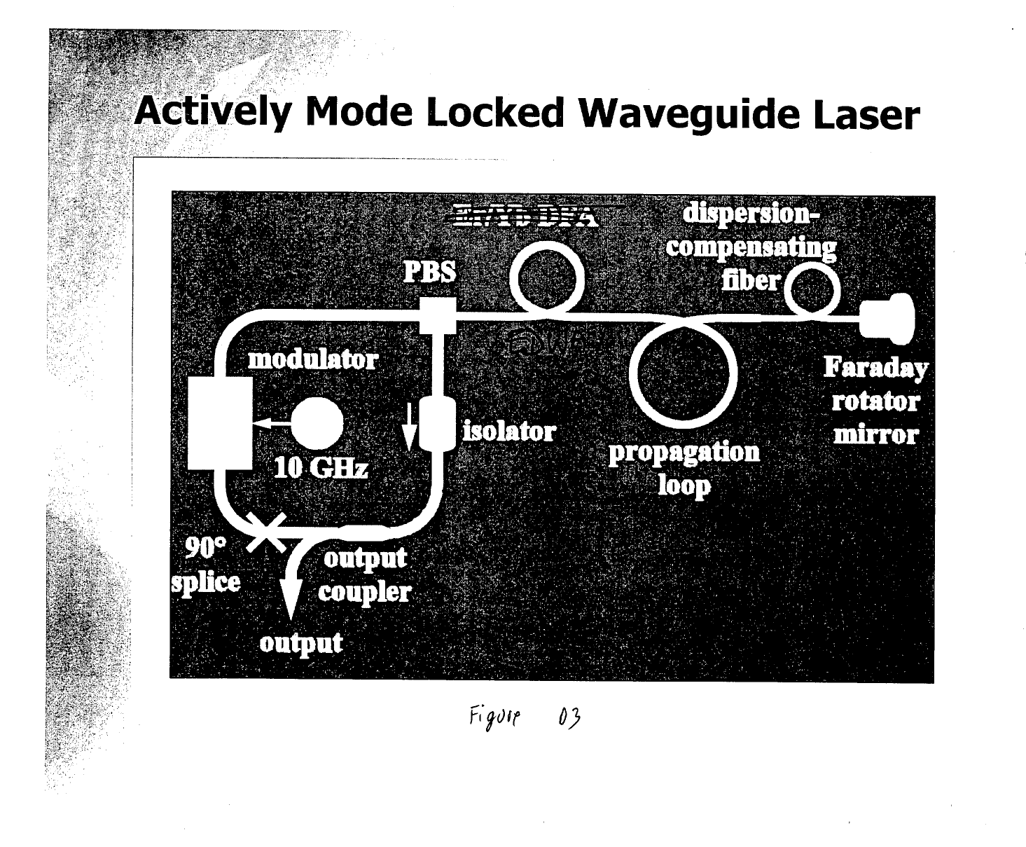

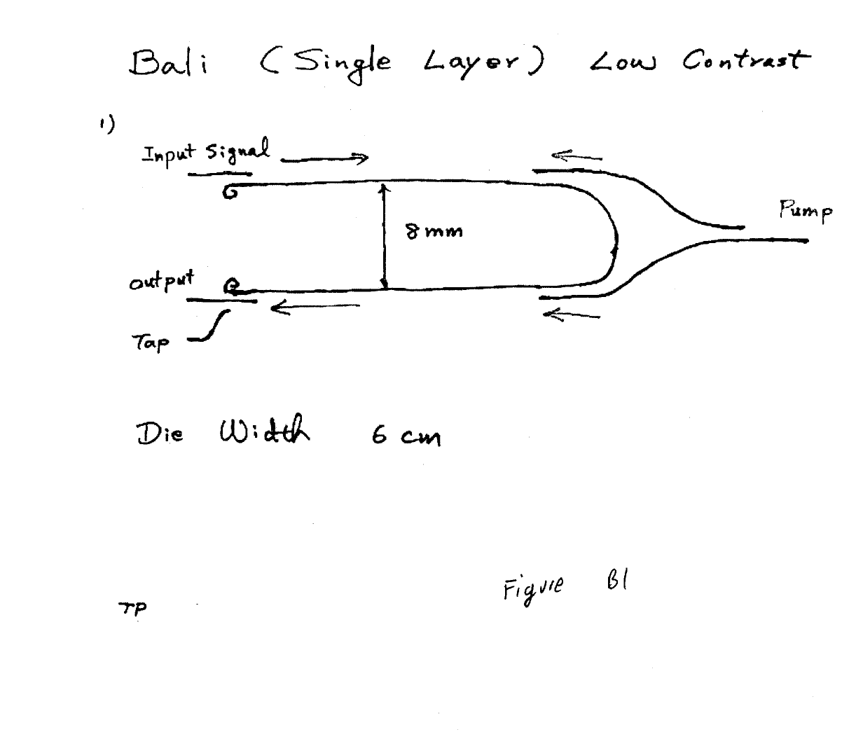

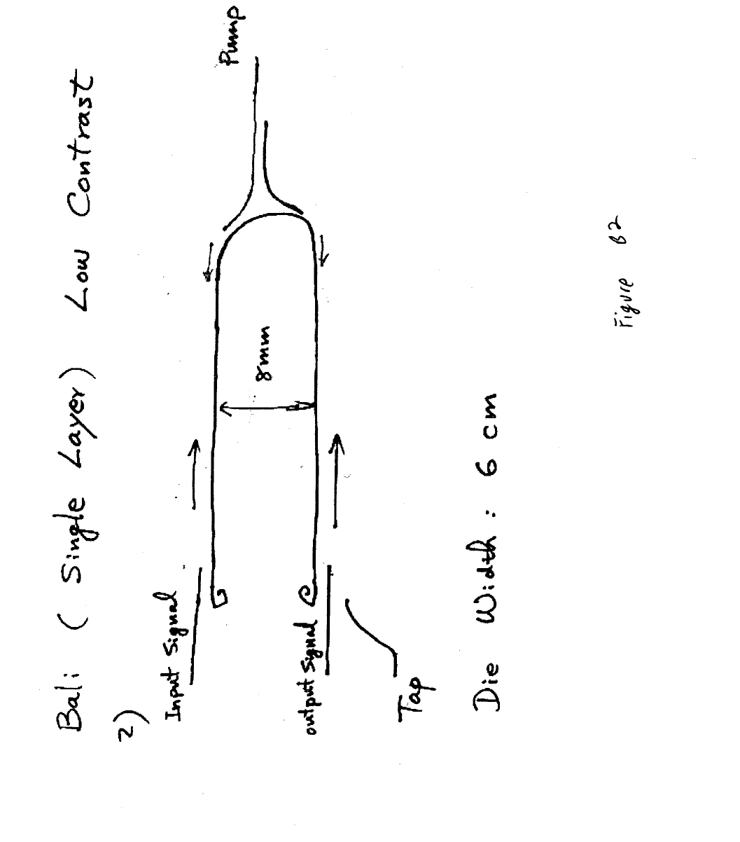

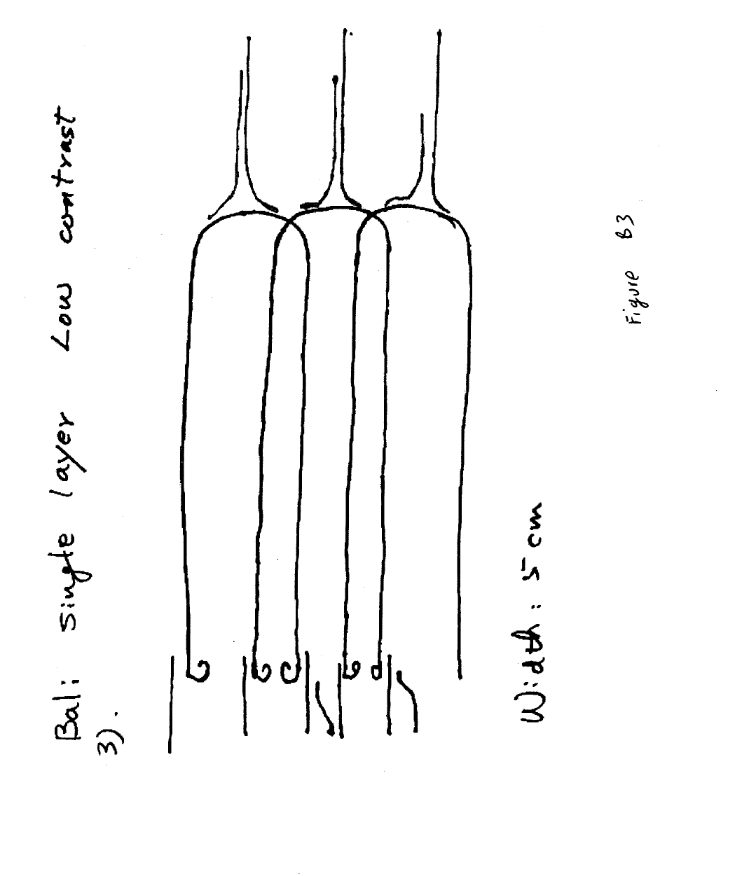

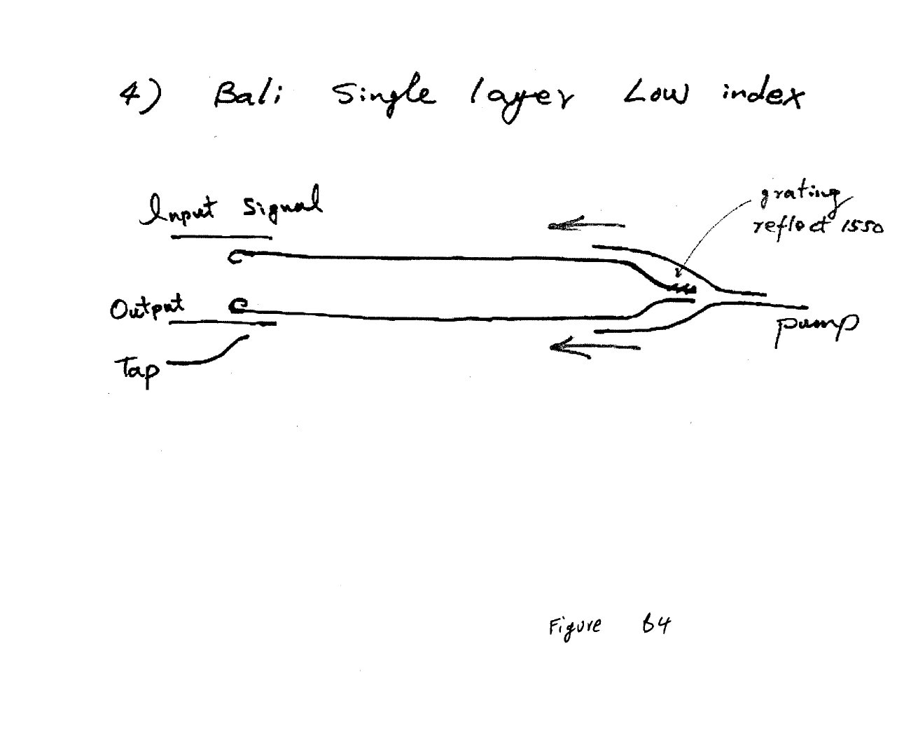

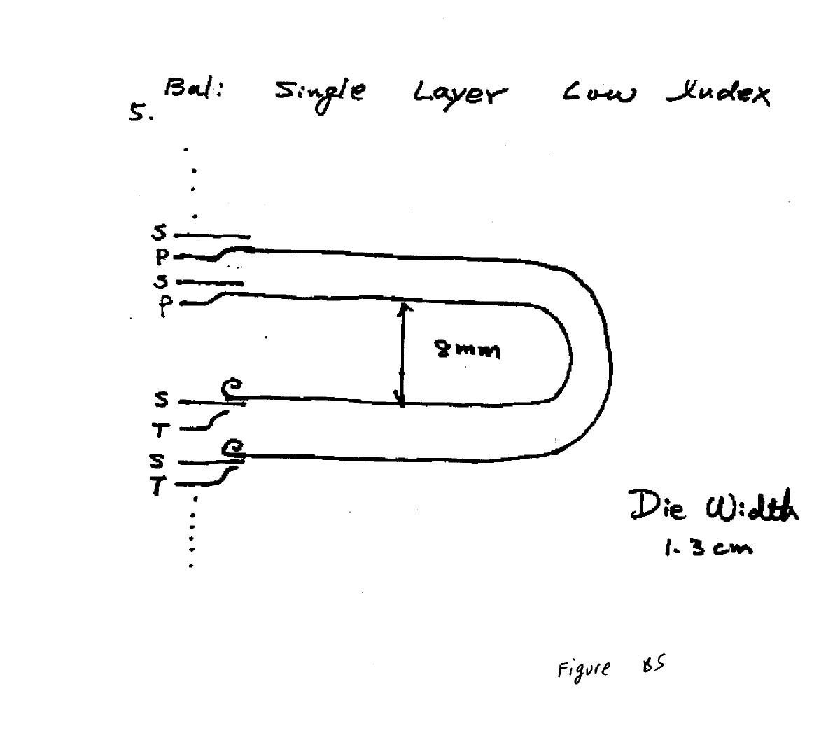

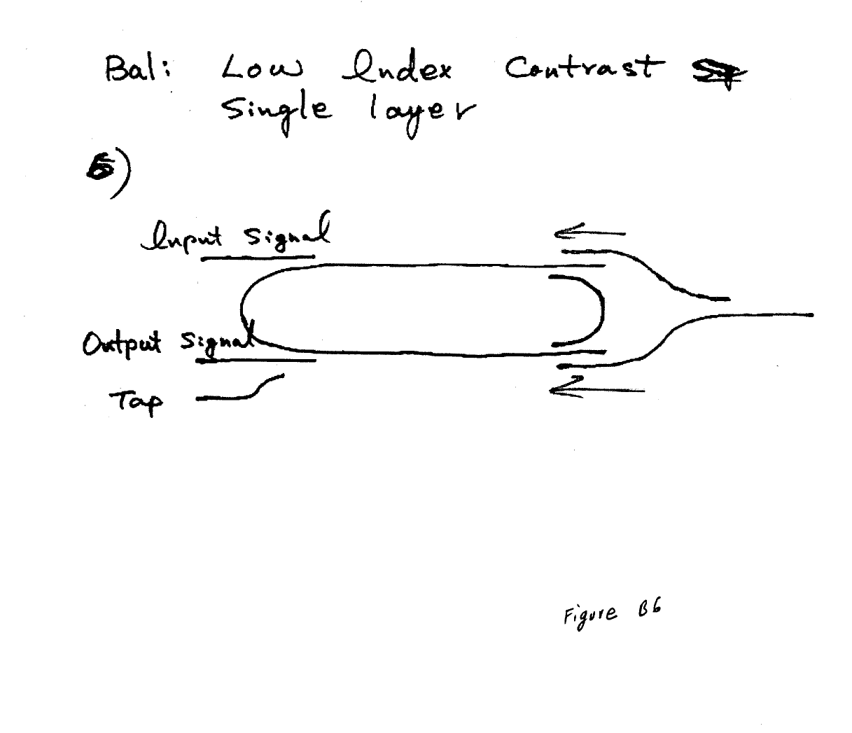

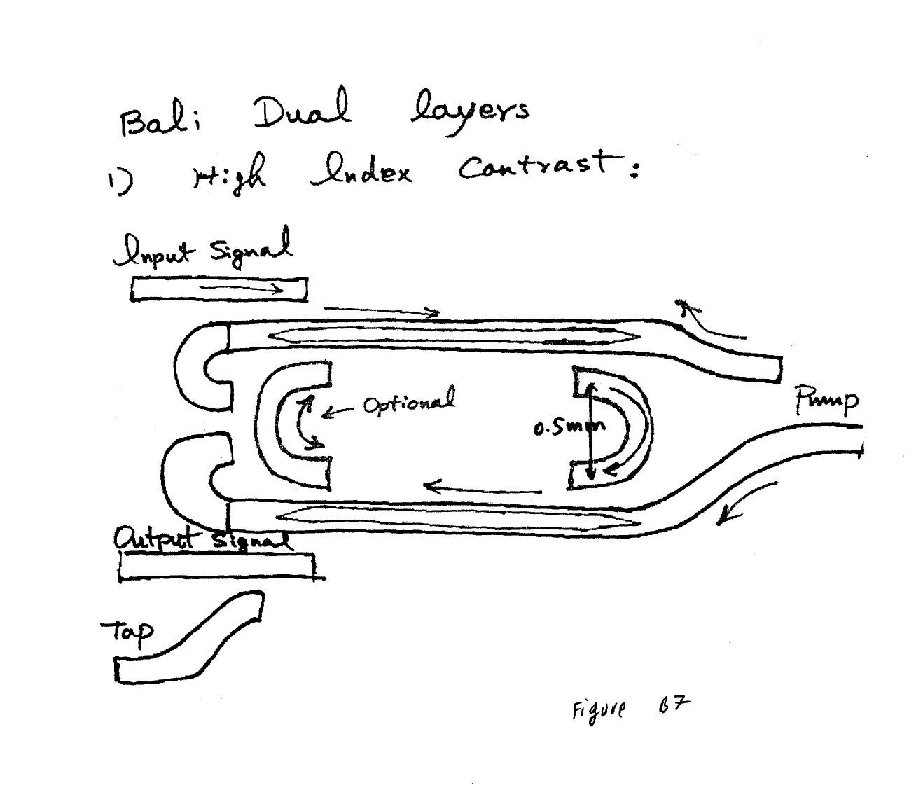

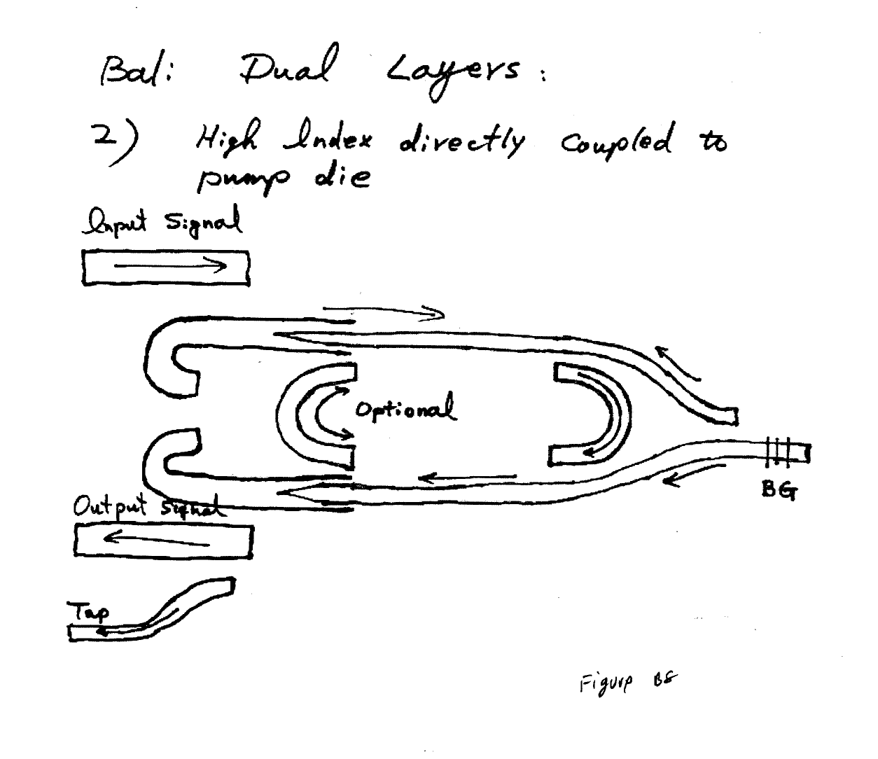

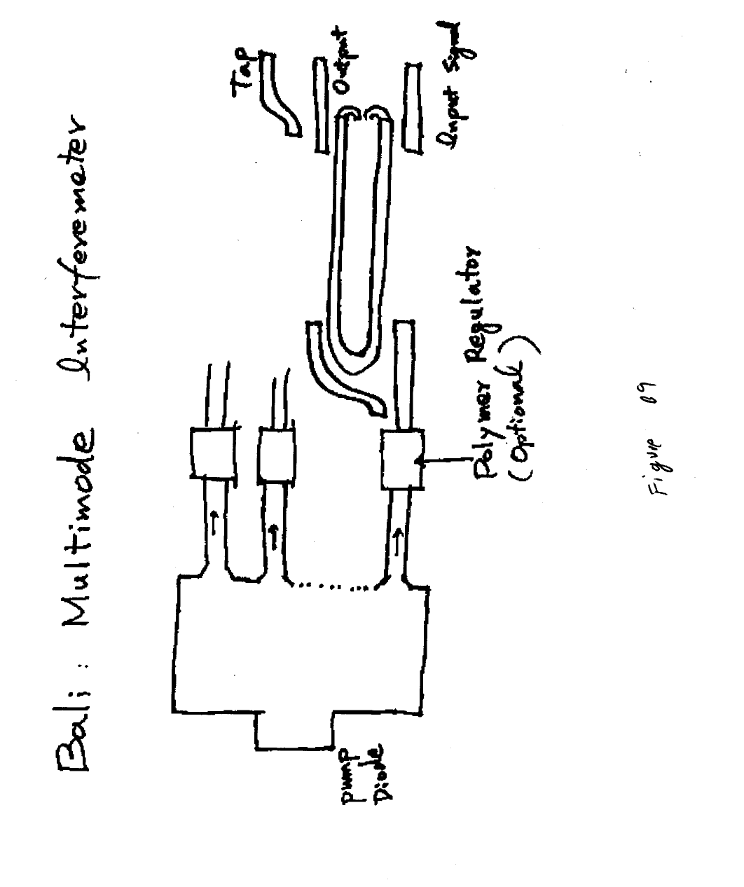

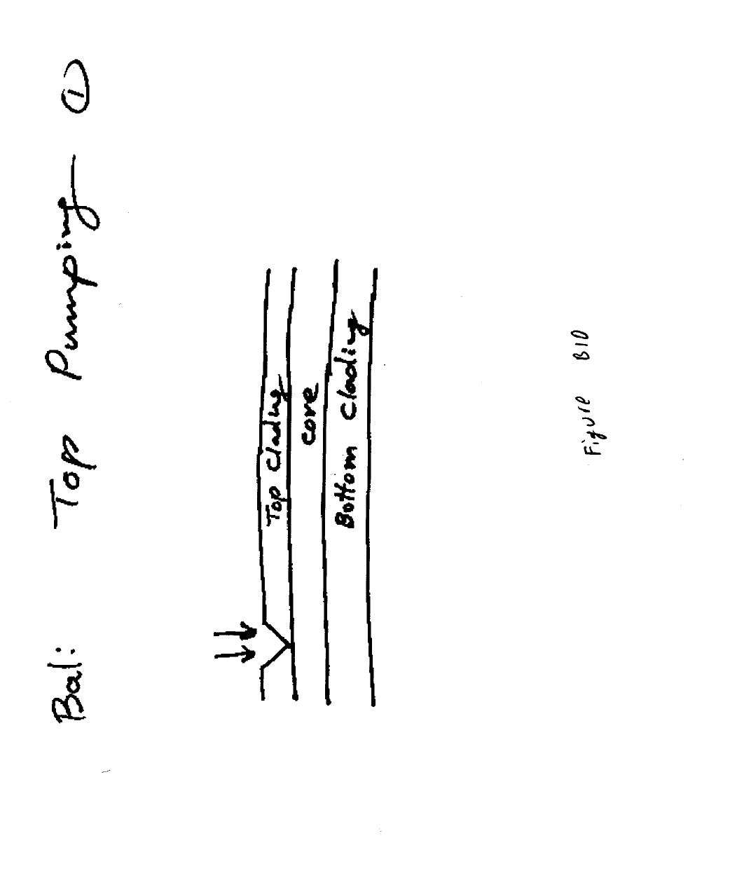

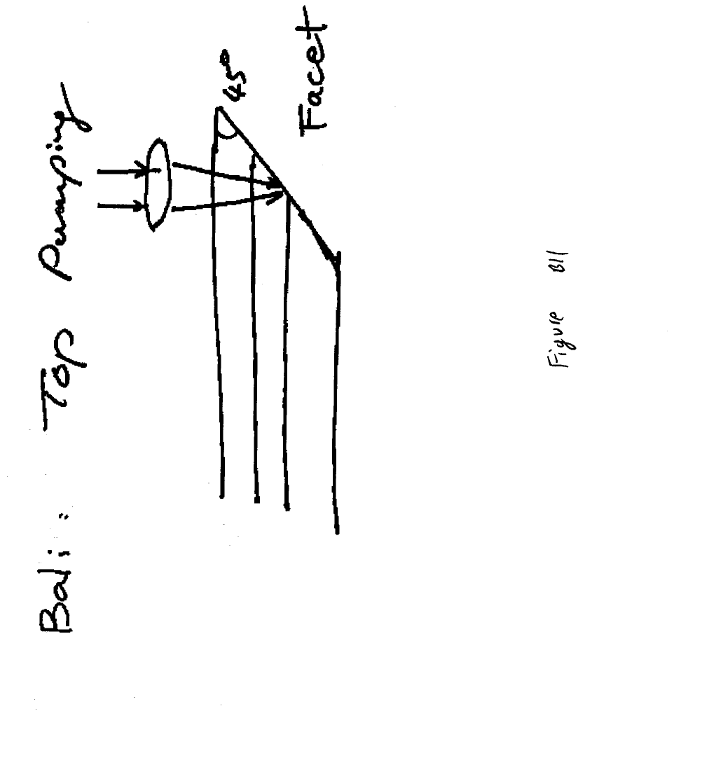

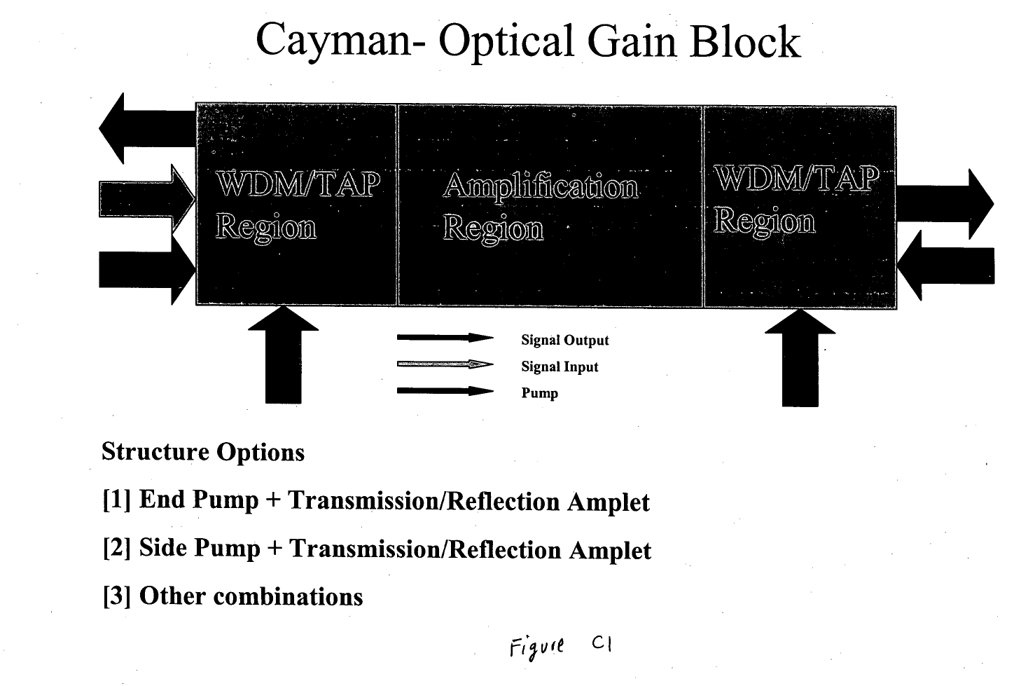

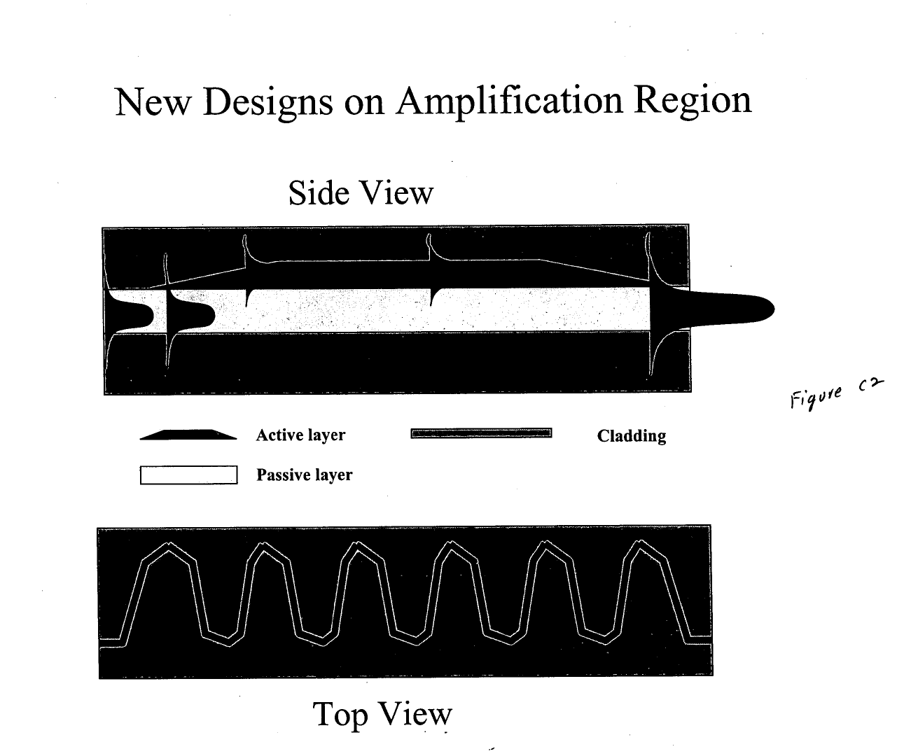

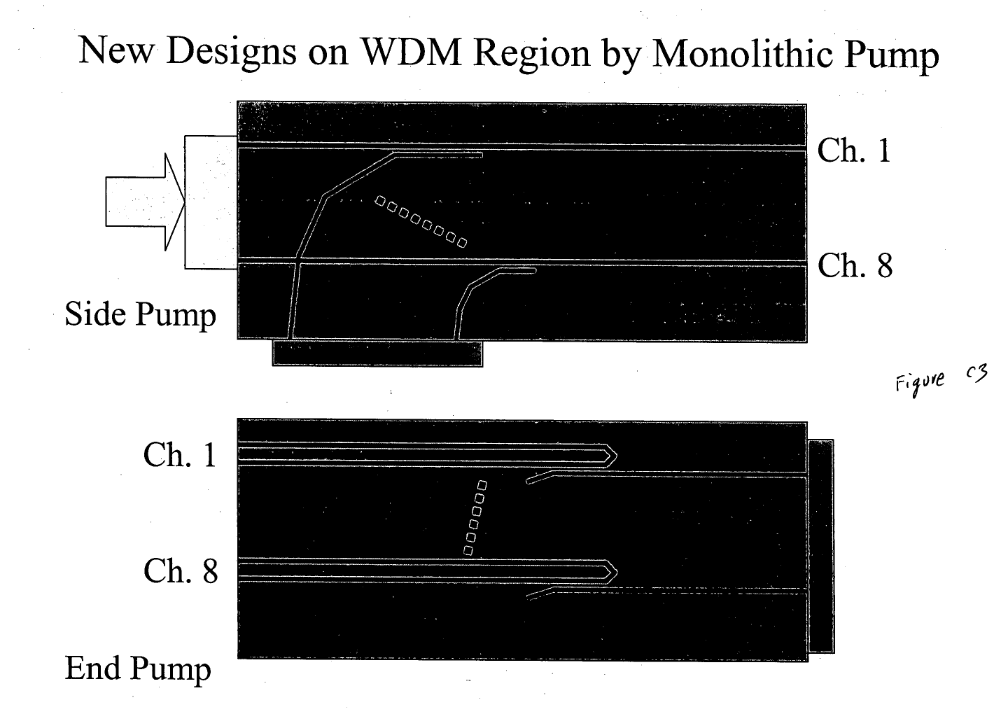

FIG. 2a shows that all of these dielectric films could function as gate oxides for low temperature polysilicon transistors because they have slightly negative flat band voltages when operated in the megahertz range. However, the rare earth doped aluminosilicate 1/0.4 sputtered from an oxide target with 1.56 MHz RF and deposited with an oxygen flow of 4 SCCM/60 SCCM Argon would be the ideal gate oxide or barrier film on either side of the polysilicon gate to form a transistor at low processing temperature.

FIG. 2b demonstrates that the flat band voltage does not vary significantly up to a driving frequency of 100 kHz.

FIG. 2c demonstrates, similar to the case above, small variation of the CV curve up to 100 kHz for the 1/0.4 doped film.

With the oxygen at 3 SCCM/60 SCCM Argon reactive gas, the 1/0.4 doped 60/40 aluminosilicate demonstrates low negative flat band as deposited. Of the two as deposited cases the film with bias demonstrates the higher accumulation or effective dielectric constant. Both low temperature depositions demonstrate good, slightly negative flat band behavior required of a barrier layer under, or a gate oxide over a layer of polysilicon.

The longer the bum in the more alumina is available in the film, also the greater the degree of formation of oxide on the target surface and also the resulting film. The more alumina in the film and the greater oxide formation the further the flat band shifts to the right after anneal. Both the preconditioning of the target and the anneal process can independently effect the flat band voltage of the rare earth doped oxide.

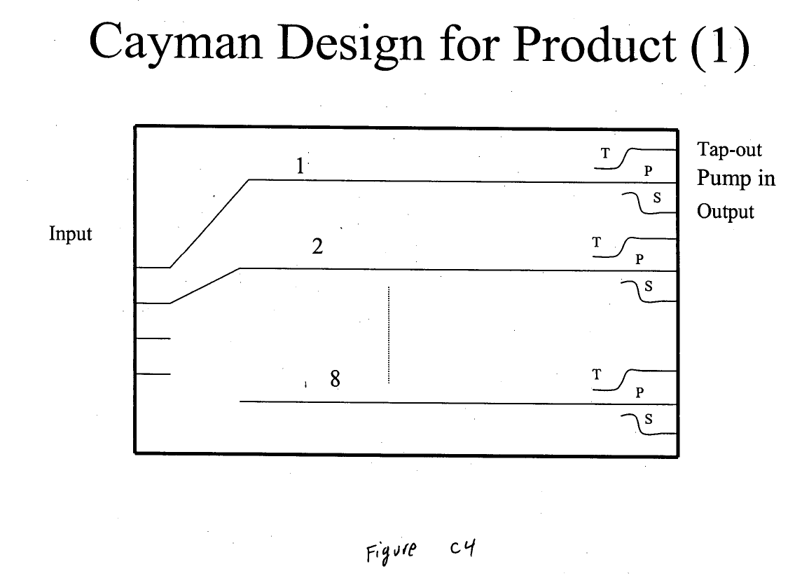

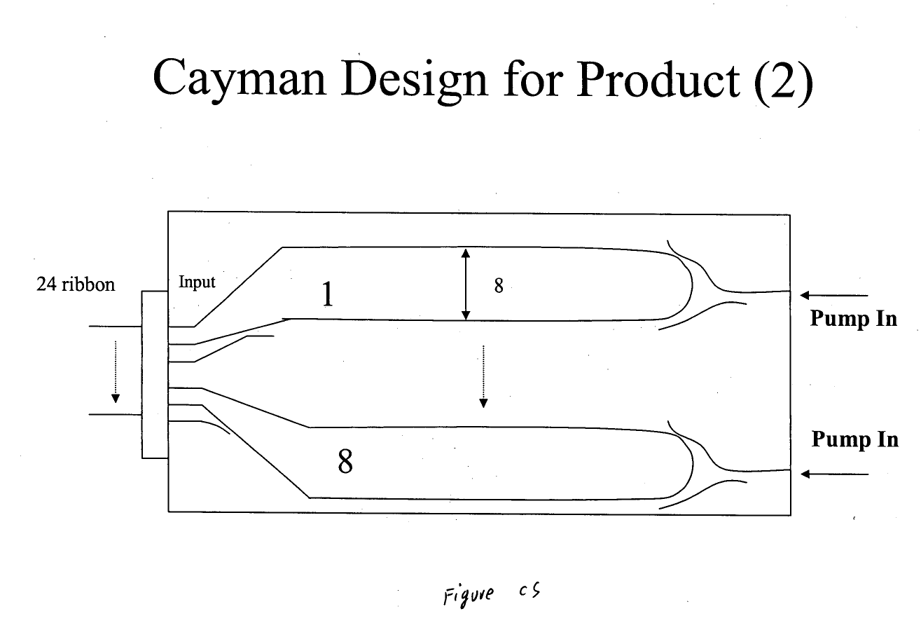

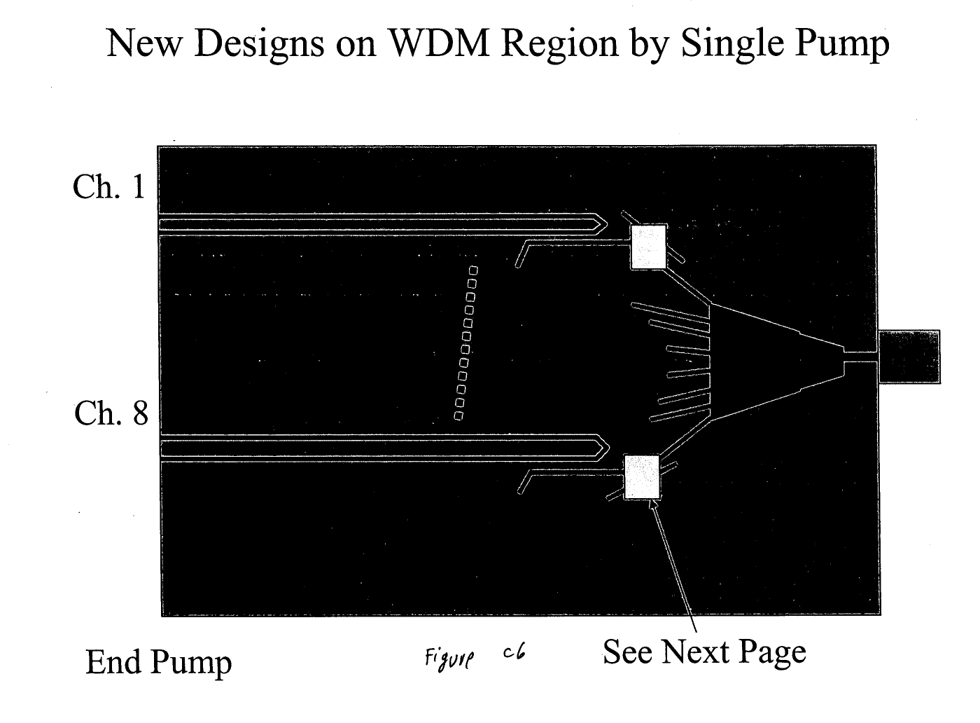

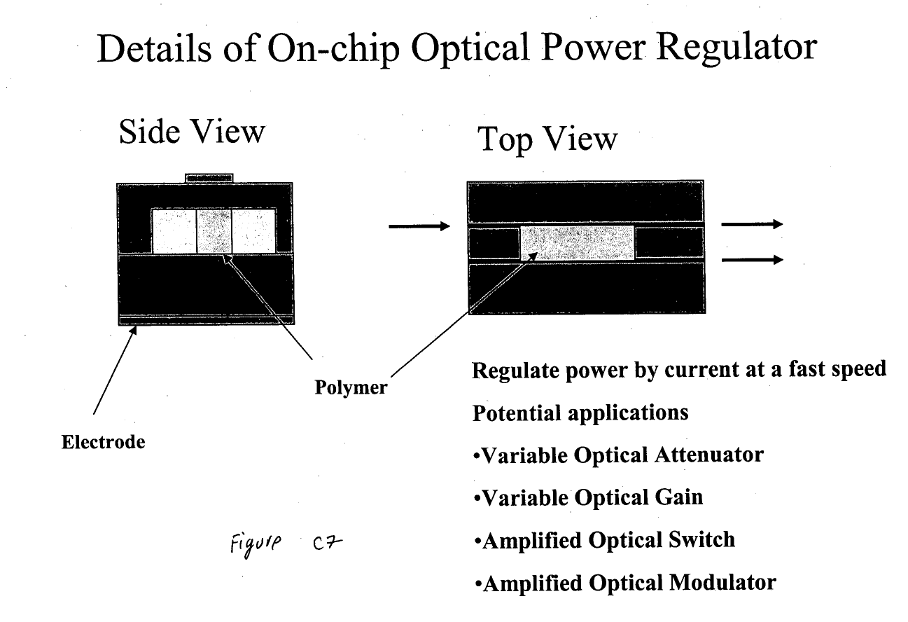

FIG. 6a shows the band voltage of the 0.8/0.8 doped film is resistant to applied voltages up to at least 100 Volts/200 nm of film thickness. This corresponds to about 500 Volts/micron. The higher voltage corresponds to the beginning of breakdown as shown in the following IV curves.

FIG. 6b show the IV behavior of doped and undoped RPDC films as well as the RF sputtered 1/0.4 doped film which has the highest voltage with the lowest conduction. These 200 nm films on conductive silicon demonstrate the highest voltage to conduction of any vacuum thin dielectric film reported. Note that the film with the lowest conduction at 8 to 12 Megavolts/Cm is the rare earth doped aluminosilicate 1/0.4 sputtered from an oxide target under conditions of reactive oxygen and 2 MegaHertz substrate bias.

### Wide Band Free Space Erbium Doped Grating Amplifier and Laser

The angle dependent bandwidth of an erbium doped grating, as shown below in FIGS. Y1 through FIG. Y5, provides a free space source with as much as 100 nm of bandwidth in the C and L bands due to the 35-40 nm emission of erbium +3 ion in silica at a selected output angle.

A single erbium doped grating can there for provide a fixed angle, wide band ASE source. Arrangement of a second reciprocal blazed grating at the same angle to the light from the first grating can provide a cavity with higher dispersion. The output of the cavity can be tuned by the angle of second grating to the first grating. Output of the angle selected wavelength is at the specular or zeroth order angles from the first grating.

Introduction of pump and signal light at one specular angle to the first erbium doped grating will provide output at the input frequency having gain at the opposite specular angle to the first grating. Consequently, such a double dispersed cavity will provide a very narrow bandwidth output, wide bandwidth amplifier at fixed angle when excited with a narrow input frequency. Alternatively, the ASE output wavelength can be angle tuned by the second grating over the extended bandwidth.

Positioning mirrors to reflect back into the cavity at the specular angles will provide wide band lasing from the two grating cavity. Pumping and erbium doping of the second grating, similar to the first would increase the gain of the device.

We claim:

1. An planar wave guide device, comprising
a core layer deposited by sputtering onto a substrate; and
an upper cladding layer fabricated by sputter deposition processes.

2. The device of claim 1, wherein the core layer includes a rare earth dopant.

3. The device of claim 1, further including a second planar waveguide with a core layer and an upper cladding layer, the second planar waveguide being arranged proximate and parallel for a preselected distance to the planar waveguide to form a directional coupler, wherein a portion of a light wave within one of the planar waveguide or second planar waveguide is transferred to the other of the planar waveguide or second planar waveguide.

4. The device of claim 3, wherein the planar waveguide and the second planar wave guide each form a separate facet at the edge of the planar device.

5. The device of claim 1, wherein light traveling through the planar waveguide is amplified or attenuated in response to a control signal.

6. The device of claim 1, wherein the device transmits light or does not transmit light in response to a control signal.

7. The device of claim 1, wherein the device is configure as a gain flattening filter.

8. The device of claim 1, further including a DWDM array deposited on the substrate.

9. The device of claim 1, coupled to provide feedback so as to form a mode locked laser.

10. The device of claim 1, coupled to form an oscillator in a frequency source or a clock.

11. The device of claim 1, further including an input terminal and an output terminal located on the same side of a substrate.
